(19) United States
(12) Patent Application Publication
(10) Pub. No.: US 2025/0263541 A1
(43) Pub. Date: Aug. 21, 2025

(54) MASTER BATCH FOR RUBBER MODIFICATION, AND HYDROGENTATED CONJUGATED DIENE POLYMER COMPOSITION

(71) Applicant: ASAHI KASEI KABUSHIKI KAISHA, Tokyo (JP)

(72) Inventors: Takaaki Matsuda, Tokyo (JP); Shinichi Motofusa, Tokyo (JP); Ryosuke Ozawa, Tokyo (JP); Atsushi Bamba, Tokyo (JP)

(73) Assignee: ASAHI KASEI KABUSHIKI KAISHA, Tokyo (JP)

(21) Appl. No.: 19/105,483

(22) PCT Filed: Aug. 24, 2023
(86) PCT No.: PCT/JP2023/030528

§ 371 Date: Feb. 21, 2025

(30) Foreign Application Priority Data
Aug. 24, 2022 (JP) 2022-133674
Aug. 24, 2022 (JP) 2022-133678

(51) Int. Cl. C08L 15/00; C08J 3/22; C08L 7/00

(52) U.S. Cl. CPC C08L 15/00; C08J 3/226; C08L 7/00; C08J 2315/00; C08J 2401/02; C08J 2421/00; C08L 2205/035; C08L 2205/16; C08L 2207/324; C08L 2310/00

(57) ABSTRACT

The present invention provides a master batch for rubber modification, the master batch containing a rubber component and cellulose nanofibers in such a manner that the cellulose nanofibers are well dispersed in the rubber, and the master batch enabling the achievement of a rubber composition that exhibits excellent ozone resistance and mechanical characteristics after being cured; and a rubber composition which uses this master batch for rubber modification. One embodiment of the present invention provides a hydrogenated conjugated diene polymer composition which contains a hydrogenated conjugated diene polymer and cellulose nanofibers. With respect to the hydrogenated conjugated diene polymer in this embodiment, the hydrogenation degree of a structural unit derived from a conjugated diene compound is 30% by mole to 99% by mole. Another embodiment of the present invention provides a master batch for rubber modification, the master batch containing 100 parts by mass of a first rubber component that contains 50% by mass or more of a hydrogenated conjugated diene polymer, and 15 parts by mass to 100 parts by mass of cellulose nanofibers.

### FIELD

The present invention relates to a masterbatch for rubber modification and a rubber composition, which contain cellulose nanofibers.

### BACKGROUND

Conventionally, it has been common practice to mix reinforcing fillers such as carbon black and silica into a rubber composition for the purpose of improving properties of the rubber composition, such as elastic modulus, hardness, mechanical strength and abrasion resistance.

With increasing awareness of alternatives to petroleum resources and environmental issues in recent years, various proposals have been made on the use of cellulosic fibers which are natural materials with low specific gravity.

It is known that mixing cellulose nanofibers as a filler into a rubber composition enables reinforcing the rubber composition to improve hardness and tensile modulus (see PTL 1 and PTL 2).

In this way, cellulose nanofibers function as the reinforcing filler for rubber and can provide high-strength, lightweight and thin-walled rubber molded articles, and therefore are attracting attention as the reinforcing filler to replace carbon black and silica.

For example, PTL 3 describes a masterbatch composition of a styrene-butadiene copolymer and cellulose nanofibers for the purpose of providing a rubber composition for tires that can improve tensile properties and fuel economy.

PTL 4 proposes a rubber composition which is a silica compound, but has high strength and excellent abrasion resistance by hydrogenating double bonds derived from butadiene of a styrene-butadiene copolymer.

### CITATION LIST

### [Patent Literature]

[PTL1] JP 2017-2148 A
[PTL 2] JP 2021-191841 A
[PTL 3] JP 2020-41076 A
[PTL 4] WO 2019/151127 A

### SUMMARY

### Technical Problem

However, conventionally proposed rubber compositions comprising a rubber and cellulose nanofibers have a problem that the dispersibility of the cellulose nanofibers and the mechanical strength tend to be inferior. Even conventionally proposed hydrogenated conjugated diene-based polymer compositions do not exhibit mechanical strength high enough to enable rubber molded articles to be made thinner. Further, conventional diene polymer compositions also have a problem that the ozone resistance is inferior when used in various members.

It is an object of the present invention to solve the above problems, thus providing a rubber composition comprising a rubber and cellulose nanofibers in which the cellulose nanofibers are satisfactorily dispersed in the rubber to provide a rubber composition having excellent ozone resistance and mechanical properties after curing, and a rubber composition using the same.

### Solution to Problem

The present invention encompasses the following items.

### [Item 1]

A hydrogenated conjugated diene-based polymer composition comprising a hydrogenated conjugated diene-based polymer and cellulose nanofibers.

### [Item 2]

The hydrogenated conjugated diene-based polymer composition according to item 1, wherein the hydrogenated conjugated diene-based polymer is a hydrogenated conjugated diene-based polymer in which a hydrogenation rate of a structural unit derived from a conjugated diene compound is 30 mol % or more and 99 mol % or less.

### [Item 3]

A masterbatch for rubber modification comprising 100 parts by mass of a first rubber component containing 50% by mass or more of a hydrogenated conjugated diene-based polymer, and parts by mass or more and 100 parts by mass or less of cellulose nanofibers.

### [Item 4]

The masterbatch for rubber modification according to item 3, wherein the hydrogenated conjugated diene-based polymer is a hydrogenated conjugated diene-based polymer in which a hydrogenation rate of a structural unit derived from a conjugated diene compound is 30 mol % or more and 99 mol % or less.

### [Item 5]

The masterbatch for rubber modification according to item 3 or 4, wherein the hydrogenated conjugated diene-based polymer has a solubility parameter (SP value) of 16.8 (MPa)^{1/2} or more and 17.6 (MPa)^{1/2} or less.

### [Item 6]

The masterbatch for rubber modification according to any one of items 3 to 5, wherein the hydrogenated conjugated diene-based polymer has a weight average molecular weight of 200,000 or more and 2,000,000 or less.

### [Item 7]

The masterbatch for rubber modification according to any one of items 3 to 6, wherein the hydrogenated conjugated diene-based polymer includes an aromatic vinyl monomer unit.

### [Item 8]

The masterbatch for rubber modification according to item 7, wherein the hydrogenated conjugated diene-based polymer includes a styrene unit, and a styrene unit content St and a hydrogenation rate H of the hydrogenated conjugated diene-based polymer satisfy the relationship of the following formula:

$$0.297 \times St + 29.1 \leq H \leq 0.0877 \times St + 84.7 .$$

### [Item 9]

The masterbatch for rubber modification according to any one of items 3 to 8, wherein the cellulose nanofibers have no ionic groups.

### [Item 10]

The masterbatch for rubber modification according to any one of items 3 to 9, wherein the masterbatch for rubber modification further comprises a surfactant.

### [Item 11]

The masterbatch for rubber modification according to item 10, wherein the surfactant is a nonionic surfactant.

### [Item 12]

The masterbatch for rubber modification according to item 11, wherein the nonionic surfactant is a compound having a hydrophilic group selected from the group consisting of hydroxyl, carboxy, sulfonic acid and amino groups, and a hydrocarbon group.

### [Item 13]

The masterbatch for rubber modification according to item 11 or 12, wherein the nonionic surfactant is one or more types selected from the group consisting of compounds represented by the following general formula (1):

R—(OCH₂CH₂)ₘ—OH (1)
wherein R represents a monovalent aliphatic group of 6 to 30 carbon atoms, and m is a natural number smaller than the number of carbon atoms of R, and
   compounds represented by the following general formula (2):

R¹OCH₂—(CHOH)₄—CH₂OR₂ (2)
wherein R¹ and R² each independently represent a hydrogen atom, an aliphatic group of 1 to 30 carbon atoms, —COR₃ {wherein R³ represents an aliphatic group of 1 to 30 carbon atoms} or —(CH₂CH₂O)_{y}—R⁴ {wherein R⁴ represents a hydrogen atom or an aliphatic group of 1 to 30 carbon atoms, and y is an integer of 1 to 30}.

### [Item 14]

The masterbatch for rubber modification according to any one of items 10 to 13, wherein the masterbatch for rubber modification further comprises a liquid rubber.

### [Item 15]

The masterbatch for rubber modification according to item 14, wherein the liquid rubber has a number average molecular weight of 1,000 to 80,000.

### [Item 16]

The masterbatch for rubber modification according to item 14 or 15, wherein a ratio (Mw/Mn) of the weight average molecular weight (Mw) to the number average molecular weight (Mn) of the liquid rubber is 1.5 to 5.

### [Item 17]

The masterbatch for rubber modification according to any one of items 14 to 16, wherein the liquid rubber comprises one or more types selected from the group consisting of a diene-based rubber, a silicone rubber, a urethane rubber, and a polysulfide rubber and a hydrogenated product thereof.

### [Item 18]

The masterbatch for rubber modification according to any one of items 14 to 17, wherein the liquid rubber comprises a modified liquid rubber modified with an unsaturated carboxylic acid and/or a derivative thereof.

The masterbatch for rubber modification according to item 18, comprising 10 parts by mass or more and 200 parts by mass or less of the modified liquid rubber with respect to 100 parts by mass of the first rubber component.

### [Item 20]

A hydrogenated conjugated diene-based polymer composition, which is a kneaded product comprising the masterbatch for rubber modification according to any one of items 3 to 19 and a second rubber component.

### [Item 21]

The hydrogenated conjugated diene-based polymer composition according to item 20, wherein the second rubber component contains a natural rubber.

### [Item 22]

The hydrogenated conjugated diene-based polymer composition according to item 20 or 21, comprising 1 part by mass or more and 15 parts by mass or less of cellulose nanofibers with respect to 100 parts by mass in total of the first rubber component and the second rubber component.

### [Item 23]

The hydrogenated conjugated diene-based polymer composition according to any one of items 20 to 22, comprising 10 parts by mass or more and 80 parts by mass or less of a reinforcing filler with respect to 100 parts by mass in total of the first rubber component and the second rubber component.

### [Item 24]

The hydrogenated conjugated diene-based polymer composition according to any one of items 20 to 23, comprising a modified liquid rubber modified with an unsaturated carboxylic acid and/or a derivative thereof.

### [Item 25]

The hydrogenated conjugated diene-based polymer composition according to item 24, comprising 1 part by mass or more and 25 parts by mass or less of the modified liquid rubber with respect to 100 parts by mass in total of the first rubber component and the second rubber component.

### [Item 26]

A hydrogenated conjugated diene-based polymer cured product, which is a cured product of the hydrogenated conjugated diene-based polymer composition according to any one of items 20 to 25.

### [Item 27]

A hydrogenated conjugated diene-based polymer cured product, which is a cured product of the hydrogenated conjugated diene-based polymer composition according to item 21, wherein the hydrogenated conjugated diene-based polymer and the cellulose nanofibers are dispersed in a continuous phase containing the natural rubber.

### [Item 28]

The hydrogenated conjugated diene-based polymer cured product according to item 27, wherein the hydrogenated conjugated diene-based polymer is dispersed in the continuous phase as particles having a median diameter of 50 nm or more and 1,000 nm or less.

### [Item 29]

A hydrogenated conjugated diene-based polymer composition comprising 100 parts by mass of a rubber component containing 50% by mass or more of a hydrogenated conjugated diene-based polymer, and
1 part by mass or more and 15 parts by mass or less of cellulose nanofibers.

### [Item 30]

A hydrogenated conjugated diene-based polymer composition comprising 100 parts by mass of a rubber component containing 5% by mass or more of a hydrogenated conjugated diene-based polymer and a natural rubber, and
part by mass or more and 15 parts by mass or less of cellulose nanofibers.

### [Item 31]

The hydrogenated conjugated diene-based polymer composition according to item 29 or 30, wherein the hydrogenated conjugated diene-based polymer is a hydrogenated conjugated diene-based polymer in which a hydrogenation rate of a structural unit derived from a conjugated diene compound is 30 mol % or more and 99 mol % or less.

### [Item 32]

The hydrogenated conjugated diene-based polymer composition according to any one of items 29 to 31, wherein the hydrogenated conjugated diene-based polymer has a solubility parameter (SP value) of 16.8 (MPa)^{1/2} or more and 17.6 (MPa)^{1/2} or less.

### [Item 33]

The hydrogenated conjugated diene-based polymer composition according to any one of items 29 to 32, wherein the hydrogenated conjugated diene-based polymer has a weight average molecular weight of 200,000 or more and 2,000,000 or less.

### [Item 34]

The hydrogenated conjugated diene-based polymer composition according to any one of items 29 to 33, wherein the hydrogenated conjugated diene-based polymer includes an aromatic vinyl monomer unit.

### [Item 35]

The hydrogenated conjugated diene-based polymer composition according to item 34, wherein the hydrogenated conjugated diene-based polymer includes a styrene unit, and a styrene unit content St and a hydrogenation rate H of the hydrogenated conjugated diene-based polymer satisfy the relationship of the following formula:

$$0.297 \times St + 29.1 \leq H \leq 0.0877 \times St + 84.7 .$$

### [Item 36]

The hydrogenated conjugated diene-based polymer composition according to any one of items 29 to 35, wherein the cellulose nanofibers have no ionic groups.

### [Item 37]

The hydrogenated conjugated diene-based polymer composition according to any one of items 29 to 36, wherein the hydrogenated conjugated diene-based polymer composition further comprises a surfactant.

### [Item 38]

The hydrogenated conjugated diene-based polymer composition according to item 37, wherein the surfactant is a nonionic surfactant.

### [Item 39]

The hydrogenated conjugated diene-based polymer composition according to item 38, wherein the nonionic surfactant is a compound having a hydrophilic group selected from the group consisting of hydroxyl, carboxy, sulfonic acid and amino groups, and a hydrocarbon group.

### [Item 40]

The hydrogenated conjugated diene-based polymer composition according to item 38 or 39, wherein the nonionic surfactant is one or more types selected from the group consisting of compounds represented by the following general formula (1):

R—(OCH₂CH₂)ₘ—OH (1)
wherein R represents a monovalent aliphatic group of 6 to 30 carbon atoms, and m is a natural number smaller than the number of carbon atoms of R, and
   compounds represented by the following general formula (2):

R¹OCH₂—(CHOH)₄—CH₂OR₂ (2)
wherein R¹ and R² each independently represent a hydrogen atom, an aliphatic group of 1 to 30 carbon atoms, —COR₃ {wherein R³ represents an aliphatic group of 1 to 30 carbon atoms} or —(CH₂CH₂O)_{y}—R⁴ {wherein R⁴ represents a hydrogen atom or an aliphatic group of 1 to 30 carbon atoms, and y is an integer of 1 to 30}.

### [Item 41]

The hydrogenated conjugated diene-based polymer composition according to any one of items 37 to 40, wherein the hydrogenated conjugated diene-based polymer composition further comprises a liquid rubber.

### [Item 42]

The hydrogenated conjugated diene-based polymer composition according to item 41, wherein the liquid rubber has a number average molecular weight of 1,000 to 80,000.

### [Item 43]

The hydrogenated conjugated diene-based polymer composition according to item 41 or 42, wherein a ratio (Mw/Mn) of the weight average molecular weight (Mw) to the number average molecular weight (Mn) of the liquid rubber is 1.5 to 5.

### [Item 44]

The hydrogenated conjugated diene-based polymer composition according to any one of items 41 to 43, wherein the liquid rubber comprises one or more types selected from the group consisting of a diene-based rubber, a silicone rubber, a urethane rubber, and a polysulfide rubber and a hydrogenated product thereof.

### [Item 45]

The hydrogenated conjugated diene-based polymer composition according to any one of items 41 to 44, wherein the liquid rubber comprises a modified liquid rubber modified with an unsaturated carboxylic acid and/or a derivative thereof.

### [Item 46]

The hydrogenated conjugated diene-based polymer composition according to item 45, comprising 1 part by mass or more and 25 parts by mass or less of the modified liquid rubber with respect to 100 parts by mass of the rubber component.

### [Item 47]

The hydrogenated conjugated diene-based polymer composition according to any one of items 29 to 46, comprising 10 parts by mass or more and 80 parts by mass or less of a reinforcing filler with respect to 100 parts by mass of the rubber component.

### [Item 48]

A hydrogenated conjugated diene-based polymer cured product, which is a cured product of the hydrogenated conjugated diene-based polymer composition according to any one of items 29 to 47.

### [Item 49]

A hydrogenated conjugated diene-based polymer cured product, which is a cured product of the hydrogenated conjugated diene-based polymer composition according to item 30, wherein the hydrogenated conjugated diene-based polymer and the cellulose nanofibers are dispersed in a continuous phase containing the natural rubber.

### [Item 50]

The hydrogenated conjugated diene-based polymer cured product according to item 49, wherein the hydrogenated conjugated diene-based polymer is dispersed in the continuous phase as particles having a median diameter of 50 nm or more and 1,000 nm or less.

### [Item 51]

A method for producing the masterbatch for rubber modification according to any one of items 10 to 13, the method comprising:
a step of preparing a cellulose nanofiber composition comprising cellulose nanofibers and a surfactant, and
a step of mixing the cellulose nanofiber composition with a first rubber component containing a hydrogenated conjugated diene-based polymer.

### [Item 52]

A method for producing the masterbatch for rubber modification according to any one of items 14 to 19, the method comprising:
a step of preparing a cellulose nanofiber composition comprising cellulose nanofibers, a liquid rubber and a surfactant, and
a step of mixing the cellulose nanofiber composition with a first rubber component containing a hydrogenated conjugated diene-based polymer.

### [Item 53]

The method according to item 51 or 52, wherein the cellulose nanofiber composition is a powder.

### [Item 54]

A method for producing the hydrogenated conjugated diene-based polymer composition according to any one of items 37 to 40, the method comprising:
a step of preparing a cellulose nanofiber composition comprising cellulose nanofibers and a surfactant,
a step of mixing the cellulose nanofiber composition with a first rubber component containing a hydrogenated conjugated diene-based polymer to prepare a masterbatch for rubber modification, and
a step of mixing the masterbatch for rubber modification with a second rubber component to prepare a hydrogenated conjugated diene-based polymer composition.

### [Item 55]

A method for producing the hydrogenated conjugated diene-based polymer composition according to any one of items 41 to 46, the method comprising:
a step of preparing a cellulose nanofiber composition comprising cellulose nanofibers, a liquid rubber and a surfactant,
a step of mixing the cellulose nanofiber composition with a first rubber component containing a hydrogenated conjugated diene-based polymer to prepare a masterbatch for rubber modification, and
a step of mixing the masterbatch for rubber modification with a second rubber component to prepare a hydrogenated conjugated diene-based polymer composition.

### [Item 56]

The method according to item 54, wherein the cellulose nanofiber composition is a powder.

### [Item 57]

The method according to item 55, wherein the cellulose nanofiber composition is a powder.

### [Item 58]

The method according to item 54, wherein the hydrogenated conjugated diene-based polymer includes an aromatic vinyl monomer unit, and the second rubber contains a natural rubber.

### [Item 59]

The method according to item 58, wherein the hydrogenated conjugated diene-based polymer includes a styrene unit, and a styrene unit content St and a hydrogenation rate H of the hydrogenated conjugated diene-based polymer satisfy the relationship the following formula:

$$0.297 \times St + 29.1 \leq H \leq 0.0877 \times St + 84.7 .$$

### Advantageous Effects of Invention

According to one aspect of the present invention, it is possible to provide a rubber composition comprising a rubber and cellulose nanofibers in which the cellulose nanofibers are satisfactorily dispersed in the rubber to provide a rubber composition having excellent ozone resistance and mechanical properties after curing, and a rubber composition using the same.

### DESCRIPTION OF EMBODIMENTS

Embodiments for carrying out the present invention (hereinafter referred to as “present embodiment”) will be described in detail below. The following embodiments are merely illustrative of the present invention, and the present invention is not limited to the following embodiments. Modifications can be made as appropriate within the gist of the present invention.

One aspect of the present invention provides a hydrogenated conjugated diene-based polymer composition comprising a hydrogenated conjugated diene-based polymer and cellulose nanofibers (also referred to rubber composition in the present disclosure).

In the present disclosure, the hydrogenated conjugated diene-based polymer is a polymer in which a hydrogenated conjugated diene-based polymer in which a hydrogenation rate of a structural unit derived from a conjugated diene compound is 30 mol % or more and 99 mol % or less in one aspect.

One aspect of the present invention provides a masterbatch for rubber modification, comprising a hydrogenated conjugated diene-based polymer and cellulose nanofibers.

One aspect of the present invention provides a masterbatch for rubber modification comprising a hydrogenated conjugated diene-based polymer in which a hydrogenation rate of a structural unit derived from a conjugated diene compound is 30 mol % or more and 99 mol % or less, and cellulose nanofibers.

In one aspect, the masterbatch for rubber modification comprises 100 parts by mass of a rubber component containing 50% by mass or more of a hydrogenated conjugated diene-based polymer (also referred to as first rubber component in the present disclosure), and 15 parts by mass or more and 100 parts by mass or less of cellulose nanofibers.

In one aspect, the masterbatch for rubber modification is a masterbatch for natural rubber modification.

In one aspect, the hydrogenated conjugated diene-based polymer composition is a mixture containing the masterbatch for rubber modification of the present embodiment, and a second rubber component, more specifically, a kneaded product.

In one aspect, the second rubber component contains a natural rubber.

In one aspect, the hydrogenated conjugated diene-based polymer composition comprises 100 parts by mass of a rubber component containing 50% by mass or more of a hydrogenated conjugated diene-based polymer (the total of the first rubber component and the second rubber component in one aspect), and 1 part by mass or more and 15 parts by mass or less of cellulose nanofibers.

In one aspect, the rubber component contains a natural rubber.

In one aspect, the hydrogenated conjugated diene-based polymer composition comprises 100 parts by mass of a rubber component containing 50% by mass or more of a hydrogenated conjugated diene-based polymer in which a hydrogenation rate of a structural unit derived from a conjugated diene compound is 30 mol % or more and 99 mol % or less (the total of the first rubber component and the second rubber component in one aspect), and 1 part by mass or more and 15 parts by mass or less of cellulose nanofibers.

In one aspect, the hydrogenated conjugated diene-based polymer composition comprises 100 parts by mass of a rubber component containing 5% by mass or more of a hydrogenated conjugated diene-based polymer and a natural rubber (the total of the first rubber component and the second rubber component in one aspect), and 1 part by mass or more and 15 parts by mass or less of cellulose nanofibers.

In the rubber composition of the present embodiment, particularly, the rubber composition obtained by kneading a masterbatch for rubber modification and a second rubber component, the reinforcing effect is satisfactorily exerted by satisfactorily dispersing cellulose nanofibers in the rubber composition. The rubber molded article which is a cured product of the rubber composition of the present embodiment exhibits high ozone resistance, tensile modulus and elastic modulus due to the contribution of the hydrogenated conjugated diene-based polymer. That is, by curing the rubber composition of the present embodiment, a cured product having high strength, high elastic modulus and high abrasion resistance can be obtained.

Each component of the masterbatch for rubber modification and the hydrogenated conjugated diene-based polymer composition of the present embodiment will be described in detail below. In the production of the rubber composition, the second rubber component that is combined with the masterbatch for rubber modification may be the same as or different from the material of the first rubber component in the masterbatch for rubber modification.

### <Cellulose Nanofibers>

The starting material for the cellulose nanofibers may be natural cellulose or regenerated cellulose. Natural cellulose includes wood pulp obtained from wood sources (broadleaf trees or conifers), nonwood pulp obtained from non-wood sources (cotton, bamboo, hemp, bagasse, kenaf, cotton linter, sisal and straw), and cellulose aggregates obtained from sources such as animals (such as sea squirts), algae, or cellulose aggregates produced by microbes (such as acetic acid bacteria). Regenerated cellulose for use may be regenerated cellulose fibers (such as viscose, cupra and Tencel), cellulose derivative fibers, and superfine yarn of regenerated cellulose or cellulose derivatives, obtained by electrospinning methods.

The cellulose nanofibers refer to microcellulose fibers obtained by treating cellulose starting materials such as pulp with hot water, for example, at 100° C. or higher, hydrolyzing the hemicellulose portion to weaken it, and then mechanically defibrating by a pulverizing method using a high-pressure homogenizer, microfluidizer, ball mill, disk mill or mixer (such as a homomixer). According to one aspect, the cellulose nanofibers have a number average fiber diameter of 1 nm to 1000 nm. The cellulose nanofibers may be chemically modified as described below, but they are preferably not chemically modified, from the viewpoint of exhibiting the reinforcing effect as a filler. For example, cellulose nanofibers that have been defibrated by chemical oxidizing treatment using 2,2,6,6-tetramethylpiperidine-1-oxyl (TEMPO) phosphoric acid ester, for example, tend to have low heat resistance due to the ionic groups (such as carboxy groups) introduced into the cellulose nanofibers, and also tend to have small fiber diameters after defibrating. From the viewpoint of exhibiting the reinforcing effect as a filler, it is more advantageous for the cellulose nanofibers to be defibrated by mechanical defibrating alone (that is, without chemical defibrating such as oxidation). According to a preferred aspect, therefore, the cellulose nanofibers do not have ionic groups. As used herein, the phrase “cellulose nanofibers do not have ionic groups” means that the amount of ionic groups is 0.1 mmol/g or lower as measured by conductometric titration.

A slurry can be prepared by dispersing cellulose fiber in a liquid medium. The cellulose fiber can be dispersed in the slurry using a high-pressure homogenizer, microfluidizer, ball mill, disk mill or mixer (such as a homomixer), and for example, a defibration product can be obtained as the product of the slurry preparation step of the present disclosure. The liquid medium in the slurry may optionally include water, and optionally one or a combination of two or more liquid media other than water (such as organic solvents). Examples of organic solvents to be used include commonly used water-miscible organic solvents, such as alcohols with boiling points of 50° C. to 170° C. (for example, methanol, ethanol, n-propanol, i-propanol, n-butanol, i-butanol, s-butanol and t-butanol); ethers (for example, propylene glycol monomethyl ether, 1,2-dimethoxyethane, diisopropyl ether, tetrahydrofuran and 1,4-dioxane); carboxylic acids (for example, formic acid, acetic acid and lactic acid); esters (for example, ethyl acetate and vinyl acetate); ketones (for example, acetone, methyl ethyl ketone, methyl isobutyl ketone, cyclopentanone and cyclohexanone); and nitrogen-containing solvents (for example, dimethylformamide, dimethyl acetamide, acetonitrile, etc.). According to a typical aspect, the liquid medium in the slurry consists essentially of water.

Cellulose starting materials contain alkali-soluble components and sulfuric acid-insoluble components (such as lignin), and the alkali-soluble portion and the sulfuric acid-insoluble components may be reduced by carrying out refining steps such as delignification by digestion processing, and bleaching steps. However, since refining steps such as delignification by digestion processing, and bleaching steps, cut the molecular chains of the cellulose, altering its weight average molecular weight and number average molecular weight, it is preferred for the refining steps, and bleaching steps for the cellulose starting material to be controlled so that the weight average molecular weight and the weight average molecular weight/number average molecular weight ratio of the cellulose nanofibers do not deviate from the proper ranges.

Since refining steps such as delignification by digestion processing, and bleaching steps lower the molecular weight of the cellulose molecules, this raises the concern that these steps may lead to low molecularization of the cellulose nanofibers and degeneration of the cellulose starting material, which increases the abundance ratio of the alkali-soluble portion. Since the alkali-soluble portion has poor heat resistance, refining and bleaching of the cellulose starting material is preferably controlled so that the amount of alkali-soluble components in the cellulose starting material is less than a certain value.

In one aspect, the number average fiber diameters of the cellulose nanofibers are 1 to 1,000 nm, and preferably 2 to 1,000 nm, from the viewpoint of obtaining satisfactory improving effect on the physical properties by the cellulose nanofibers. The number average fiber diameter of the cellulose nanofibers is more preferably 4 nm or more, 5 nm or more, 10 nm or more, 15 nm or more or 20 nm or more, and more preferably 500 nm or less, 450 nm or less, 400 nm or less, 350 nm or less, 300 nm or less or 250 nm or less.

The fiber length (L)/fiber diameter (D) ratio of the cellulose nanofibers is preferably 30 or more, 50 or more, 80 or more, 100 or more, 120 or more or 150 or more, from the viewpoint of satisfactorily improving the mechanical properties of the rubber composition containing the cellulose nanofibers, while using a small amount of cellulose nanofibers. The upper limit is not particularly limited but is preferably 5,000 or less from the viewpoint of the handleability.

In the present disclosure, the fiber length, fiber diameter and the L/D ratio of the cellulose nanofibers are determined by preparing aqueous dispersions of the cellulose nanofibers, each aqueous dispersion being dispersed using a high-shear homogenizer (for example, an “Excel ED-7 Autohomogenizer”, trade name of Nippon Seiki Co., Ltd.), under processing conditions with a rotational speed of 15,000 rpm× 5 minutes, diluting the aqueous dispersion with purified water to 0.1 to 0.5% by mass, casting this onto mica, and using each air-dried product as a measuring sample for measurement with a scanning electron microscope (SEM) or atomic force microscope (AFM). Specifically, the length (L) and diameter (D) of 100 randomly selected cellulose nanofibers are measured in an observation field with the magnification adjusted so as to observe at least 100 cellulose nanofibers, and the ratio (L/D) is calculated. The number average value for the fiber length (L), the number average value for the fiber diameter (D) and the number average value for the ratio (L/D) is calculated for the cellulose nanofibers.

Alternatively, the fiber length, fiber diameter and L/D ratio of cellulose nanofibers in rubber composition can be confirmed by measurement of a sample of the same, using the measuring method described above.

Alternatively, the fiber length, fiber diameter and L/D ratio of the cellulose nanofibers to be included in a masterbatch for rubber modification, a rubber composition or the like can be confirmed by dissolving the polymer component in an organic or inorganic solvent capable of dissolving the polymer component, separating the cellulose nanofibers, thoroughly rinsing them with the solvent, and then replacing the solvent with purified water to form an aqueous dispersion, diluting the cellulose nanofibers concentration to 0.1 to 0.5% by mass with purified water, casting the dispersion onto mica, and performing measurement by the measuring method described above using the air-dried product as the measuring sample. The cellulose nanofibers are measured using 100 or more randomly selected fibers.

The degree of crystallinity of the cellulose nanofibers is preferably 55% or more. If the degree of crystallinity is within this range, the mechanical properties (strength and dimensional stability) of the cellulose itself will be high, so that when the cellulose nanofibers are dispersed in rubber, the strength and dimensional stability of the rubber composition will also tend to be high. A more preferred lower limit for the degree of crystallinity is 60%, preferably 70% and most preferably 80%. The upper limit for the degree of crystallinity of the cellulose nanofibers is not particularly limited, a higher degree being preferred, but the preferred upper limit is 99% from the viewpoint of the productivity.

The alkali-soluble polysaccharides such as hemicellulose and acid-insoluble components such as lignin are present between plant-derived cellulose nanofibers microfibrils and between microfibril bundles. Hemicellulose is a polysaccharide composed of sugars such as mannan and xylan, and it plays a role in hydrogen bonding with cellulose and binding together microfibrils. Lignin is a compound class with aromatic rings that is known to participate in covalent bonding with hemicellulose in plant cell walls. A large residue of impurities such as lignin in cellulose nanofibers may result in discoloration by heating during working, and therefore the degree of crystallinity of the cellulose nanofibers is preferably within the ranges specified above from the viewpoint of reducing discoloration of the rubber composition during extrusion or during shaping.

When the cellulose is type I cellulose crystals (derived from natural cellulose), the degree of crystallinity referred to here is that determined by the following formula, from the diffraction pattern (2θ/deg.=10 to 30) obtained by measurement of the sample by wide-angle X-ray diffraction, based on the Segal method.

$$Degree of crystallinity ( \% ) = ( [ Diffraction intensity from ( 200 ) plane with 2 θ / deg . = 22.5 ] - [ diffraction intensity from amorphous matter with 2 θ / deg . = 18 ] ) / [ diffraction intensity from ( 200 ) plane with 2 θ / deg . = 22.5 ] \times 100$$

When the cellulose is type II cellulose crystals (derived from regenerated cellulose), the degree of crystallinity is determined by the following formula, from the absolute peak intensity h0 at 2θ=12.6° attributed to the (110) plane peak of the type II cellulose crystal, and the peak intensity h1 from the baseline for the plane spacing, in wide-angle X-ray diffraction.

$$Degree of crystallinity ( \% ) = h 1 / h 0 \times 100$$

The known crystalline forms of cellulose include type I, type II, type III and type IV, of which type I and type II are most commonly used, whereas type III and type IV are not commonly used on an industrial scale but have been obtained on a laboratory scale. The cellulose nanofibers of the disclosure are preferably cellulose nanofibers containing type I cellulose crystals or type II cellulose crystals, for relatively high mobility in terms of structure and to obtain a molded article with a lower coefficient of linear expansion and more excellent strength and elongation when subjected to stretching or bending deformation, by dispersion of the cellulose nanofibers in the rubber, and more preferably the cellulose nanofibers contain type I cellulose crystals and have a degree of crystallinity of 55% or higher.

The degree of polymerization of the cellulose nanofibers is preferably 100 or more, more preferably 150 or more, still more preferably 200 or more, yet more preferably 300 or more, even yet more preferably 400 or more, and most preferably 450 or more, and preferably 3,500 or lower, more preferably 3,300 or less, still more preferably 3,200 or less, yet more preferably 3,100 or less, and most preferably 3,000 or less.

The degree of polymerization of the cellulose nanofibers is preferably within this range from the viewpoint of the workability and mechanical properties. The degree of polymerization is preferably not too high from the viewpoint of the workability, and it is preferably not too low from the viewpoint of exhibiting mechanical properties.

The degree of polymerization of the cellulose nanofibers is the mean polymerization degree measured by a reduced relative viscosity method using a copper-ethylenediamine solution, as described in Verification Test (3) of “Japanese Pharmacopeia, 15th Edition Reference Manual (Hirokawa Shoten)”.

In one aspect, the weight average molecular weight (Mw) of the cellulose nanofibers is 100,000 or more and preferably 200,000 or more. The ratio (Mw/Mn) of the weight average molecular weight and number average molecular weight (Mn) is 6 or less and preferably 5.4 or less. A higher weight average molecular weight means a lower number of terminal groups of the cellulose molecules. Since the ratio (Mw/Mn) of the weight average molecular weight and number average molecular weight represents the width of the molecular weight distribution, a smaller Mw/Mn means a lower number of ends of cellulose molecules. Since the ends of the cellulose molecules are origins for thermal decomposition, it is not sufficient for the cellulose molecules of the cellulose nanofibers to merely have high weight average molecular weight, but when a high weight average molecular weight is combined with a more narrow width of the molecular weight distribution, it is possible to obtain especially high heat resistance for the cellulose nanofibers, and for a rubber composition comprising the cellulose nanofibers and rubber. The weight average molecular weight (Mw) of the cellulose nanofibers may be 600,000 or less, or 500,000 or less, for example, from the viewpoint of greater availability of the cellulose starting material. The ratio (Mw/Mn) of the weight average molecular weight and number average molecular weight (Mn) may be 1.5 or more or 2 or more, for example from the viewpoint of easier production of the cellulose nanofibers. The Mw can be controlled to within this range by selecting a cellulose starting material having the corresponding Mw, or by carrying out appropriate physical treatment and/or chemical treatment of the cellulose starting material.

The Mw/Mn ratio can also be controlled to within this range by selecting a cellulose starting material having the corresponding Mw/Mn ratio, or by carrying out appropriate physical treatment and/or chemical treatment of the cellulose starting material. The Mw and Mw/Mn of the cellulose starting material may be in the ranges specified above according to one aspect. Examples of physical treatment for control of both the Mw and Mw/Mn include physical treatment by application of mechanical force, such as dry grinding or wet grinding with a microfluidizer, ball mill or disk mill, for example, or impacting, shearing, sliding or abrasion with a crusher, homomixer, high-pressure homogenizer or ultrasonic device, for example, while examples of chemical treatment include digestion, bleaching, acid treatment and regenerated cellulose treatment.

The weight average molecular weight and number average molecular weight of the cellulose nanofibers referred to here are the values determined after dissolving the cellulose nanofibers in lithium chloride-added N,N-dimethylacetamide, and then performing gel permeation chromatography with N,N-dimethylacetamide as the solvent.

The method of controlling the degree of polymerization (i.e. mean polymerization degree) or molecular weight of the cellulose nanofibers may be hydrolysis. Hydrolysis promotes depolymerization of amorphous cellulose inside the cellulose nanofibers and lowers the mean polymerization degree. Simultaneously, hydrolysis also results in removal of impurities such as hemicellulose and lignin in addition to the aforementioned amorphous cellulose, so that the interior of the fiber material becomes porous.

The method of hydrolysis is not particularly limited and may be acid hydrolysis, alkali hydrolysis, hot water decomposition, steam explosion, microwave decomposition or the like. Such methods may be used alone or in combinations of two or more thereof. In a method of acid hydrolysis, for example, the cellulose starting material is-cellulose obtained as pulp from a fibrous plant, which is dispersed in an aqueous medium, and then a suitable amount of a proton acid, carboxylic acid, Lewis acid, heteropolyacid or the like is added to the dispersion and the mixture is heated while stirring, thereby allowing easy control of the mean polymerization degree. The reaction conditions such as temperature, pressure and time will differ depending on the type of cellulose, the cellulose concentration, the acid type and the acid concentration, and they are appropriately adjusted so as to obtain the desired mean polymerization degree. For example, a water-soluble mineral acid solution at up to 2% by mass may be used for treatment of cellulose nanofibers for 10 minutes or longer under the conditions of 100° C. or higher under pressure. Under such conditions, the catalyst component, such as an acid, penetrates to the cellulose nanofibers interiors and promotes hydrolysis, allowing a lower amount of catalyst component usage and easier subsequent refining. During hydrolysis, the dispersion of the cellulose material may contain, in addition to water, also a small amount of an organic solvent in a range that does not interfere with the effect of the invention.

Alkali-soluble polysaccharides in the cellulose nanofibers include β-cellulose and γ-cellulose, in addition to hemicellulose. Alkali-soluble polysaccharides are understood by those skilled in the art to consist of the components that are obtained as the alkali-soluble portion of holocellulose (that is, the components other than α-cellulose in the holocellulose), upon solvent extraction and chlorine treatment of a plant (such as wood). Since alkali-soluble polysaccharides consist of hydroxyl group-containing polysaccharides with poor heat resistance, which can lead to inconveniences such as decomposition when subjected to heat, or yellowing due to heat aging, or reduced strength of the cellulose nanofibers, it is preferred to have a lower alkali-soluble polysaccharide content in the cellulose nanofibers.

In one aspect, the average content of alkali-soluble polysaccharides in the cellulose nanofibers is preferably 20% by mass or less, 18% by mass or less, 15% by mass or less or 12% by mass or less, with respect to 100% by mass of the cellulose nanofibers, from the viewpoint of obtaining satisfactory dispersibility for the cellulose nanofibers. The content may also be 1% by mass or more, 2% by mass or more or 3% by mass or more from the viewpoint of facilitating production of the cellulose nanofibers.

The average content of alkali-soluble polysaccharides can be determined by the method described in non-patent literature (Mokushitsu Kagaku Jikken Manual, ed. The Japan Wood Research Society, pp. 92-97, 2000), subtracting the α-cellulose content from the holocellulose content (Wise method). In the technical field this method is considered to be a method of measuring hemicellulose content. The alkali-soluble polysaccharide content is calculated 3 times for each sample, and the number average for the calculated alkali-soluble polysaccharide contents is recorded as the average alkali-soluble polysaccharide content.

In one aspect, the average content of acid-insoluble components in the cellulose nanofibers is preferably 10% by mass or less, 5% by mass or less or 3% by mass or less, with respect to 100% by mass of the cellulose nanofibers, from the viewpoint of avoiding reduction in heat resistance and resulting discoloration of the cellulose nanofibers. The content may also be 0.1% by mass or more, 0.2% by mass or more or 0.3% by mass or more, from the viewpoint of facilitating production of the cellulose nanofibers.

The average content of the acid-insoluble component is quantified using the Klason method, described in non-patent literature (Mokushitsu Kagaku Jikken Manual, ed. The Japan Wood Research Society, pp. 92-97, 2000). In the technical field this method is considered to be a method of measuring lignin content. The sample is stirred in a sulfuric acid solution to dissolve the cellulose and hemicellulose, and then filtered with glass fiber filter paper, and the obtained residue is used as the acid-insoluble component. The acid-insoluble component content is calculated from the weight of the acid-insoluble component, and the average of the acid-insoluble component content calculated for three samples is recorded as the average content of the acid-insoluble component.

The thermal decomposition initiation temperature (T_{D}) of the cellulose nanofibers, according to one aspect, is 270° C. or higher, preferably 275° C. or higher, more preferably 280° C. or higher, and still more preferably 285° C. or higher, from the viewpoint of allowing the desired heat resistance and mechanical strength to be exhibited for on-vehicle purposes. While a higher thermal decomposition initiation temperature is preferred, it is also 320° C. or lower or 300° C. or lower, from the viewpoint of easier production of the cellulose nanofibers.

For the purpose of the disclosure, the T_{D} is the value determined from a graph of thermogravimetry (TG) analysis where the abscissa is temperature and the ordinate is weight retention %. Starting from the weight of cellulose nanofibers at 150° C. (with essentially all of the moisture content removed) (0 wt % weight reduction) and increasing the temperature, a straight line is obtained running through the temperature at 1 wt % weight reduction (T₁%) and the temperature at 2 wt % weight reduction (T₂%). The temperature at the point of intersection between this straight line and a horizontal (baseline) running through the origin at weight reduction 0 wt %, is defined as T_{D}.

The 1% weight reduction temperature (T₁%) is the temperature at 1 wt % weight reduction with the 150° C. weight as the origin, after continuous temperature increase by the method for T_{D} described above.

The 250° C. weight loss (T_{250° C.}) of the cellulose nanofibers is the weight loss by TG analysis when the cellulose nanofibers have been stored for 2 hours at 250° C. under a nitrogen flow.

### (Chemical Modification)

The cellulose nanofibers may be chemically modified cellulose nanofibers. The cellulose nanofibers may be chemically modified beforehand, at the stage of the starting pulp or linter, during defibration treatment or after defibration treatment, or they may be chemically modified either during or after the slurry preparation step, or during or after the drying (granulation) step.

The modifying agent for the cellulose nanofibers used may be a compound that reacts with the hydroxyl groups of cellulose, and it may be an esterifying agent, an etherifying agent or a silylating agent. A modifying agent having polar groups, such as a carboxylic acid or phosphoric acid ester, will introduce ionic groups (such as carboxy groups) into the cellulose nanofibers, tending to lower the heat resistance and also tending to reduce the fiber diameters after defibration, and therefore such a modifying agent is preferably not used from the viewpoint of exhibiting a reinforcing effect as a filler. According to a preferred aspect, the chemical modification is acylation, and especially acetylation, using an esterifying agent. Preferred esterifying agents are acid halides, acid anhydrides, vinyl carboxylate esters and carboxylic acids.

An acid halide may be one or more types selected from the group consisting of compounds represented by the following formula:

R¹—C(═O)—X

wherein R¹ represents an alkyl group of 1 to 24 carbon atoms, an alkenyl group of 2 to 24 carbon atoms, a cycloalkyl group of 3 to 24 carbon atoms or an aryl group of 6 to 24 carbon atoms, and X is Cl, Br or I.

Specific examples of acid halides include, but are not limited to, acetyl chloride, acetyl bromide, acetyl iodide, propionyl chloride, propionyl bromide, propionyl iodide, butyryl chloride, butyryl bromide, butyryl iodide, benzoyl chloride, benzoyl bromide and benzoyl iodide. Acid chlorides are preferably used of these from the viewpoint of reactivity and handleability. For reaction of an acid halide, one or more alkaline compounds may also be added to neutralize the acidic by-products while simultaneously exhibiting catalytic action. Specific examples of alkaline compounds include, but are not limited to, tertiary amine compounds such as triethylamine and trimethylamine; and nitrogen-containing aromatic compounds such as pyridine and dimethylaminopyridine.

Any suitable acid anhydride may be used as an acid anhydride. Examples thereof include: anhydrides of saturated aliphatic monocarboxylic acids such as acetic acid, propionic acid, (iso) butyric acid and valeric acid; anhydrides of unsaturated aliphatic monocarboxylic acids such as (meth)acrylic acid and oleic acid; anhydrides of alicyclic monocarboxylic acids such as cyclohexanecarboxylic acid and tetrahydrobenzoic acid; anhydrides of aromatic monocarboxylic acids such as benzoic acid and 4-methylbenzoic acid;
dibasic carboxylic anhydrides, for example: anhydrides of saturated aliphatic dicarboxylic acids such as succinic acid and adipic acid; unsaturated aliphatic dicarboxylic anhydrides such as maleic anhydride and itaconic anhydride; alicyclic dicarboxylic anhydrides such as 1-cyclohexene-1,2-dicarboxylic anhydride, hexahydrophthalic anhydride and methyltetrahydrophthalic anhydride; and aromatic dicarboxylic anhydrides such as phthalic anhydride and naphthalic anhydride; and
tribasic or higher polybasic carboxylic anhydrides, for example: polycarboxylic acid (anhydrides) such as trimellitic anhydride and pyromellitic anhydride. The catalyst for reaction of an acid anhydride may be one or more types of an acidic compound such as sulfuric acid, hydrochloric acid or phosphoric acid, or a Lewis acid (such as a Lewis acid compound represented by MYn where M represents a metalloid element such as B, As or Ge, a base metal element such as Al, Bi or In, a transition metal element such as Ti, Zn or Cu, or a lanthanoid element, n represents an integer corresponding to the valence of M and is 2 or 3, and Y represents a halogen atom, OAc, OCOCF₃, ClO₄, SbF₆, PF₆ or OSO₂CF₃ (OTf)), or an alkaline compound such as triethylamine or pyridine.

Preferred vinyl carboxylate esters are vinyl carboxylate esters represented by the following formula:

R—COO—CH—CH₂

wherein R is an alkyl group of 1 to 24 carbon atoms, an alkenyl group of 2 to 24 carbon atoms, a cycloalkyl group of 3 to 16 carbon atoms or an aryl group of 6 to 24 carbon atoms. Vinyl carboxylate esters are more preferably one or more types selected from the group consisting of vinyl acetate, vinyl propionate, vinyl butyrate, vinyl caproate, vinyl cyclohexanecarboxylate, vinyl caprylate, vinyl caprate, vinyl laurate, vinyl myristate, vinyl palmitate, vinyl stearate, vinyl pivalate, vinyl octylate, divinyl adipate, vinyl methacrylate, vinyl crotonate, vinyl octylate, vinyl benzoate and vinyl cinnamate. For esterification reaction with a vinyl carboxylate ester, one or more catalysts selected from the group consisting of alkali metal hydroxides, alkaline earth metal hydroxides, alkali metal carbonates, alkaline earth metal carbonates, alkali metal hydrogencarbonate salts, primary to tertiary amines, quaternary ammonium salts, imidazoles and their derivatives, pyridines and their derivatives, and alkoxides, may be added.

Alkali metal hydroxides and alkaline earth metal hydroxides include sodium hydroxide, potassium hydroxide, lithium hydroxide, calcium hydroxide and barium hydroxide. Alkali metal carbonates, alkaline earth metal carbonates and alkali metal hydrogencarbonate salts include lithium carbonate, sodium carbonate, potassium carbonate, cesium carbonate, magnesium carbonate, calcium carbonate, barium carbonate, lithium hydrogencarbonate, sodium hydrogencarbonate, potassium hydrogencarbonate and cesium hydrogencarbonate. Primary to tertiary amines are primary amines, secondary amines and tertiary amines, specific examples of which include ethylenediamine, diethylamine, proline, N,N,N′,N′-tetramethylethylenediamine, N,N,N′,N′-tetramethyl-1,3-propanediamine, N,N,N′,N′-tetramethyl-1,6-hexanediamine, tris(3-dimethylaminopropyl)amine, N,N-dimethylcyclohexylamine and triethylamine.

Imidazole and its derivatives include 1-methylimidazole, 3-aminopropylimidazole and carbonyldiimidazole.

Pyridine and its derivatives include N,N-dimethyl-4-aminopyridine and picoline.

Alkoxides include sodium methoxide, sodium ethoxide and potassium-t-butoxide.

Carboxylic acids include one or more types selected from the group consisting of compounds represented by the following formula:

R—COOH

wherein R represents an alkyl group of 1 to 16 carbon atoms, an alkenyl group of 2 to 16 carbon atoms, a cycloalkyl group of 3 to 16 carbon atoms or an aryl group of 6 to 16 carbon atoms.

Specific examples of carboxylic acids include one or more types selected from the group consisting of acetic acid, propionic acid, butyric acid, caproic acid, cyclohexanecarboxylic acid, caprylic acid, capric acid, lauric acid, myristic acid, palmitic acid, stearic acid, pivalic acid, methacrylic acid, crotonic acid, octylic acid, benzoic acid and cinnamic acid.

Preferred of these carboxylic acids are one or more types selected from the group consisting of acetic acid, propionic acid and butyric acid, and especially acetic acid, from the viewpoint of the reaction efficiency.

The catalyst for reaction of a carboxylic acid may be one or more types of an acidic compound such as sulfuric acid, hydrochloric acid or phosphoric acid, or a Lewis acid (such as a Lewis acid compound represented by MYn where M represents a metalloid element such as B, As or Ge, a base metal element such as Al, Bi or In, a transition metal element such as Ti, Zn or Cu, or a lanthanoid element, n represents an integer corresponding to the valence of M and is 2 or 3, and Y represents a halogen atom, OAc, OCOCF₃, ClO₄, SbF₆, PF₆ or OSO₂CF₃ (OTf)), or an alkaline compound such as triethylamine or pyridine.

Particularly preferred of these esterification reactants are one or more types selected from the group consisting of acetic anhydride, propionic anhydride, butyric anhydride, vinyl acetate, vinyl propionate, vinyl butyrate and acetic acid, of which acetic anhydride and vinyl acetate are especially preferred from the viewpoint of the reaction efficiency.

When the cellulose nanofibers are chemically modified (for example, by hydrophobizing such as acylation), the dispersibility of the cellulose nanofibers in the rubber will tend to be satisfactory, but the cellulose nanofibers of the disclosure can also exhibit satisfactory dispersibility in rubber even when they are unsubstituted or low-substituted.

In one aspect, the degree of substitution of the cellulose nanofibers is 0 (i.e. they are unsubstituted).

In one aspect, the degree of acyl substitution (DS) of the cellulose nanofibers is more than 0, 0.1 or more, 0.2 or more, 0.25 or more, 0.3 or more or 0.5 or more, from the viewpoint of obtaining chemically modified cellulose nanofibers with a high thermal decomposition initiation temperature. If unmodified cellulose backbones remain in the esterified cellulose nanofibers, then it will be possible to obtain esterified cellulose nanofibers exhibiting high tensile strength and dimensional stability provided by the cellulose and a high thermal decomposition initiation temperature provided by the chemical modification, and in this regard the degree of acyl substitution (DS) of the cellulose nanofibers may be 1.2 or less, 1.0 or less, 0.8 or less, 0.7 or less, 0.6 or less or 0.5 or less.

When the modifying groups on the chemically modified cellulose nanofibers are acyl groups, the degree of acyl substitution (DS) can be calculated based on the peak intensity ratio between the acyl group-derived peak and the cellulose backbone-derived peak, in the attenuated total reflection (ATR) infrared absorption spectrum of the esterified cellulose nanofibers. The peak of the absorption band for C—O based on acyl groups appears at 1,730 cm⁻¹, while the peak of the absorption band for C—O based on the cellulose backbone chain appears at 1,030 cm⁻¹. The DS of esterified cellulose nanofibers can be calculated using the calibration curve:

Degree of substitution DS=4.13×IR index (1030),

derived from a correlation graph drawn between DS obtained from solid NMR measurement of the esterified cellulose nanofibers, and the modification rate (IR index 1030), defined by the ratio of the peak intensity of the absorption band for C═O based on acyl groups with respect to the peak intensity of the absorption band for C—O of the cellulose backbone chain.

In one aspect, the cellulose nanofibers may be added in the system in the form of a cellulose nanofiber composition combined with other components (for example, a surfactant and/or a liquid rubber) during the production of a masterbatch for rubber modification or a hydrogenated conjugated diene-based polymer composition.

In the masterbatch for rubber modification, the content of the cellulose nanofibers with respect to 100 parts by mass of the first rubber component is preferably 15 parts by mass or more, or 20 parts by mass or more, from the viewpoint of satisfactorily obtaining the reinforcing effect of the cellulose nanofibers, and is preferably 100 parts by mass or less, or 70 parts by mass or less, or 50 parts by mass or less, from the viewpoint of obtaining a cured product excellent in mechanical strength and elongation at break by satisfactorily dispersing the cellulose nanofibers in the rubber in the hydrogenated conjugated diene-based polymer composition.

In the masterbatch for rubber modification, the content of the cellulose nanofibers with respect to 100 parts by mass of the hydrogenated conjugated diene-based polymer is preferably 15 parts by mass or more, or 20 parts by mass or more, or 25 parts by mass or more, and is preferably 100 parts by mass or less, or 80 parts by mass or less, or 60 parts by mass or less.

The content of the cellulose nanofibers in the masterbatch for rubber modification is, in one aspect, 10% by mass or more, or 20% by mass or more, or 25% by mass or more, and in one aspect, 50% by mass or less, or 40% by mass or less, or 30% by mass or less.

In the hydrogenated conjugated diene-based polymer composition, the content of the cellulose nanofibers with respect to 100 parts by mass of the rubber component (the total of the first and second rubber components in one aspect) is preferably 1 part by mass or more, more preferably 2 parts by mass or more, and still more preferably 3 parts by mass or more, from the viewpoint of satisfactorily obtaining the effect of mixing the cellulose nanofibers. From the viewpoint of the dispersibility of the cellulose nanofibers in the rubber, the content is preferably 15 parts by mass or less, and more preferably 10 parts by mass or less.

The content of the cellulose nanofibers in the hydrogenated conjugated diene-based polymer composition is preferably 0.5% by mass or more, or 1% by mass or more, or 3% by mass or more, from the viewpoint of obtaining satisfactory reinforcing effect of the cellulose nanofibers, and is preferably 30% by mass or less, or 20% by mass or less, or 10% by mass or less, from the viewpoint of obtaining a cured product having satisfactory rubber elasticity.

### <Surfactant>

In one aspect, the masterbatch for rubber modification or hydrogenated conjugated diene-based polymer composition includes a surfactant. In one aspect, the surfactant constitutes the cellulose nanofiber composition. In one aspect, the surfactant is present in the vicinity of the cellulose nanofibers in the masterbatch for rubber modification or hydrogenated conjugated diene-based polymer composition, and thus the surfactant contributes to an improvement in dispersibility of the cellulose nanofibers in the rubber.

In one aspect, the surfactant is a nonionic surfactant. The nonionic surfactant can infiltrate into the voids between aggregates of cellulose nanofibers, rendering the aggregates porous. For example, if the nonionic surfactant is allowed to infiltrate the aggregates in a wetted state and then dried to form a dried body, it will be possible to reduce shrinkage during drying, compared to a dried body obtained by drying aggregates without using the nonionic surfactant, thus allowing the cellulose nanofibers to be satisfactorily dispersed when the dried body is mixed with rubber.

The nonionic surfactant is preferably a compound having a hydrophilic group selected from the group consisting of hydroxyl, carboxy, sulfonic acid and amino groups, and a hydrocarbon group.

In one aspect, the nonionic surfactant has an aliphatic group of 6 to 30 carbon atoms as the hydrophobic portion. The cellulose nanofibers of the embodiment typically form loose aggregates, but a nonionic surfactant has satisfactory affinity with rubber components due to the contribution of the carbon chains in the hydrophobic portion, while being able to easily infiltrate into the voids of the cellulose nanofiber aggregates, since the carbon chains of the hydrophobic portion are not excessively long, and can thus render the aggregates porous. For example, if a nonionic surfactant is allowed to infiltrate the aggregates in a wetted state and then dried to form a dried body, it will be possible to reduce shrinkage during drying, compared to a dried body obtained by drying aggregates without using a nonionic surfactant, thus allowing the cellulose nanofibers to be satisfactorily dispersed when the dried body is combined with a rubber component.

The aliphatic groups may be linear or alicyclic groups, or combinations thereof. According to one aspect, the number of carbon atoms in the aliphatic groups is 6 or more, 8 or more or 10 or more from the viewpoint of obtaining satisfactory dispersibility of the cellulose nanofibers in the rubber, and according to another aspect it is 30 or less, 25 or less or 20 or less, from the viewpoint of infiltration into the voids of the cellulose nanofibers aggregates.

The nonionic surfactant preferably has one or more structures selected from the group consisting of oxyethylene, glycerol and sorbitan as hydrophilic portions (specifically, a repeating structure having one or more of these as repeating units). These structures are preferred because they exhibit high hydrophilic properties while allowing different types of nonionic surfactants to be easily obtained by combination of different hydrophobic portions. In a nonionic surfactant having such a hydrophilic portion, the number of carbon atoms n in the hydrophobic portion and the number of repeating units m in the hydrophilic portion preferably satisfy the relationship n>m, from the viewpoint of obtaining satisfactory dispersibility of the cellulose nanofibers in the rubber. The number of repeats m of the hydrophilic portion is preferably one or more, 2 or more, 3 or more or 5 or more, from the viewpoint of satisfactory infiltration of the nonionic surfactant into the voids of the cellulose nanofibers aggregates, and preferably 30 or less, 25 or less, 20 or less or 18 or less, from the viewpoint of obtaining satisfactory dispersibility of the cellulose nanofibers in the rubber.

The nonionic surfactant is preferably one or more types selected from the group consisting of compounds represented by the following general formula (1):

R—(OCH₂CH₂)ₘ—OH (1)
wherein R represents a monovalent aliphatic group of 6 to 30 carbon atoms, and m is a natural number smaller than the number of carbon atoms of R, and
   compounds represented by the following general formula (2):

R¹OCH₂—(CHOH)₄—CH₂OR₂ (2)
wherein R¹ and R² each independently represent a hydrogen atom, an aliphatic group of 1 to 30 carbon atoms, —COR₅ {wherein R³ represents an aliphatic group of 1 to 30 carbon atoms} or —(CH₂CH₂O)_{y}—R⁴ {wherein R⁴ represents a hydrogen atom or an aliphatic group of 1 to 30 carbon atoms, and y is an integer of 1 to 30}.

In general formula (1), R corresponds to the hydrophobic portion, and (OCH₂CH₂) (i.e. an oxyethylene unit) corresponds to the hydrophilic portion. The number of carbon atoms of R and the number of repeats m of (OCH₂CH₂) are preferably within the same respective ranges specified above for the number of carbon atoms n of the hydrophobic portion and the number of repeats m of the hydrophilic portion.

In general formula (2), the number of carbon atoms of the aliphatic group of 1 to 30 carbon atoms, for each of R¹, R², R³ and R⁴, is preferably 6 or more, 8 or more or 10 or more and preferably 24 or less, 20 or less or 18 or less.

y is one or more, and preferably 2 or more or 4 or more and preferably 30 or less, 25 or less or 20 or less.

The amount of the surfactant in the cellulose nanofiber composition, the masterbatch for rubber modification, or the hydrogenated conjugated diene-based polymer composition is preferably 10 parts by mass or more, or 15 parts by mass or more, or 20 parts by mass or more, and preferably 50 parts by mass or less, or 45 parts by mass or less, or 40 parts by mass or less, with respect to 100 parts by mass of the cellulose nanofiber.

### <Liquid Rubber>

In one aspect, the masterbatch for rubber modification or hydrogenated conjugated diene-based polymer composition includes a liquid rubber. In one aspect, the liquid rubber may constitute the above cellulose nanofiber composition. In one aspect, the liquid rubber may constitute the first rubber component. In one aspect, the liquid rubber may constitute the second rubber component. In one aspect, the liquid rubber is present in the vicinity of the cellulose nanofibers in the masterbatch for rubber modification or hydrogenated conjugated diene-based polymer composition, and thus the liquid rubber contributes to an improvement in dispersibility in the rubber of the cellulose nanofibers.

In the present disclosure, “liquid rubber” means a substance having fluidity at 23° C. and forming a rubber elastomer by crosslinking (more specifically, vulcanization) and/or chain extension. That is, according to one aspect the liquid rubber is uncured. The “flow property” means, according to one aspect, that when the liquid rubber that has been dissolved in cyclohexane is placed in a vial with dimensions of 21 mm torso diameter×50 mm full length at 23° C. and then dried, causing the liquid rubber to fill the vial up to a height of 1 mm, and the vial is then closed shut, vertically inverted and allowed to stand for 24 hours, the substance can be observed to move at least 0.1 mm in the height direction. The rubber component of the present disclosure, the first rubber component or the second rubber component, is distinguished from liquid rubber in that it does not meet the definition of the liquid rubber in the present disclosure.

The liquid rubber may be a common rubber monomer composition, and it preferably has a relatively low molecular weight from the viewpoint of easier handleability and obtaining satisfactory dispersibility of the cellulose nanofibers. According to one aspect, the liquid rubber is in liquid form with a number average molecular weight (Mn) of 80,000 or less. For the purpose of the disclosure, the molecular weight and molecular weight distribution of the rubber component are values obtained by measuring the chromatogram by gel permeation chromatography with 3 linked columns packed with polystyrene gel, and performing calculation with a calibration curve using standard polystyrene. The solvent used is tetrahydrofuran.

When the rubber composition is cured to obtain a cured rubber product, the liquid rubber is preferably vulcanized during curing from the viewpoint of improving the mechanical properties of the cured rubber product.

The number average molecular weight (Mn) of the liquid rubber is preferably 1,000 or more, or 1,500 or more, or 2,000 or more, or 5,000 or more, from the viewpoint of obtaining a cured product with excellent storage elastic modulus, and preferably 80,000 or less, 50,000 or less, 40,000 or less, 30,000 or less or 10,000 or less from the viewpoint of exhibiting high fluidity suited for satisfactory dispersion of the cellulose nanofibers in the liquid rubber, and from the viewpoint of avoiding excessive hardening of the liquid rubber after curing and obtaining satisfactory rubber elasticity.

The weight average molecular weight (Mw) of the liquid rubber is preferably 1,000 or more, or 2,000 or more, or 4,000 or more from the viewpoint of obtaining a cured product with excellent storage elastic modulus, and from the viewpoint of obtaining a masterbatch for rubber modification with excellent dispersibility of the cellulose nanofibers in the second rubber component in an aspect in which the masterbatch for rubber modification includes a liquid rubber, and preferably 240,000 or less, 150,000 or less or 30,000 or less, from the viewpoint of exhibiting high fluidity suited for satisfactory dispersion of the cellulose nanofibers in the liquid rubber, and from the viewpoint of avoiding excessive hardening of the liquid rubber after curing and obtaining satisfactory rubber elasticity.

The ratio of the number average molecular weight (Mn) and the weight average molecular weight (Mw) (Mw/Mn) of the cured product is preferably 1.5 or more, 1.8 or more or 2.0 or more from the viewpoint of allowing high levels of multiple properties of the cured product (high levels of storage modulus and rubber elasticity of the cured product in one aspect) by producing some degree of variation in the molecular weight, and preferably 10 or less, 8 or less or 5 or less from the viewpoint of stably obtaining the desired physical properties of the cured product without excessively large variation in molecular weight.

The liquid rubber may be a conjugated diene-based polymer, a non-conjugated diene-based polymer, or a hydrogenated product of the same. The polymer or its hydrogenated product may also be an oligomer. In one aspect, the liquid rubber may have reactive groups at both ends (for example, one or more types selected from the group consisting of hydroxyl, carboxy, isocyanato, thio, amino and halo groups), in which case it may be bifunctional. The reactive groups contribute to crosslinking and/or chain extension of the liquid rubber.

In preferred one aspect, the liquid rubber includes at least one selected from the group consisting of a diene-based rubber, a silicone rubber, a urethane rubber, a polysulfide rubber, and hydrogenated products thereof.

The liquid rubber may be a modified liquid rubber. It is preferable to contain the modified liquid rubber in the masterbatch for rubber modification or the hydrogenated conjugated diene-based polymer composition, from the viewpoint of improving the dispersibility of the cellulose nanofibers. In one aspect, the modified liquid rubber is a compound capable of forming a covalent bond with the cellulose nanofibers. The modified liquid rubber is particularly preferably a modified liquid rubber obtained by modifying an unmodified liquid rubber with an unsaturated carboxylic acid and/or a derivative thereof.

The unmodified liquid rubber is an unmodified liquid polymer (liquid diene-based polymer) obtained by polymerizing conjugated diene-based monomers such as 1,3-butadiene, isoprene, 1,3-pentadiene, 2,3-dimethyl-1,3-butadiene, 2-methyl-1,3-pentadiene, 1,3-hexadiene, 2-methyl-1,3-pentadiene, 4,5-diethyl-1,3-octadiene, and 3-butyl-1,3-octadiene. Examples of the unmodified liquid rubber include liquid diene-based polymers such as liquid polybutadiene, liquid polyisoprene, liquid styrene-butadiene random copolymers, liquid styrene-butadiene block copolymers, liquid butadiene-isoprene random copolymers, liquid styrene-butadiene-isoprene random copolymers, and liquid styrene-butadiene-isoprene block copolymers. These may be used alone or in combination of two or more thereof.

Examples of the unsaturated carboxylic acid include maleic acid, fumaric acid, itaconic acid, (meth)acrylic acid and the like. Examples of the unsaturated carboxylic acid derivative include unsaturated carboxylic anhydrides such as maleic anhydride and itaconic anhydride; unsaturated carboxylate esters such as maleate ester, fumarate ester, itaconate ester, glycidyl (meth)acrylate and hydroxyethyl (meth)acrylate; unsaturated carboxylic acid amides such as maleic acid amide, fumaric acid amide and itaconic acid amide; and unsaturated carboxylic acid imides such as maleic acid imide and itaconic acid imide. The modified liquid rubber may be modified with one or more types of the unsaturated carboxylic acid and the unsaturated carboxylic acid derivative.

Of these, from the viewpoint of economy and effects such as tensile properties and elastic modulus, maleic anhydride modified liquid rubber is preferred, and maleic anhydride modified liquid polybutadiene, maleic anhydride modified liquid polyisoprene, and maleic anhydride modified liquid styrene-butadiene random copolymer are more preferred.

In one aspect, the modification amount of the modified liquid rubber is 1 or more, or 3 or more, or 5 or more per molecular chain of the modified liquid rubber, from the viewpoint of improving tensile properties and elastic modulus, and is preferably 25 or less, or 20 or less, or 15 or less, from the viewpoint of production costs of the modified liquid rubber and having high fluidity and easy handling. The amount of modification is confirmed by H-NMR measurement.

The weight average molecular weight (Mw) of the modified liquid rubber is preferably 2,000 or more, or 5,000 or more, or 10,000 or more, from the viewpoint of obtaining a cured product having excellent storage modulus, and in one aspect in which the masterbatch for rubber modification includes a liquid rubber, the weight average molecular weight, and is preferably 150,000 or less, or 100,000 or less, or 50,000 or less from the viewpoint of obtaining a masterbatch for rubber modification having excellent dispersibility of cellulose nanofibers in the second rubber component, and from the viewpoint of having high fluidity suited for satisfactorily dispersing cellulose nanofibers in the rubber composition, and from the viewpoint of avoiding excessive hardening of the modified liquid rubber after curing and obtaining satisfactory rubber elasticity.

The content of the liquid rubber or the modified liquid rubber in the masterbatch for rubber modification may be, in one aspect, 10 parts by mass or more, or 30 parts by mass or more, or 50 parts by mass or more with respect to 100 parts by mass of the first rubber component, and may be, in one aspect, 200 parts by mass or less, or 150 parts by mass or less, or 100 parts by mass or less.

The content of the liquid rubber or modified liquid rubber in the hydrogenated conjugated diene-based polymer composition may be, in one aspect, 1 part by mass or more, or 5 parts by mass or more, or 10 parts by mass or more, with respect to 100 parts by mass of the rubber component (the total of the first and second rubber components in one aspect), and may be, in one aspect, 25 parts by mass or less, or 20 parts by mass or less, or 15 parts by mass or less.

### <Powder of Cellulose Nanofiber Composition>

In one aspect, the cellulose nanofiber composition may be in the form of a powder. In one aspect, the cellulose nanofiber composition may be in the form of a powder. The powder may have one or more of the properties mentioned below. This allows the powder to have excellent processing properties and the cellulose nanofibers to exhibit an excellent dispersion state in the rubber.

### <Loose Bulk Density>

In one aspect, the loose bulk density of the powder is preferably 0.01 g/cm³ or more, 0.05 g/cm³ or more, 0.10 g/cm³ or more, 0.15 g/cm³ or more or 0.20 g/cm³ or more, from the viewpoint of obtaining a satisfactory powder flow property and excellent feedability to the kneader, and from the viewpoint of inhibiting migration of the surfactant into the rubber, and it is preferably 0.50 g/cm³ or less, 0.40 g/cm³ or less, 0.30 g/cm³ or less, 0.25 g/cm³ or less or 0.20 g/cm³ or less, from the viewpoint of easily disintegrating the powder in the rubber so that the cellulose nanofibers satisfactorily disperse in the rubber, and from the viewpoint of avoiding excessive powder heaviness and reducing mixing defects with the powder and rubber.

### <Compacted Bulk Density>

The compacted bulk density of the powder is controlled within a range that is useful for keeping the loose bulk density and degree of compaction within desirable ranges, and according to one aspect it is preferably 0.01 g/cm³ or more, 0.05 g/cm³ or more, 0.10 g/cm³ or more, 0.15 g/cm³ or more or 0.20 g/cm³ or more, and preferably 1.00 g/cm³ or less, 0.80 g/cm³ or less, 0.70 g/cm³ or less, 0.60 g/cm³ or less, 0.50 g/cm³ or less, 0.40 g/cm³ or less or 0.30 g/cm³ or less.

The loose bulk density and compacted bulk density are measured by the procedures explained under the section EXAMPLES below, using a powder tester (Model PT-X) manufactured by Hosokawa Micron Group.

The method for producing the powder may be a method that includes a slurry preparation step in which a slurry containing the cellulose nanofibers and liquid medium is prepared, and a drying step in which the slurry is dried to form a powder.

### (Slurry Preparation Step)

In this step, a slurry is prepared. Examples of liquid media to be used include commonly used water-miscible organic solvents, such as alcohols with boiling points of 50° C. to 170° C. (for example, methanol, ethanol, n-propanol, i-propanol, n-butanol, i-butanol, s-butanol and t-butanol); ethers (for example, propylene glycol monomethyl ether, 1,2-dimethoxyethane, diisopropyl ether, tetrahydrofuran and 1,4-dioxane); carboxylic acids (for example, formic acid, acetic acid and lactic acid); esters (for example, ethyl acetate and vinyl acetate); ketones (for example, acetone, methyl ethyl ketone, methyl isobutyl ketone, cyclopentanone and cyclohexanone); and nitrogen-containing solvents (such as dimethylformamide, dimethyl acetamide and acetonitrile). According to a typical aspect, the liquid medium in the slurry consists essentially of water. The slurry may be composed of the cellulose nanofibers and liquid medium, but it may also include a surfactant and/or a rubber, and also optionally an additional component.

From the viewpoint of process efficiency in the subsequent drying step, the concentration of the cellulose nanofibers in the slurry is preferably 5% by mass or more, 10% by mass or more, 15% by mass or more, 20% by mass or more or 25% by mass or more, and from the viewpoint of avoiding excessive increase in the slurry viscosity and its solidification by aggregation to maintain satisfactory handleability, it is preferably 60% by mass or less, 55% by mass or less, 50% by mass or less or 45% by mass or less. For example, while production of cellulose nanofibers is generally carried out in a dilute dispersion, the dilute dispersion can be concentrated to adjust the cellulose nanofibers concentration in the slurry to the aforementioned preferred range. A method such as suction filtration, pressure filtration, centrifugal dehydration or heating may be used for the concentration.

### (Drying Step)

In this step, the slurry is dried under controlled drying conditions to form a powder. The timing of addition of the components other than the cellulose nanofibers may be before, during and/or after drying of the slurry. A drying apparatus such as a spray dryer or extruder may be used for the drying. The drying apparatus may be a commercial product, such as a Micromist spray dryer (manufactured by Fujisaki Denki Co.), a spray dryer (manufactured by Ohkawara Kakohki Co., Ltd.), or a twin-screw extruder (manufactured by Japan Steel Works, Ltd.). Appropriate control of the drying conditions, namely the drying speed, drying temperature and/or pressure (pressure reduction), and especially the drying speed, may be advantageous for obtaining powder in the desired form.

The drying speed, which is the amount of desorption (parts by mass) of the liquid medium per 1 minute per 100 parts by mass of slurry, may be 10%/min or more, 50%/min or more or 100% min or more from the viewpoint of rapidly drying the slurry to form powder of the desired particle size, and may be 10,000%/min or less, 1,000%/min or less or 500%/min or less, from the viewpoint of avoiding excessive micronization of the cellulose nanofibers to reduce aggregation of the cellulose nanofibers, while also obtaining satisfactory handleability.

The drying speed is the following formula: Drying speed (%/min)=(Slurry moisture content at drying start point (mass %)−powder moisture content at drying end point (mass %))/time required from drying start point to drying end point (min) (i.e. it is the average value throughout the drying step).

The drying start point is the point where the slurry or cake to be dried has been supplied to the apparatus and the step of drying at the prescribed drying temperature, pressure reduction and shear rate has begun, and the drying time does not include the pre-mixing period with different drying temperature, pressure reduction or shear rate from the drying step.

The drying end point is the point where the moisture content first begins to fall below 7% by mass with sampling at maximum intervals of 10 minutes after the drying start point.

In the case of a continuous drying apparatus, the time required from the drying start point to the drying end point can be interpreted as the residence time. In the case of a spray dryer, the residence time can be calculated from the heating air volume and the drying chamber volume. When an extruder is used as the drying apparatus, the residence time can be calculated from the screw rotational speed and the total screw pitch count.

The drying temperature may be 20° C. or higher, 30° C. or higher, 40° C. or higher or 50° C. or higher, for example, from the viewpoint of drying efficiency and of suitably aggregating the cellulose nanofibers to form powder of the preferred particle size, and may also be 200° C. or lower, 150° C. or lower, 140° C. or lower, 130° C. or lower or 100° C. or lower, from the viewpoint of reducing heat degradation of the cellulose nanofibers and additional components and of avoiding excessive micronization of the cellulose nanofibers.

The drying temperature is the temperature of the heat source that is contacted with the slurry, and it is defined as the surface temperature of the temperature control jacket of the drying apparatus, the surface temperature of the heating cylinder, or the temperature of the hot air, for example.

The pressure reduction may be-1 kPa or less, −10 kPa or less, −20 kPa or less, −30 kPa or less, −40 kPa or less or −50 kPa or less, from the viewpoint of drying efficiency and of suitably aggregating the cellulose nanofibers to form powder of the preferred particle size, and −100 kPa or more, −95 kPa or more or −90 kPa or more from the viewpoint of avoiding excessive micronization of the cellulose nanofibers.

During the drying step, the residence time of the slurry at a temperature of 20° C. to 200° C. is preferably 0.01 minutes to 10 minutes, 0.05 minutes to 5 minutes or 0.1 minutes to 2 minutes. With drying under these conditions the cellulose nanofibers dry rapidly, satisfactorily producing powder of the preferred particle size.

When a spray dryer is used, for example, the slurry is dried by introducing spray into a drying chamber containing circulating hot gas, using a spraying mechanism (such as a rotating disc or pressurized nozzle). The slurry droplet size during spray introduction may be, for example, 0.01 μm to 500 μm, 0.1 μm to 100 μm or 0.5 μm to 10 μm. The hot gas may be an inert gas such as nitrogen or argon, or air. The hot gas temperature may be, for example, 50° C. to 300° C., 80° C. to 250° C. or 100° C. to 200° C. Contact between the slurry droplets and the hot gas in the drying chamber may be by cocurrent flow, countercurrent flow or parallel flow. The particulate powder produced by drying of the droplets is collected using a cyclone or drum.

When an extruder is used, for example, the slurry is loaded into a screw-equipped kneading unit through a hopper, and the slurry is dried by continuous transport of the slurry with the screw in the kneading unit that is being depressurized and/or heated. The screw configuration may be a combination of a transport screw, counter-clockwise screw or kneading disc, in any order. The drying temperature may be, for example, 50° C. to 300° C., 80° C. to 250° C. or 100° C. to 200° C.

### <Hydrogenated Conjugated Diene-Based Polymer>

In one aspect, the masterbatch for rubber modification or hydrogenated conjugated diene-based polymer composition includes a hydrogenated conjugated diene-based polymer. In one aspect, the hydrogenated conjugated diene-based polymer is a polymer in which a hydrogenation rate of a structural unit derived from a conjugated diene compound is 30 mol % or more and 99 mol % or less. The hydrogenated conjugated diene-based polymers is advantageous from the viewpoint of providing a cured product having excellent mechanical strength and ozone resistance. The hydrogenated conjugated diene-based polymer of the present embodiment preferably includes 3% by mass or more and 60% by mass or less of a structural unit based on an aromatic vinyl monomer in view of providing a cured product having excellent mechanical strength and ozone resistance.

The hydrogenated conjugated diene-based polymer of the present embodiment includes a structural unit based on an aromatic vinyl monomer (also referred to as “aromatic vinyl monomer unit” in the present disclosure). In one aspect, the hydrogenated conjugated diene-based polymer is a random copolymer or a block copolymer including an aromatic vinyl monomer unit, a structural unit based on a conjugated diene monomer (also referred to as “conjugated diene monomer unit” in the present disclosure), and a structural unit based on ethylene (also referred to as “ethylene unit” in the present disclosure).

In the present disclosure, “random copolymer” refers to a copolymer in which the proportion of chains in which 8 or more consecutive structural units derived from an aromatic vinyl compound are present is 10% by mass or less with respect to the whole structural units derived from an aromatic vinyl compound.

Here, the content of chains each having 8 or more consecutive structural units derived from an aromatic vinyl compound can be calculated as the ratio of the integral value in the range (A) to the total integral values in each of the chemical shift ranges (A) to (C) in H-NMR spectrum measured for the copolymer using deuterated chloroform as a solvent. For example, when the aromatic vinyl compound is styrene, the proportion of styrene can be calculated by determining the ratio of the integral value in the range (A) to the sum of the integral values in the ranges (A) to (C) and multiplying this value by 2.5. This makes it possible to grasp the state of the chains of structural units derived from an aromatic vinyl compound.
(A) Aromatic vinyl compound chains of 8 or more: 6.00≤S<6.68
(B) Aromatic vinyl compound chains of 2 to 7:6.68≤S<6.89
(C) Aromatic vinyl compound short chain: 6.89≤S≤8.00

In one aspect, the hydrogenated conjugated diene-based polymer of the present embodiment is a random copolymer including a structural unit based on an aromatic vinyl compound, a structural unit based on a conjugated diene compound, and a structural unit based on ethylene.

Preferred is a hydrogenated copolymer obtained by adding hydrogen to a copolymer having an aromatic moiety which is a structural unit based on an aromatic vinyl compound, and a conjugated diene portion which is a structural unit based on a conjugated diene compound, from the viewpoint of commercial production, but a random copolymer obtained by copolymerizing an aromatic vinyl compound, a conjugated diene compound and ethylene may also be used. In the hydrogenated copolymer, hydrogen is added to the double bond portion in the conjugated diene portion, so that a part or the whole of the conjugated diene portions is converted to the ethylene portion. By increasing the hydrogenation rate, the content of the ethylene portion can be increased.

In the present disclosure, the term “block copolymer” refers to a copolymer in which the proportion of chains in which 8 or more consecutive structural units derived from an aromatic vinyl compound are present exceeds 10% by mass with respect to the whole structural units derived from an aromatic vinyl compound. Here, the content of chains each having eight or more consecutive structural units derived from an aromatic vinyl compound can be calculated by the above-mentioned method.

The proportion of chains having 8 or more consecutive structural units derived from an aromatic vinyl compound is preferably 20% by mass or more, or 30% by mass or more, or 40% by mass or more, from the viewpoints of improving the dispersibility of the cellulose nanofibers in the hydrogenated conjugated diene-based polymer composition, and improving the fracture properties of the cured product.

In one aspect, the first rubber component includes a hydrogenated conjugated diene-based polymer. The second rubber component may or may not include a hydrogenated conjugated diene-based polymer.

In one aspect, the hydrogenated conjugated diene-based polymer has a solubility parameter (hereinafter referred to as SP value) of 16.8 (MPa)^{1/2} or more and 17.6 (MPa)^{1/2} or less. The above solubility parameter (SP value) contributes to providing a cured product having excellent mechanical strength and ozone resistance.

The fact that the solubility parameter of the hydrogenated conjugated diene-based polymer of the present embodiment within a range of 16.8 (MPa)^{1/2} or more and 17.6 (MPa)^{1/2} or less is particularly advantageous when the first rubber component or the second component includes a natural rubber. The SP value of the natural rubber is known to be 17.19 (MPa)^{1/2}. When the SP value of the hydrogenated conjugated diene-based polymer is within the above range, the compatibility of the hydrogenated conjugated diene-based polymer with the natural rubber is improved. This tends to improve the rigidity of the rubber in the cured product because the cellulose nanofibers are uniformly dispersed in the rubber.

The SP value is calculated from the formula: (SP value)=((molar cohesive energy)/(molar volume))^{1/2}. When a rubber-like polymer is composed of two or more different types of monomers, the molar cohesive energy exhibits additivity. Therefore, the molar cohesive energy of the rubber-like polymer is calculated as the average value of the molar cohesive energies based on the content (mol %) of each component (the average value apportioned according to the content). As with the molar cohesive energy, the molar volume is additive, and the molar volume of a rubber-like polymer is calculated as the average value of the molar volumes based on the content (mol %) of each component (the average value apportioned according to the content).

Examples of two or more different types of monomers include, but are not particularly limited to, a conjugated diene compound monomer unit and an aromatic vinyl hydrocarbon monomer unit which are incorporated in the following bonding patterns: unhydrogenated 1,2-bonds, 1,2-bonds after hydrogenation, unhydrogenated 3,4-bonds, 3,4-bonds after hydrogenation, unhydrogenated 1,4-bonds and 1,4-bonds after hydrogenation. The amount of each of the conjugated diene compound monomer units incorporated in each bonding mode can be measured by NMR or the like.

The molar volume and molar cohesive energy of the conjugated diene compound monomer unit, aromatic vinyl hydrocarbon monomer unit, and other monomer units incorporated in the bonding patterns of unhydrogenated 1,2-bonds, hydrogenated 1,2-bonds, unhydrogenated 3,4-bonds, hydrogenated 3,4-bonds, unhydrogenated 1,4-bonds, and hydrogenated 1,4-bonds are determined according to the method mentioned in J. Bicerano, Prediction of Polymer Properties, 3rd Ed. Marcel Dekker, 2002 (Bicerano method).

The SP value can be controlled within the above range by controlling the 1,2-vinyl bond content in the conjugated diene monomer unit, the amount of an aromatic vinyl compound, and the hydrogenation rate. Examples of the method of adjusting the SP value to 16.8 (MPa)^{1/2} or more and 17.6 (MPa)^{1/2} or less include adjusting the amount of an aromatic vinyl compound to 5 to 30% by mass, the amount of 1,2-bond of the conjugated diene-based monomer units to 20 to 60% by mass, or the hydrogenation rate to 40 to 90 mol %.

In the hydrogenated copolymer, the ethylene portion is defined as a portion to which hydrogen is added to the polymer chain at both ends of the main chain of a conjugated diene compound (for example, the 1,4 bonds of a polymer using 1,3-butadiene as a monomer, that is, those in which hydrogen is added to other forms (for example, 1,2 bonds (vinyl bonds) in polymers using 1,3-butadiene as a monomer) are not included in the ethylene portion.

Examples of the aromatic vinyl compound include, but are not particularly limited to, styrene, α-methylstyrene, 1-vinylnaphthalene, 3-vinyltoluene, ethylvinylbenzene, divinylbenzene, 4-cyclohexylstyrene, 2,4,6-trimethylstyrene and the like. These may be used alone or in combination of two or more thereof. Of these, styrene is particularly preferred from the viewpoint of practical aspects such as availability of the monomer.

Examples of the conjugated diene compound include, but are not particularly limited to, 1,3-butadiene, isoprene, 1,3-pentadiene, 2,3-dimethylbutadiene, 2-phenyl-1,3-butadiene, 1,3-hexadiene and the like. These may be used alone or in combination of two or more thereof. Of these, from the viewpoint of practical aspects such as availability of the monomer, 1,3-butadiene and isoprene are preferred, and 1,3-butadiene is more preferred.

The content of the aromatic vinyl monomer units in the hydrogenated conjugated diene-based polymer of the present embodiment is preferably 3% by mass or more, or 10% by mass or more, or 15% by mass or more, or 20% by mass or more, from the viewpoints of improving the dispersibility of cellulose nanofibers in the hydrogenated conjugated diene-based polymer composition, improving the fracture properties of the cured product, and adjusting the glass transition temperature of the rubber composition, and is preferably 60% by mass or less, or 55% by mass or less, or 50% by mass or less, from the viewpoint of avoiding excessive hardening of the hydrogenated conjugated diene-based polymer after curing and obtaining satisfactory rubber elasticity. The content of the aromatic vinyl monomer unit is measured by nuclear magnetic resonance (NMR), more specifically, by the method of the below-mentioned Examples.

In one aspect, the hydrogenation rate (the ratio of hydrogenation to the conjugated diene portion) of the hydrogenated conjugated diene-based polymer of the present embodiment is 30 mol % or more, preferably 50 mol % or more, more preferably 60 mol % or more, and still more preferably 70 mol % or more, from the viewpoint of the crosslinkability. In one aspect, from the viewpoint of the crosslinkability, the hydrogenation rate is 99 mol % or less, preferably 95 mol % or less, and more preferably 90 mol % or less. The hydrogenation rate of 30 mol % or more and 99 mol % or less is advantageous in that a cured product having excellent mechanical strength and ozone resistance can be obtained. When the natural rubber is not used as the rubber component, it is advantageous to set the hydrogenation rate within the above range, whereas when the natural rubber is used as the rubber component, it may be advantageous to have the hydrogenation rate within or outside the above range.

The hydrogenation rate of the hydrogenated conjugated diene-based polymer can be controlled by the hydrogen amount in the hydrogenation reaction, the reaction time or the like, and can be calculated from the H-NMR measurement of the hydrogenated conjugated diene-based polymer.

In one aspect, the hydrogenated conjugated diene-based polymer includes a styrene unit. In this case, a styrene unit content St and a hydrogenation rate H of the polymer preferably satisfy the relationship of the following formula:

$$0.297 \times St + 29.1 \leq H \leq 0.0877 \times St + 84.7 .$$

In one aspect, the styrene unit content St may be within the above range as the content of the aromatic vinyl monomer unit.

As the styrene unit content increases, the dispersibility of cellulose nanofibers in the hydrogenated conjugated diene-based polymer tends to improve, while the compatibility of the hydrogenated conjugated diene-based polymer with natural rubber tends to degrade. As the hydrogenation rate increases, the compatibility between the hydrogenated conjugated diene-based polymer and natural rubber tends to improve. Even if the hydrogenated conjugated diene-based polymer has a high styrene unit content, it may have satisfactory compatibility with the natural rubber if the hydrogenation rate is high. From the above viewpoint, a hydrogenated conjugated diene-based polymer in which the styrene unit content St and the hydrogenation rate H satisfy the relationship of 0.297×St+29.1≤H can be satisfactorily miscible with the natural rubber, and therefore can uniformly disperse cellulose nanofibers in a cured product, thus making it possible to impart satisfactory mechanical strength to the cured product.

From the viewpoint of uniformly dispersing the cellulose nanofibers in the hydrogenated conjugated diene-based polymer, it is advantageous that the hydrogenation rate of the hydrogenated conjugated diene-based polymer is not too high. The hydrogenated conjugated diene-based polymer that satisfies the relationship H≤0.0877×St+84.7 contributes to uniformly dispersing cellulose nanofibers in the hydrogenated conjugated diene-based polymer and imparting satisfactory mechanical strength to the cured product.

The weight average molecular weight of the hydrogenated conjugated diene-based polymer is preferably 200,000 or more and 2,000,000 or less, from the viewpoints of shape stability of the cured product of the rubber composition and tensile strength and abrasion resistance of the cured product of the rubber composition. The weight average molecular weight is more preferably 300,000 or more, or 400,000 or more, or 500,000 or more, and more preferably 1,800,000 or less, or 1,500,000 or less, or 1,300,000 or less.

The weight average molecular weight of the hydrogenated conjugated diene-based polymer is the value measured by GPC (gel permeation chromatography), and more specifically, it can be measured by the method of the below-mentioned Examples.

From the viewpoint of processability, the molecular weight distribution (Mw/Mn) of the hydrogenated conjugated diene-based polymer is preferably 1.1 or more, more preferably 1.2 or more, and still more preferably 1.3 or more. The molecular weight distribution (Mw/Mn) of the hydrogenated conjugated diene-based polymer is preferably 3.0 or less, and more preferably 2.5 or less, from the viewpoint of the mechanical strength.

The Mooney viscosity at 100° C. of the hydrogenated conjugated diene-based polymer is preferably 250 or less, more preferably 200 or less, and still more preferably 180 or less, from the viewpoints of ease of kneading and prevention of breakage of the kneaded dough when preparing the rubber composition. The Mooney viscosity is preferably 35 or more, 40 or more, or 50 or more, from the viewpoint of obtaining satisfactory physical properties of the cured product of the rubber composition.

In the present aspect, the Mooney viscosity is measured by a Mooney viscometer using an L-shaped rotor in accordance with ISO 289 (corresponding to JIS K6300), and more specifically, can be measured by the method of the below-mentioned Examples.

### [Production of Hydrogenated Conjugated Diene-Based Polymer]

In one aspect, the hydrogenated conjugated diene-based polymer can be produced by producing a conjugated diene-based polymer and hydrogenating the same.

The polymerization method for the conjugated diene-based polymer is not particularly limited as long as the above-mentioned predetermined physical properties can be obtained, and any of solution polymerization, gas phase polymerization, and bulk polymerization can be used. From the viewpoint of commercial production, however, the solution polymerization is particularly preferred. The polymerization method may be either a batch method or a continuous method.

When a solution polymerization method is used, the monomer concentration in the solution is preferably 5% by mass or more, and more preferably 10% by mass or more. When the monomer concentration in the solution is 5% by mass or more, the amount of the obtained conjugated diene-based polymer is sufficient, and the cost tends to be low. The monomer concentration in the solution is preferably 50% by mass or less, and more preferably 30% by mass or less. When the monomer concentration in the solution is 50% by mass or less, the solution viscosity becomes low, which makes stirring easy and tends to facilitate polymerization.

### (Polymerization Initiator)

In one aspect, the conjugated diene-based polymer is obtained by anionic polymerization. The polymerization initiator for the anionic polymerization is not particularly limited, but an organolithium compound is preferably used. The organolithium compound is preferably one having an alkyl group having 2 to 20 carbon atoms, and examples thereof include ethyllithium, n-propyllithium, isopropyllithium, n-butyllithium, sec-butyllithium, tert-butyllithium, tert-octyllithium, n-decyllithium, phenyllithium, 2-naphthyllithium, 2-butyl-phenyllithium, 4-phenyl-butyllithium, cyclohexyllithium, cyclopentyllithium, and a reaction product of diisopropenylbenzene with butyllithium. Of these, n-butyllithium or sec-butyllithium is preferred from the viewpoints of availability, safety and the like.

In one aspect, the conjugated diene-based polymer is obtained by coordination polymerization. It is preferable to use, as a polymerization initiator for coordination polymerization, the polymerization catalyst composition mentioned in JP 2020-45500 A.

### (Polymerization Method)

The method for producing a conjugated diene-based copolymer by anionic polymerization or coordination polymerization using a polymerization initiator is not particularly limited, and any conventionally known method can be used. Specifically, in an organic solvent inert to the reaction, for example, a hydrocarbon solvent such as a chain aliphatic, alicyclic, or aromatic hydrocarbon compound, styrene, 1,3-butadiene, ethylene or the like is polymerized using, for example, butyllithium as a polymerization initiator, and optionally in the presence of a randomizer, to obtain the target conjugated diene copolymer.

### (Hydrocarbon-Based Solvent)

The hydrocarbon solvent is preferably one having 3 to 8 carbon atoms, and examples thereof include propane, n-butane, isobutane, n-pentane, isopentane, n-hexane, cyclohexane, propene, 1-butene, isobutene, trans-2-butene, cis-2-butene, 1-pentene, 2-pentene, 1-hexene, 2-hexene, benzene, toluene, xylene, ethylbenzene and the like. These may be used alone or in combination of two or more thereof.

### (Randomizer in Anionic Polymerization)

A randomizer is a compound having the effect of controlling the microstructure of a conjugated diene portion in a conjugated diene-based copolymer, for example, increasing 1,2-bonds in butadiene or 3,4-bonds in isoprene, or controlling the composition distribution of monomer units in a copolymer, for example, randomizing styrene units or butadiene units in a styrene-butadiene copolymer. There are no particular limitations on the randomizer, and any of the known compounds that have been generally used as randomizers can be used. Examples thereof include ethers such as dimethoxybenzene, tetrahydrofuran, dimethoxyethane, diethylene glycol dibutyl ether, diethylene glycol dimethyl ether, 2,2-di(2-tetrahydrofuryl) propane, triethylamine, pyridine, N-methylmorpholine, N,N,N′,N′-tetramethylethylenediamine and 1,2-dipiperidinoethane, and tertiary amines. It is also possible to use potassium salts such as potassium t-amylate and potassium t-butoxide, and sodium salts such as sodium t-amylate. These randomizers may be used alone or in combination of two or more thereof The amount of the randomizer used is preferably 0.01 molar equivalent or more, and more preferably 0.05 molar equivalent or more, per mol of the organolithium compound. When the amount of the randomizer used is 0.01 molar equivalent or more, the effect of addition is large and randomization tends to be facilitated. The amount of the randomizer used is preferably 1000 molar equivalents or less, and more preferably 500 molar equivalents or less, per mol of the organolithium compound. When the amount of the randomizer used is 1,000 molar equivalents or less, the reaction rate of the monomers does not change significantly, thus making it possible to avoid the inconvenience of difficulty in randomization.

### (Reaction Temperature)

The reaction temperature during polymerization is not particularly limited as long as the reaction proceeds suitably. Usually, the reaction temperature is preferably −10° C. to 100° C., and more preferably 25° C. to 70° C.

### (Reaction Termination)

The anionic polymerization can be terminated by the addition of a reaction terminator commonly used in this field. Examples of such reaction terminator include, but are not limited to, polar solvents having an active proton (e.g., alcohols such as methanol, ethanol and isopropanol, or acetic acid) and mixtures thereof, or mixtures of one or more of the above polar solvents with nonpolar solvents such as hexane and cyclohexane. The amount of the reaction terminator added is usually sufficient if it is about the same molar amount or about twice the molar amount of the anionic polymerization initiator.

### (Use of Rubber Stabilizer)

It is preferable to add a rubber stabilizer at the final stage of the hydrogenation process of the conjugated diene-based polymer, from the viewpoints of preventing gel formation and improving processing stability. The rubber stabilizer is not limited to the following ones, and known ones can be used. For example, antioxidants such as 2,6-di-tert-butyl-4-hydroxytoluene (BHT), n-octadecyl-3-(4′-hydroxy-3′,5′-di-tert-butylphenol) propionate, and 2-methyl-4,6-bis [(octylthio)methyl]phenol are preferable.

### (Use of Rubber Softening Agent)

In the final stage of the polymerization process of the conjugated diene-based polymer, a rubber softening agent can be added as necessary in order to improve the productivity of the polymer and the processability when an inorganic filler or the like is mixed during the production of the rubber composition. Examples of the rubber softening agent include, but are not particularly limited to, an extender oil, a liquid rubber, a resin and the like. The liquid rubber can be selected from those exemplified above. From the viewpoints of the processability, productivity and economy, the extender oil is preferred.

The method of adding a rubber softening agent to a conjugated diene-based polymer is not limited to the following, but a preferred method is a method of adding a rubber softening agent to a polymer solution, followed by mixing and removing the solvent from the resulting rubber softening agent-containing polymer solution.

Preferred examples of the extender oil include aromatic oil, naphthenic oil, and paraffinic oil. Of these, from the viewpoints of environmental safety, prevention of oil bleeding, and wet grip properties, an aromatic substitute oil having a polycyclic aromatic compound (PCA) content of 3% by mass or less according to the IP346 method is preferred. Examples of the aromatic substitute oil include Treated Distillate Aromatic Extracts (TDAE) and Mild Extraction Solvate (MES) as shown in Kautschuk Gummi Kunststoffe 52 (12) 799 (1999), as well as Residual Aromatic Extracts (RAE).

In terms of suppressing deterioration over time of the cured product, the content of the extender oil is preferably 37.5 parts by mass or less, more preferably 30 parts by mass or less, still more preferably 25 parts by mass or less, and most preferably 20 parts by mass or less, with respect to 100 parts by mass of the first rubber component in the masterbatch for rubber modification, or with respect to 100 parts by mass of the rubber components (the total of the first and second rubber components in one aspect) in the hydrogenated conjugated diene-based polymer composition. In one aspect, the content may be 5 parts by mass or more, 10 parts by mass or more, or 15 parts by mass or more.

### (Hydrogenation)

The method for hydrogenating the conjugated diene-based polymer and the hydrogenation reaction conditions are not particularly limited as long as the above-mentioned predetermined physical properties are obtained, and hydrogenation may be performed by a known method under known conditions. Usually, the reaction is carried out at 20° C. to 150° C. under a hydrogen pressure of 0.1 MPa to 10 MPa in the presence of a hydrogenation catalyst. The hydrogenation rate can be arbitrarily selected by changing the amount of the hydrogenation catalyst, the hydrogen pressure during the hydrogenation reaction, the reaction time and the like.

It is possible to use, as the hydrogenation catalyst, a compound containing any of metals in Groups 4 to 11 of the Periodic Table. Specifically, it is possible to use, but not limited to, for example, a compound containing Ti, V, Co, Ni, Zr, Ru, Rh, Pd, Hf, Re, and/or Pt atoms as the hydrogenation catalyst. More specific examples of the hydrogenation catalyst include, but are not limited to, metallocene compounds of Ti, Zr, Hf, Co, Ni, Pd, Pt, Ru, Rh, Re and the like; supported heterogeneous catalysts in which metals such as Pd, Ni, Pt, Rh, Ru and the like are supported on a carrier such as carbon, silica, alumina, diatomaceous earth and the like; homogeneous Ziegler type catalysts in which an organic salt or acetylacetone salt of a metal element such as Ni or Co is combined with a reducing agent such as organoaluminum; organometallic compounds or complexes of Ru, Rh and the like; fullerenes having hydrogen absorbed therein, and carbon nanotubes having hydrogen absorbed therein.

Of these, metallocene compounds containing any one of Ti, Zr, Hf, Co and Ni are preferred since they can be subjected to a hydrogenation reaction in a homogeneous system in an inert organic solvent. Further, metallocene compounds containing any one of Ti, Zr, and Hf are preferred. The hydrogenation catalysts may be used alone or in combination of two or more thereof.

At the final stage of the polymerization process of the conjugated diene-based polymer, a deactivator, a neutralizer and the like may be added, if necessary. Examples of the quenching agent include, but are not limited to, water; alcohols such as methanol, ethanol and isopropanol; and the like. The final stage of the polymerization process here means a state in which 95 mol % or more of the added monomer has been consumed in the polymerization. Examples of the neutralizing agent include, but are not limited to, carboxylic acids such as stearic acid, oleic acid and versatic acid (highly branched carboxylic acid mixture having 9 to 11 carbon atoms, with the majority having 10 carbon atoms); aqueous solutions of inorganic acids; and carbon dioxide gas.

### (Solvent Removal)

It is possible to use, as a method for removing the solvent from the polymer solution containing a hydrogenated conjugated diene-based polymer to obtain the hydrogenated conjugated diene-based polymer, a known method. Examples of the method include a method in which the solvent is separated by steam stripping or the like, followed by filtration of a polymer and further dehydration and drying to obtain a polymer; a method in which a polymer solution is concentrated in a flashing tank and then devolatilized using a vent extruder or the like; and a method in which the devolatilization is directly performed using a drum dryer or the like.

In the masterbatch for rubber modification, the ratio of the hydrogenated conjugated diene-based polymer in 100% by mass of the first rubber component (the ratio of the hydrogenated conjugated diene-based polymer in which a hydrogenation rate of a structural unit derived from a conjugated diene compound is 30 mol % or more and 99 mol % or less in one aspect) is, in one aspect, 50% by mass or more, or 60% by mass or more, or 80% by mass or more, from the viewpoint of providing a cured product having excellent ozone resistance. The above ratio may be 100% by mass, but in one aspect, it can be 90% by mass or less, or 80% by mass or less, or 70% by mass or less.

In the hydrogenated conjugated diene-based polymer composition, when the second rubber component contains a hydrogenated conjugated diene-based polymer (a hydrogenated conjugated diene-based polymer in which a hydrogenation rate of a structural unit derived from a conjugated diene compound is 30 mol % or more and 99 mol % or less in one aspect), the amount of the hydrogenated conjugated diene-based polymer (the amount of the hydrogenated conjugated diene-based polymer in which a hydrogenation rate of a structural unit derived from a conjugated diene compound is 30 mol % or more and 99 mol % or less in one aspect) in 100% by mass of the second rubber component is, in one aspect, 50% by mass or more, or 60% by mass or more, or 80% by mass or more, from the viewpoint of providing a cured product having excellent ozone resistance. In one aspect, the above ratio is 95% by mass or less, or 90% by mass or less, or 85% by mass or less.

In the hydrogenated conjugated diene-based polymer composition, when the second rubber component includes a hydrogenated conjugated diene-based polymer and a natural rubber, the amount of the hydrogenated conjugated diene-based polymer in 100% by mass of the second rubber component is, in one aspect, 5% by mass or more, 10% by mass or more, or 15% by mass or more, from the viewpoint of providing a cured product having an excellent balance between mechanical strength and ozone resistance. In one aspect, the ratio is 50% by mass or less, or 45% by mass or less, or 40% by mass or less.

In the hydrogenated conjugated diene-based polymer composition, the ratio of the hydrogenated conjugated diene-based polymer (the ratio of the hydrogenation rate of the structural unit derived from the conjugated diene compound is 30 mol % or more and 99 mol % or less in one aspect) in 100% by mass of the rubber component (the total of the first rubber and the second rubber in one aspect) is, in one aspect, 50% by mass or more, or 60% by mass or more, or 80% by mass or more, from the viewpoint of providing a cured product having excellent ozone resistance. In one aspect, the above ratio is 95% by mass or less, or 90% by mass or less, or 85% by mass or less.

In the hydrogenated conjugated diene-based polymer composition, when the rubber component includes a natural rubber, the amount of the hydrogenated conjugated diene-based polymer in 100% by mass of the rubber component (the total of the first rubber and the second rubber containing natural rubber in one aspect) is, in one aspect, 5% by mass or more, 10% by mass or more, or 15% by mass or more, from the viewpoint of providing a cured product having an excellent balance between mechanical strength and ozone resistance. In one aspect, the ratio is 50% by mass or less, or 45% by mass or less, or 40% by mass or less.

<Rubber Other than Hydrogenated Conjugated Diene-Based Polymer>

The rubber component, the first rubber component and the second rubber component of the present disclosure may each include a rubber other than a diene-based polymer, but are typically composed of a diene-based polymer. The masterbatch for rubber modification or the hydrogenated conjugated diene-based polymer composition may include, as a rubber component, a rubber other than a hydrogenated conjugated diene-based polymer (a hydrogenated conjugated diene-based polymer in which a hydrogenation rate of a structural unit derived from a conjugated diene compound is 30 mol % or more and 99 mol % or less in one aspect). Examples of such rubber include, but are not limited to, conjugated diene-based polymer, random copolymer of a conjugated diene compound and a vinyl aromatic compound, block copolymer of a conjugated diene-based compound and a vinyl aromatic compound, diene-based polymer such as natural rubber, and non-diene-based polymer.

Specific examples thereof include, but are not limited to, butadiene rubbers; isoprene rubbers; styrene-based elastomers such as styrene-butadiene rubbers, styrene-butadiene block copolymers, and styrene-isoprene block copolymers; acrylonitrile-butadiene rubbers and the like.

However, in an aspect in which the hydrogenated conjugated diene-based polymer is a polymer in which a hydrogenation rate of a structural unit derived from a conjugated diene compound is 30 mol % or more and 99 mol % or less, a rubber other than the hydrogenated conjugated diene-based polymer in which a hydrogenation rate of a structural unit derived from a conjugated diene compound is 30 mol % or more and 99 mol % or less may be used as the rubber other than the hydrogenated conjugated diene-based polymer. Examples of such rubber include, but are not limited to, butadiene rubber or hydrogenated products thereof; isoprene rubber or hydrogenated products thereof; styrene-based elastomers such as styrene-butadiene rubber or hydrogenated products thereof, styrene-butadiene block copolymer or hydrogenated products thereof, and styrene-isoprene block copolymer or hydrogenated products thereof; acrylonitrile-butadiene rubber or hydrogenated products thereof and the like.

In the hydrogenated conjugated diene-based polymer composition, the ratio of diene polymers other than hydrogenated conjugated diene-based polymers (the ratio of diene polymers other than hydrogenated conjugated diene-based polymers in which a hydrogenation rate of a structural unit derived from a conjugated diene compound is 30 mol % or more and 99 mol % or less in one aspect) in 100% by mass of the first rubber component, or in 100% by mass of the second rubber component, or in the total of 100% by mass of the first and second rubber components, is preferably 50% by mass or less, more preferably 40% by mass or less, and still more preferably 20% by mass or less, from the viewpoint of the ozone resistance of the cured product. In one aspect, the ratio may be 5% by mass or more, or 10% by mass or more, or 15% by mass or more.

In the hydrogenated conjugated diene-based polymer composition according to one aspect, the rubber component contains natural rubber, and in an aspect in which a masterbatch for rubber modification is used, the second rubber component includes a natural rubber. In this aspect, the first rubber component may or may not include a natural rubber. The natural rubber may be unmodified or modified.

From the viewpoint of having a high molecular weight component and excellent breaking strength, examples of the natural rubber include, but are not particularly limited to, smoke-dried RSS (Ribbed Smoked Sheet) No. 3 to 5; mechanically dried TSR (Technically Specified Rubber) such as SIR (Standard Indonesian Rubber) (made in Indonesia), STR (Standard Thai Rubber) (made in Thailand), and SMR (Standard Malaysian Rubber) (made in Malaysia); and epoxidized natural rubber.

### <Additives>

The rubber-modifying masterbatch or the hydrogenated conjugated diene-based polymer composition may include additives, in addition to the cellulose nanofibers and the rubber component. It is possible to use, as the additive, one or more types of various materials generally used in the rubber industry, such as organic or inorganic reinforcing fillers (e.g., carbon black, silica-based inorganic fillers, etc.), silane coupling agents, metal oxides or metal hydroxides, stearic acid, various antioxidants, rubber softening agents (oil, wax, etc.), vulcanizing agents (sulfur, organic peroxides, etc.), and vulcanization accelerators (sulfenamide-based or guanidine-based vulcanization accelerators, etc.). It is possible to use, as the additive, one or more types of additional polymers, dispersants, heat stabilizers, antioxidants, antistatic agents, colorants and the like.

### (Silica-Based Inorganic Filler)

The hydrogenated conjugated diene-based polymer composition of the present embodiment may include a silica-based inorganic filler. In a typical aspect, the silica-based inorganic filler is combined with the masterbatch for rubber modification during the production of the hydrogenated conjugated diene-based polymer composition. In the hydrogenated conjugated diene-based polymer composition, the content of the silica-based inorganic filler with respect to 100 parts by mass of the rubber component (the total of the first and second rubber components in one aspect) is preferably 10 parts by mass or more and 80 parts by mass or less, from the viewpoints of the mechanical strength and elastic modulus of the cured product. From the viewpoint of reducing the weight of the cured product, the content of the silica-based inorganic filler is preferably 80 parts by mass or less, or 50 parts by mass or less, or 30 parts by mass or less.

There is no particular limitation on the silica-based inorganic filler, and any known filler can be used, but solid particles containing SiO₂ or Si₃ Al as a structural unit are preferred, and it is more preferred that the main component of the structural unit is SiO₂ or Si₃ Al. Throughout the present disclosure, a main component means a component that accounts for more than 50% by mass, preferably 70% by mass or more, and more preferably 80% by mass or more of the total.

Examples of the silica-based inorganic filler include, but are not limited to, inorganic fibrous materials such as silica, clay, talc, mica, diatomaceous earth, wollastonite, montmorillonite, zeolite and glass fiber. Example of commercially available silica-based inorganic filler include “Ultrasil 7000GR” manufactured by Evonik Degussa. Examples also include silica-based inorganic fillers whose surfaces are made hydrophobic, and mixtures of silica-based inorganic fillers and inorganic fillers other than silica-based inorganic fillers. Of these, silica and glass fibers are preferred from the viewpoints of the strength and abrasion resistance, and silica is more preferred. Examples of silica include dry silica, wet silica and synthetic silicate silica. Of these, wet silica is more preferred from the viewpoint of excellent balance between the effect of improving the fracture properties and the wet skid resistance.

### (Carbon Black)

The hydrogenated conjugated diene-based polymer composition of the present embodiment may include carbon black. In a typical aspect, carbon black is combined with the masterbatch for rubber modification during the production of the hydrogenated conjugated diene-based polymer composition. In the hydrogenated conjugated diene-based polymer composition, the content of carbon black with respect to 100 parts by mass of the rubber component (the total of the first and second rubber components in one aspect) is preferably 10 parts by mass or more and 80 parts by mass or less, from the viewpoints of the mechanical strength and elastic modulus of the cured product. From the viewpoint of reducing the weight of the cured product, the amount of carbon black is preferably 80 parts by mass or less, or 50 parts by mass or less, or 30 parts by mass or less.

The carbon black is not particularly limited, and for example, carbon black of various classes such as SRF, FEF, HAF, ISAF and SAF can be used. Of these, from the viewpoint of the extrusion moldability and, for example, rolling resistance in tire applications, carbon black having a nitrogen adsorption specific surface area of 50 mL/100 g or more and a dibutyl phthalate (DBP) oil absorption of 80 mL/100 g or more is preferred. From the viewpoint of the availability of carbon black, the nitrogen adsorption specific surface area may be 130 m²/g or less or less in one aspect, and the dibutyl phthalate (DBP) oil absorption may be 120 mL/100 g or less in one aspect.

In a preferred aspect, the content of the reinforcing filler with respect to 100 parts by mass of the rubber component (the total of the first and second rubber components in one aspect) is preferably 10 parts by mass or more from the viewpoint of the mechanical strength and elastic modulus of the cured product, and is preferably 80 parts by mass or less, or 50 parts by mass or less, or 30 parts by mass or less from the viewpoint of reducing the weight of the cured product.

### (Metal Oxide, Metal Hydroxide)

The hydrogenated conjugated diene-based polymer composition of the present aspect may include a metal oxide and/or a metal hydroxide. In one aspect, the metal oxide is a solid particle including a structural unit represented by chemical formula MxOy (M represents a metal atom, and x and y each independently represent an integer of 1 to 6) as a main component. Examples thereof include alumina, titanium oxide, magnesium oxide, zinc oxide and the like.

The metal oxide may be used as a mixture with inorganic fillers. Examples of the metal hydroxide include, but are not particularly limited to, aluminum hydroxide, magnesium hydroxide, zirconium hydroxide and the like.

### (Rubber Softening Agent)

The hydrogenated conjugated diene-based polymer composition of the present aspect may include a rubber softening agent for the purpose of improving the processability. Suitable rubber softening agents include, for example, mineral oil-based rubber softening agents and liquid or low molecular weight synthetic softeners. The mineral oil-based rubber softening agent is also called process oil or extender oil, and is used to soften the rubber, increase its volume, or improve its processability. The mineral oil-based rubber softening agent contain aromatic ring, naphthenic ring, and paraffin chain, and those in which the carbon number of the paraffin chains accounts for 50% or more of the total carbons are called paraffinic, those in which the carbon number of the naphthenic rings accounts for 30 to 45% are called naphthenic, and those in which the aromatic carbon number exceeds 30% are called aromatic. As the rubber softening agent to be used together with the modified conjugated diene-aromatic vinyl copolymer, those having an appropriate aromatic content are preferred since they tend to have satisfactory affinity with the copolymer.

The rubber softening agent may be added during the production of the hydrogenated conjugated diene-based polymer, during the production of the masterbatch for rubber modification, and/or during the production of the hydrogenated conjugated diene-based polymer composition. In the hydrogenated conjugated diene-based polymer composition, the content of the rubber softening agent with respect to 100 parts by mass of the rubber component (the total of the first and second rubber components in one aspect) is preferably 5 parts by mass or more, more preferably 10 parts by mass or more, and still more preferably 30 parts by mass or more, from the viewpoint of improving the processability. From the viewpoint of suppressing bleed-out and preventing stickiness on the surface of the rubber composition, the amount is preferably 100 parts by mass or less, or 70 parts by mass or less, or 50 parts by mass or less, or 40 parts by mass or less, or 30 parts by mass or less.

### <Masterbatch for Rubber Modification>

The masterbatch for rubber modification of the present aspect includes a first rubber component containing the hydrogenated conjugated diene-based polymer of the present embodiment mentioned above, and cellulose nanofibers. The content of the first rubber component in the masterbatch for rubber modification is, in one aspect, 30% by mass or more, or 40% by mass or more, or 50% by mass or more, and in one aspect, 80% by mass or less, or 70% by mass or less, or 60% by mass or less.

### [Production of Masterbatch for Rubber Modification]

The masterbatch for rubber modification may be a kneaded product. Examples of the method of mixing constituent materials of the masterbatch for rubber modification include, but are not limited to, a melt-kneading method using general mixer such as an open roll, a Banbury mixer, a kneader, a single-screw extruder, a twin-screw extruder or a multi-screw extruder, and a method in which the components are dissolved and mixed and then the solvent is removed by heating. Of these, the melt kneading method using a roll, a Banbury mixer, a kneader or an extruder is preferred from the viewpoints of the productivity and kneading ability. It is also possible to apply either a method of kneading the constituent materials of the masterbatch for rubber modification of this aspect at once or a method of mixing them in several batches.

The kneading temperature may be about room temperature (about 15° C. to 30° C.), but may be high enough not to cause a crosslinking reaction of the rubber, for example 160° C. or lower, preferably 140° C. or lower, and more preferably 120° C. or lower. The lower limit is preferably 70° C. or higher, or 80° C. or higher. In one aspect, such lower limit is preferable from the viewpoint of ensuring the dispersibility of the cellulose nanofibers in the rubber component. In one aspect, the heating temperature is preferably 80 to 160° C., or 80 to 140° C., or 80 to 120° C.

Examples of the production method in which the masterbatch for rubber modification of the present disclosure includes a surfactant include a method comprising:
a step of preparing a cellulose nanofiber composition comprising cellulose nanofibers and a surfactant, and
a step of mixing the cellulose nanofiber composition with a first rubber component containing a hydrogenated conjugated diene-based polymer.

Examples of the production method in which the masterbatch for rubber modification of the present disclosure includes a surfactant and a liquid rubber include a method comprising:
a step of preparing a cellulose nanofiber composition comprising cellulose nanofibers, a liquid rubber and a surfactant, and
a step of mixing the cellulose nanofiber composition with a first rubber component containing a hydrogenated conjugated diene-based polymer.

In each of the above methods, the cellulose nanofiber composition may be a powder of the present disclosure.

When the masterbatch for rubber modification includes a modified liquid rubber, it is preferable to set the discharge temperature of the kneading process to a high temperature at which the modified liquid rubber reacts with the cellulose nanofibers. This makes it possible to obtain a cured product having high tensile modulus and high elastic modulus. From this viewpoint, the kneading temperature is preferably 100° C. to 170° C., or 120° C. to 160° C., or 150° C. to 160° C.

In order to improve the cohesiveness and handleability, the masterbatch for rubber modification is preferably molded into a sheet having a thickness of, for example, 10 mm to 40 mm, or 10 mm to 30 mm, using a rolling mill roll. The masterbatch for rubber modification may further include components other than those exemplified in the present disclosure, as long as the effects of the present invention are not impaired.

### <Hydrogenated Conjugated Diene-Based Polymer Composition>

The hydrogenated conjugated diene-based polymer composition of the present aspect include a rubber component and cellulose nanofibers. In one aspect, the hydrogenated conjugated diene-based polymer composition is a rubber composition comprising a component derived from a masterbatch for rubber modification, and a second rubber component containing a hydrogenated conjugated diene-based polymer. Use of the masterbatch for rubber modification makes it possible to obtain a rubber composition in which cellulose nanofibers are uniformly dispersed in the rubber. As a result, deterioration of the rubber physical properties during the kneading process is prevented and the dispersibility of fillers is improved, thus making it possible to achieve excellent tensile modulus and high elasticity. In one aspect, the hydrogenated conjugated diene-based polymer composition is a kneaded product of the masterbatch for rubber modification of the present aspect, a second rubber component, and one or more optional additives.

In the hydrogenated conjugated diene-based polymer composition, the content of the first rubber component derived from the masterbatch in the total of 100% by mass of the first and second rubber components is preferably 5% by mass or more, more preferably 10% by mass or more, and still more preferably 15% by mass or more, since the content of cellulose nanofibers in the rubber composition is not too small and the effects of the present invention can be satisfactorily obtained. In one aspect, the content may be 50% by mass or less, or 40% by mass or less, or 30% by mass or less, from the viewpoint of the dispersibility of the cellulose nanofibers in the rubber composition.

The content of the rubber components in the hydrogenated conjugated diene-based polymer composition (the total content of the first and second rubber components in one aspect) is, in one aspect, 70% by mass or more, or 80% by mass or more, or 90% by mass or more, and in one aspect, 99% by mass or less, or 95% by mass or less, or 90% by mass or less.

### [Production of Hydrogenated Conjugated Diene-Based Polymer Composition]

The hydrogenated conjugated diene-based polymer composition can be obtained by mixing a rubber component including a hydrogenated conjugated diene-based polymer, cellulose nanofibers (as a cellulose nanofiber composition in one aspect), and any additives (e.g., a silica-based inorganic filler, carbon black, other fillers, a silane coupling agent, a rubber softening agent, etc.). Examples of the method of mixing the constituent materials of the hydrogenated conjugated diene-based polymer composition include, but are not limited to, a melt-kneading method using a general mixer such as an open roll, a Banbury mixer, a kneader, a single-screw extruder, a twin-screw extruder or a multi-screw extruder, and a method in which the components are dissolved and mixed and then the solvent is removed by heating. Of these, the melt kneading method using a roll, a Banbury mixer, a kneader, or an extruder is preferred from the viewpoints of the productivity and kneadability. It is also possible to use either a method of kneading the constituent materials of the rubber composition of the present aspect all at once or a method of mixing them in several batches.

From the viewpoint of properties such as dispersibility of cellulose nanofibers, and tensile modulus and elastic modulus of the cured product, it is preferable to produce a mixture (masterbatch) of the first rubber component containing a hydrogenated conjugated diene-based polymer and the cellulose nanofibers in advance.

Examples of the production method in which the hydrogenated conjugated diene-based polymer composition of the present disclosure includes a surfactant include a method comprising:
a step of preparing a cellulose nanofiber composition comprising cellulose nanofibers and a surfactant,
a step of mixing the cellulose nanofiber composition with a first rubber component containing a hydrogenated conjugated diene-based polymer to prepare a masterbatch for rubber modification, and
a step of mixing the masterbatch for rubber modification with a second rubber component to prepare a hydrogenated conjugated diene-based polymer composition.

Examples of the production method in which the hydrogenated conjugated diene-based polymer composition of the present disclosure includes a surfactant and a liquid rubber include a method comprising:
a step of preparing a cellulose nanofiber composition comprising cellulose nanofibers, a liquid rubber and a surfactant,
a step of mixing the cellulose nanofiber composition with a first rubber component containing a hydrogenated conjugated diene-based polymer to prepare a masterbatch for rubber modification, and
a step of mixing the masterbatch for rubber modification with a second rubber component to prepare a hydrogenated conjugated diene-based polymer composition.

In each of the above methods, the cellulose nanofiber composition may be a powder of the present disclosure.

### <Hydrogenated Conjugated Diene-Based Polymer Cured Product>

The hydrogenated conjugated diene-based polymer composition of the present aspect may be subjected to a vulcanization treatment with a vulcanizing agent to form a vulcanized composition (hydrogenated conjugated diene-based polymer cured product). Examples of the vulcanizing agent include, but are not limited to, radical generators such as organic peroxides and azo compounds, oxime compounds, nitroso compounds, polyamine compounds, sulfur, and sulfur compounds. The sulfur compounds include sulfur monochloride, sulfur dichloride, disulfide compounds, polymeric polysulfur compounds and the like. The content of the vulcanizing agent is preferably 0.01 part by mass or more and 20 parts by mass or less, and more preferably 0.1 part by mass or more and 15 parts by mass or less, with respect to 100 parts by mass of the rubber component (the total of the first and second rubber components in one aspect). As the vulcanization method, a conventionally known method can be applied, and the vulcanization temperature is preferably 120° C. or higher and 200° C. or lower, and more preferably 140° C. or higher and 180° C. or lower.

At the time of vulcanization, a vulcanization accelerator may be used as necessary. As the vulcanization accelerator, a conventionally known material can be used, and examples thereof include, but are not limited to, sulfenamide-based, guanidine-based, thiuram-based, aldehyde-amine-based, aldehyde-ammonia-based, thiazole-based, thiourea-based and dithiocarbamate-based vulcanization accelerators. Further, examples of the vulcanization aid include, but are not limited to, zinc oxide and stearic acid. The content of the vulcanization accelerator is preferably 0.01 part by mass or more and 20 parts by mass or less, and more preferably 0.1 part by mass or more and 15 parts by mass or less, with respect to 100 parts by mass of the rubber component (the total of the first and second rubber components in one aspect).

### [Morphology of Hydrogenated Conjugated Diene-Based Polymer Cured Product]

In one aspect of the cured product when natural rubber is used, the hydrogenated conjugated diene-based polymer and cellulose nanofibers are dispersed in a continuous phase containing natural rubber. The fact that the hydrogenated conjugated diene-based polymer is dispersed in the continuous phase containing a natural rubber means that at least part, typically major part (more specifically, 50 area % or more of the entire hydrogenated conjugated diene-based polymer on a cross-sectional image taken by a scanning electron microscope), and more typically the entire hydrogenated conjugated diene-based polymer (or substantially the entire hydrogenated conjugated diene-based polymer) is dispersed in the continuous phase. It is particularly advantageous that the hydrogenated conjugated diene-based polymer is dispersed in the continuous phase in terms of the mechanical strength and ozone resistance of the cured product of the hydrogenated conjugated diene-based polymer. Further, the fact that the cellulose nanofibers are dispersed in a continuous phase containing natural rubber means that at least part, typically major part (more specifically, 50 area % or more of the entire cellulose nanofiber on a cross-sectional image taken by a scanning electron microscope), and more typically all (or substantially all) of the cellulose nanofibers are dispersed in the continuous phase. The fact that the cellulose nanofibers are dispersed in the continuous phase means that the cellulose nanofibers are uniformly dispersed in the cured product of the hydrogenated conjugated diene-based polymer, which is particularly advantageous in terms of the mechanical properties of the cured product.

In one aspect, the hydrogenated conjugated diene-based polymer has a median diameter of 50 nm or more and 1,000 nm or less and is dispersed in the continuous phase (matrix) as particles (domain particles). From the viewpoint of improving the mechanical strength of the cured product, the median diameter is preferably 50 nm or more, or 70 nm or more, or 100 nm or more, and from the viewpoint of improving the ozone resistance and mechanical strength of the cured product, the median diameter is preferably 1,000 nm or less, or 900 nm or less, or 800 nm or less. The median diameter is D50 of the equivalent circle diameter of the hydrogenated conjugated diene-based polymer, which is determined from a cross-sectional image of the cured product taken by a scanning electron microscope.

The present invention encompasses the following items.

### <<Aspect A>>

### [Item 1]

A hydrogenated conjugated diene-based polymer composition comprising a hydrogenated conjugated diene-based polymer in which a hydrogenation rate of a structural unit derived from a conjugated diene compound is 30 mol % or more and 99 mol % or less, and
cellulose nanofibers.

### [Item 2]

A masterbatch for rubber modification comprising 100 parts by mass of a first rubber component containing 50% by mass or more of a hydrogenated conjugated diene-based polymer in which a hydrogenation rate of a structural unit derived from a conjugated diene compound is 30 mol % or more and 99 mol % or less, and
15 parts by mass or more and 100 parts by mass or less of cellulose nanofibers.

### [Item 3]

The masterbatch for rubber modification according to item 2, wherein the hydrogenated conjugated diene-based polymer has a weight average molecular weight of 200,000 or more and 2,000,000 or less.

### [Item 4]

The masterbatch for rubber modification according to item 2 or 3, wherein the hydrogenated conjugated diene-based polymer comprises 3% by mass or more and 60% by mass or less of an aromatic vinyl monomer unit.

### [Item 5]

The masterbatch for rubber modification according to any one of items 2 to 4, wherein the cellulose nanofibers have no ionic groups.

### [Item 6]

The masterbatch for rubber modification according to any one of items 2 to 5, wherein the masterbatch for rubber modification further comprises a surfactant.

### [Item 7]

The masterbatch for rubber modification according to item 6, wherein the surfactant is a nonionic surfactant.

### [Item 8]

The masterbatch for rubber modification according to item 7, wherein the nonionic surfactant is a compound having a hydrophilic group selected from the group consisting of hydroxyl, carboxy, sulfonic acid and amino groups, and a hydrocarbon group.

### [Item 9]

The masterbatch for rubber modification according to item 7 or 8, wherein the nonionic surfactant is one or more types selected from the group consisting of compounds represented by the following general formula (1):

R—(OCH₂CH₂)ₘ—OH (1)
wherein R represents a monovalent aliphatic group of 6 to 30 carbon atoms, and m is a natural number smaller than the number of carbon atoms of R, and
   compounds represented by the following general formula (2):

R¹OCH₂—(CHOH)₄—CH₂OR₂ (2)
wherein R¹ and R² each independently represent a hydrogen atom, an aliphatic group of 1 to 30 carbon atoms, —COR₃ {wherein R³ represents an aliphatic group of 1 to 30 carbon atoms} or —(CH₂CH₂O)_{y}—R⁴ {wherein R⁴ represents a hydrogen atom or an aliphatic group of 1 to 30 carbon atoms, and y is an integer of 1 to 30}.

### [Item 10]

The masterbatch for rubber modification according to any one of items 6 to 9, wherein the masterbatch for rubber modification further comprises a liquid rubber.

### [Item 11]

The masterbatch for rubber modification according to item 10, wherein the liquid rubber has a number average molecular weight of 1,000 to 80,000.

### [Item 12]

The masterbatch for rubber modification according to item 10 or 11, wherein a ratio (Mw/Mn) of the weight average molecular weight (Mw) to the number average molecular weight (Mn) of the liquid rubber is 1.5 to 5.

### [Item 13]

The masterbatch for rubber modification according to any one of items 10 to 12, wherein the liquid rubber comprises one or more types selected from the group consisting of a diene-based rubber, a silicone rubber, a urethane rubber, and a polysulfide rubber and a hydrogenated product thereof.

### [Item 14]

The masterbatch for rubber modification according to any one of items 10 to 13, wherein the liquid rubber comprises a modified liquid rubber modified with an unsaturated carboxylic acid and/or a derivative thereof.

### [Item 15]

The masterbatch for rubber modification according to item 14, comprising 10 parts by mass or more and 200 parts by mass or less of the modified liquid rubber with respect to 100 parts by mass of the first rubber component.

### [Item 16]

A hydrogenated conjugated diene-based polymer composition, which is a kneaded product comprising the masterbatch for rubber modification according to any one of items 2 to 15 and a second rubber component.

### [Item 17]

The hydrogenated conjugated diene-based polymer composition according to item 16, comprising 1 part by mass or more and 15 parts by mass or less of cellulose nanofibers with respect to 100 parts by mass in total of the first rubber component and the second rubber component.

### [Item 18]

The hydrogenated conjugated diene-based polymer composition according to item 16 or 17, comprising 10 parts by mass or more and 80 parts by mass or less of a reinforcing filler with respect to 100 parts by mass in total of the first rubber component and the second rubber component.

### [Item 19]

The hydrogenated conjugated diene-based polymer composition according to any one of items 16 to 18, comprising a modified liquid rubber modified with an unsaturated carboxylic acid and/or a derivative thereof.

### [Item 20]

The hydrogenated conjugated diene-based polymer composition according to item 19, comprising 1 part by mass or more and 25 parts by mass or less of the modified liquid rubber with respect to 100 parts by mass in total of the first rubber component and the second rubber component.

### [Item 21]

A hydrogenated conjugated diene-based polymer cured product, which is a cured product of the hydrogenated conjugated diene-based polymer composition according to any one of items 16 to 20.

### [Item 22]

A hydrogenated conjugated diene-based polymer composition comprising 100 parts by mass of a rubber component containing 50% by mass or more of a hydrogenated conjugated diene-based polymer in which a hydrogenation rate of a structural unit derived from a conjugated diene compound is 30 mol % or more and 99 mol % or less, and
part by mass or more and 15 parts by mass or less of cellulose nanofibers.

### [Item 23]

The hydrogenated conjugated diene-based polymer composition according to item 22, wherein the hydrogenated conjugated diene-based polymer has a weight average molecular weight of 200,000 or more and 2,000,000 or less.

### [Item 24]

The hydrogenated conjugated diene-based polymer composition according to item 22 or 23, wherein the hydrogenated conjugated diene-based polymer includes 3% by mass or more and 60% by mass or less of an aromatic vinyl monomer unit.

### [Item 25]

The hydrogenated conjugated diene-based polymer composition according to any one of items 22 to 24, wherein the cellulose nanofibers have no ionic groups.

### [Item 26]

The hydrogenated conjugated diene-based polymer composition according to any one of items 22 to 25, wherein the hydrogenated conjugated diene-based polymer composition further comprises a surfactant.

### [Item 27]

The hydrogenated conjugated diene-based polymer composition according to item 26, wherein the surfactant is a nonionic surfactant.

### [Item 28]

The hydrogenated conjugated diene-based polymer composition according to item 27, wherein the nonionic surfactant is a compound having a hydrophilic group selected from the group consisting of hydroxyl, carboxy, sulfonic acid and amino groups, and a hydrocarbon group.

### [Item 29]

The hydrogenated conjugated diene-based polymer composition according to item 27 or 28, wherein the nonionic surfactant is one or more types selected from the group consisting of compounds represented by the following general formula (1):

R—(OCH₂CH₂)ₘ—OH (1)
wherein R represents a monovalent aliphatic group of 6 to 30 carbon atoms, and m is a natural number smaller than the number of carbon atoms of R, and
   compounds represented by the following general formula (2):

R¹OCH₂—(CHOH)₄—CH₂OR₂ (2)
wherein R¹ and R² each independently represent a hydrogen atom, an aliphatic group of 1 to 30 carbon atoms, —COR₅ {wherein R³ represents an aliphatic group of 1 to 30 carbon atoms} or —(CH₂CH₂O)_{y}—R⁴ {wherein R⁴ represents a hydrogen atom or an aliphatic group of 1 to 30 carbon atoms, and y is an integer of 1 to 30}.

### [Item 30]

The hydrogenated conjugated diene-based polymer composition according to any one of items 26 to 29, wherein the hydrogenated conjugated diene-based polymer composition further comprises a liquid rubber.

### [Item 31]

The hydrogenated conjugated diene-based polymer composition according to item 30, wherein the liquid rubber has a number average molecular weight of 1,000 to 80,000.

### [Item 32]

The hydrogenated conjugated diene-based polymer composition according to item 30 or 31, wherein a ratio (Mw/Mn) of the weight average molecular weight (Mw) to the number average molecular weight (Mn) of the liquid rubber is 1.5 to 5.

### [Item 33]

The hydrogenated conjugated diene-based polymer composition according to any one of items 30 to 32, wherein the liquid rubber comprises one or more types selected from the group consisting of a diene-based rubber, a silicone rubber, a urethane rubber, and a polysulfide rubber and a hydrogenated product thereof.

### [Item 34]

The hydrogenated conjugated diene-based polymer composition according to any one of items 30 to 33, wherein the liquid rubber comprises a modified liquid rubber modified with an unsaturated carboxylic acid and/or a derivative thereof.

### [Item 35]

The hydrogenated conjugated diene-based polymer composition according to item 34, comprising 1 part by mass or more and 25 parts by mass or less of the modified liquid rubber with respect to 100 parts by mass of the rubber component.

### [Item 36]

The hydrogenated conjugated diene-based polymer composition according to any one of items 22 to 35, comprising 10 parts by mass or more and 80 parts by mass or less of a reinforcing filler with respect to 100 parts by mass of the rubber component.

### [Item 37]

A hydrogenated conjugated diene-based polymer cured product, which is a cured product of the hydrogenated conjugated diene-based polymer composition according to any one of items 22 to 36.

### [Item 38]

A method for producing the masterbatch for rubber modification according to any one of items 6 to 15, the method comprising:
a step of preparing a cellulose nanofiber composition comprising cellulose nanofibers and a surfactant, and
a step of mixing the cellulose nanofiber composition with a first rubber component containing a hydrogenated conjugated diene-based polymer.

### [Item 39]

A method for producing the masterbatch for rubber modification according to any one of items 10 to 15, the method comprising:
a step of preparing a cellulose nanofiber composition comprising cellulose nanofibers, a liquid rubber and a surfactant, and
a step of mixing the cellulose nanofiber composition with a first rubber component containing a hydrogenated conjugated diene-based polymer.

### [Item 40]

The method according to item 38 or 39, wherein the cellulose nanofiber composition is a powder.

### [Item 41]

A method for producing the hydrogenated conjugated diene-based polymer composition according to any one of items 26 to 36, the method comprising:
a step of preparing a cellulose nanofiber composition comprising cellulose nanofibers and a surfactant,
a step of mixing the cellulose nanofiber composition with a first rubber component containing a hydrogenated conjugated diene-based polymer to prepare a masterbatch for rubber modification, and
a step of mixing the masterbatch for rubber modification with a second rubber component to prepare a hydrogenated conjugated diene-based polymer composition.

### [Item 42]

A method for producing the hydrogenated conjugated diene-based polymer composition according to any one of items 30 to 36, the method comprising:
a step of preparing a cellulose nanofiber composition comprising cellulose nanofibers, a liquid rubber and a surfactant,
a step of mixing the cellulose nanofiber composition with a first rubber component containing a hydrogenated conjugated diene-based polymer to prepare a masterbatch for rubber modification, and
a step of mixing the masterbatch for rubber modification with a second rubber component to prepare a hydrogenated conjugated diene-based polymer composition.

### [Item 43]

The method according to item 41 or 42, wherein the cellulose nanofiber composition is a powder.

### <<Aspect B>>

### [Item 1]

A hydrogenated conjugated diene-based polymer composition comprising 100 parts by mass of a first rubber component containing 5% by mass or more of a hydrogenated conjugated diene-based polymer and a natural rubber, and 1 part by mass or more and 15 parts by mass or less of cellulose nanofibers.

### [Item 2]

The hydrogenated conjugated diene-based polymer composition according to item 1, wherein the hydrogenated conjugated diene-based polymer has a weight average molecular weight of 200,000 or more and 2,000,000 or less.

### [Item 3]

The hydrogenated conjugated diene-based polymer composition according to item 1 or 2, wherein the hydrogenated conjugated diene-based polymer has a solubility parameter (SP value) of 16.8 (MPa)^{1/2} or more and 17.6 (MPa)^{1/2} or less.

### [Item 4]

The hydrogenated conjugated diene-based polymer composition according to any one of items 1 to 3, wherein the cellulose nanofibers have no ionic groups.

### [Item 5]

The hydrogenated conjugated diene-based polymer composition according to any one of items 1 to 4, wherein the hydrogenated conjugated diene-based polymer composition further comprises a surfactant.

### [Item 6]

The hydrogenated conjugated diene-based polymer composition according to item 5, wherein the surfactant is a nonionic surfactant.

### [Item 7]

The hydrogenated conjugated diene-based polymer composition according to item 6, wherein the nonionic surfactant is a compound having a hydrophilic group selected from the group consisting of hydroxyl, carboxy, sulfonic acid and amino groups, and a hydrocarbon group.

### [Item 8]

The hydrogenated conjugated diene-based polymer composition according to item 6 or 7, wherein the nonionic surfactant is one or more types selected from the group consisting of compounds represented by the following general formula (1):

R—(OCH₂CH₂)ₘ—OH (1)
wherein R represents a monovalent aliphatic group of 6 to 30 carbon atoms, and m is a natural number smaller than the number of carbon atoms of R, and
   compounds represented by the following general formula (2):

R¹OCH₂—(CHOH)₄—CH₂OR₂ (2)
wherein R¹ and R² each independently represent a hydrogen atom, an aliphatic group of 1 to 30 carbon atoms, —COR₃ {wherein R⁵ represents an aliphatic group of 1 to 30 carbon atoms} or —(CH₂CH₂O)_{y}—R⁴ {wherein R⁴ represents a hydrogen atom or an aliphatic group of 1 to 30 carbon atoms, and y is an integer of 1 to 30}.

### [Item 9]

The hydrogenated conjugated diene-based polymer composition according to any one of items 5 to 8, wherein the hydrogenated conjugated diene-based polymer composition further comprises a liquid rubber.

### [Item 10]

The hydrogenated conjugated diene-based polymer composition according to item 9, wherein the liquid rubber has a number average molecular weight of 1,000 to 80,000.

### [Item 11]

The hydrogenated conjugated diene-based polymer composition according to item 9 or 10, wherein a ratio (Mw/Mn) of the weight average molecular weight (Mw) to the number average molecular weight (Mn) of the liquid rubber is 1.5 to 5.

### [Item 12]

The hydrogenated conjugated diene-based polymer composition according to any one of items 9 to 11, wherein the liquid rubber comprises one or more types selected from the group consisting of a diene-based rubber, a silicone rubber, a urethane rubber, and a polysulfide rubber and a hydrogenated product thereof.

### [Item 13]

The hydrogenated conjugated diene-based polymer composition according to any one of items 9 to 12, wherein the liquid rubber comprises a modified liquid rubber modified with an unsaturated carboxylic acid and/or a derivative thereof.

### [Item 14]

The hydrogenated conjugated diene-based polymer composition according to item 13, comprising 1 part by mass or more and 25 parts by mass or less of the modified liquid rubber with respect to 100 parts by mass of the rubber component.

### [Item 15]

The hydrogenated conjugated diene-based polymer composition according to any one of items 1 to 14, comprising 10 parts by mass or more and 80 parts by mass or less of a reinforcing filler with respect to 100 parts by mass of the rubber component.

### [Item 16]

A masterbatch for natural rubber modification comprising 100 parts by mass of a first rubber component containing 50% by mass or more of a hydrogenated conjugated diene-based polymer, and 15 parts by mass or more and 100 parts by mass or less of cellulose nanofibers.

### [Item 17]

The masterbatch for natural rubber modification according to item 16, wherein the hydrogenated conjugated diene-based polymer has a weight average molecular weight of 200,000 or more and 2,000,000 or less.

### [Item 18]

The masterbatch for natural rubber modification according to item 16 or 17, wherein the hydrogenated conjugated diene-based polymer has a solubility parameter (SP value) of 16.8 (MPa)^{1/2} or more and 17.6 (MPa)^{1/2} or less.

The masterbatch for natural rubber modification according to any one of items 16 to 18, wherein the cellulose nanofibers have no ionic groups.

### [Item 20]

The masterbatch for natural rubber modification according to any one of items 16 to 19, wherein the masterbatch for natural rubber modification further comprises a surfactant.

### [Item 21]

The masterbatch for natural rubber modification according to item 20, wherein the surfactant is a nonionic surfactant.

### [Item 22]

The masterbatch for natural rubber modification according to item 21, wherein the nonionic surfactant is a compound having a hydrophilic group selected from the group consisting of hydroxyl, carboxy, sulfonic acid and amino groups, and a hydrocarbon group.

### [Item 23]

The masterbatch for natural rubber modification according to item 21 or 22, wherein the nonionic surfactant is one or more types selected from the group consisting of compounds represented by the following general formula (1):

R—(OCH₂CH₂)ₘ—OH (1)
wherein R represents a monovalent aliphatic group of 6 to 30 carbon atoms, and m is a natural number smaller than the number of carbon atoms of R, and
   compounds represented by the following general formula (2):

R¹OCH₂—(CHOH)₄—CH₂OR₂ (2)
wherein R¹ and R² each independently represent a hydrogen atom, an aliphatic group of 1 to 30 carbon atoms, —COR₃ {wherein R⁵ represents an aliphatic group of 1 to 30 carbon atoms} or —(CH₂CH₂O)_{y}—R⁴ {wherein R⁴ represents a hydrogen atom or an aliphatic group of 1 to 30 carbon atoms, and y is an integer of 1 to 30}.

### [Item 24]

The masterbatch for natural rubber modification according to item 20 to 23, wherein the masterbatch for natural rubber modification further comprises a liquid rubber.

### [Item 25]

The masterbatch for natural rubber modification according to item 24, wherein the liquid rubber has a number average molecular weight of 1,000 to 80,000.

### [Item 26]

The masterbatch for natural rubber modification according to item 24 or 25, wherein a ratio (Mw/Mn) of the weight average molecular weight (Mw) to the number average molecular weight (Mn) of the liquid rubber is 1.5 to 5.

### [Item 27]

The masterbatch for natural rubber modification according to any one of items 24 to 26, wherein the liquid rubber comprises one or more types selected from the group consisting of a diene-based rubber, a silicone rubber, a urethane rubber, and a polysulfide rubber and a hydrogenated product thereof.

### [Item 28]

The masterbatch for natural rubber modification according to any one of items 24 to 27, wherein the liquid rubber comprises a modified liquid rubber modified with an unsaturated carboxylic acid and/or a derivative thereof.

### [Item 29]

The masterbatch for natural rubber modification according to item 28, comprising 10 parts by mass or more and 200 parts by mass or less of the modified liquid rubber with respect to 100 parts by mass of the first rubber component.

### [Item 30]

A hydrogenated conjugated diene-based polymer composition, which is a kneaded product comprising the masterbatch for rubber modification according to any one of items 16 to 29 and a second rubber component.

### [Item 31]

The hydrogenated conjugated diene-based polymer composition according to item 30, comprising 1 part by mass or more and 15 parts by mass or less of cellulose nanofibers with respect to 100 parts by mass in total of the first rubber component and the second rubber component.

### [Item 32]

The hydrogenated conjugated diene-based polymer composition according to item 30 or 31, comprising 10 parts by mass or more and 80 parts by mass or less of a reinforcing filler with respect to 100 parts by mass in total of the first rubber component and the second rubber component.

### [Item 33]

The hydrogenated conjugated diene-based polymer composition according to any one of items 30 to 32, comprising a modified liquid rubber modified with an unsaturated carboxylic acid and/or a derivative thereof.

### [Item 34]

The hydrogenated conjugated diene-based polymer composition according to item 33, comprising 1 part by mass or more and 25 parts by mass or less of the modified liquid rubber with respect to 100 parts by mass in total of the first rubber component and the second rubber component.

### [Item 35]

A hydrogenated conjugated diene-based polymer cured product, which is a cured product of the hydrogenated conjugated diene-based polymer composition according to any one of items 1 to 15.

### [Item 36]

A hydrogenated conjugated diene-based polymer cured product, which is a cured product of the hydrogenated conjugated diene-based polymer composition according to any one of items 30 to 34.

### [Item 37]

A method for producing the hydrogenated conjugated diene-based polymer composition according to any one of items 5 to 14, the method comprising:
a step of preparing a cellulose nanofiber composition comprising cellulose nanofibers and a surfactant,
a step of mixing the cellulose nanofiber composition with a first rubber component containing a hydrogenated conjugated diene-based polymer to prepare a masterbatch for natural rubber modification, and
a step of mixing the masterbatch for natural rubber modification with a second rubber component containing a natural rubber to prepare a hydrogenated conjugated diene-based polymer composition.

### [Item 38]

A method for producing the hydrogenated conjugated diene-based polymer composition according to any one of items 9 to 14, the method comprising:
a step of preparing a cellulose nanofiber composition comprising cellulose nanofibers, a liquid rubber and a surfactant,
a step of mixing the cellulose nanofiber composition with a first rubber component containing a hydrogenated conjugated diene-based polymer to prepare a masterbatch for natural rubber modification, and
a step of mixing the masterbatch for natural rubber modification with a second rubber component containing a natural rubber to prepare a hydrogenated conjugated diene-based polymer composition.

### [Item 39]

The method according to item 37 or 38, wherein the cellulose nanofiber composition is a powder.

### [Item 40]

A method for producing the masterbatch for natural rubber modification according to any one of items 20 to 29, the method comprising:
a step of preparing a cellulose nanofiber composition comprising cellulose nanofibers and a surfactant, and
a step of mixing the cellulose nanofiber composition with a first rubber component containing a hydrogenated conjugated diene-based polymer.

### [Item 41]

A method for producing the masterbatch for natural rubber modification according to any one of items 24 to 29, the method comprising:
a step of preparing a cellulose nanofiber composition comprising cellulose nanofibers, a liquid rubber and a surfactant, and
a step of mixing the cellulose nanofiber composition with a first rubber component containing a hydrogenated conjugated diene-based polymer.

### [Item 42]

The method according to item 40 or 41, wherein the cellulose nanofiber composition is a powder.

### EXAMPLES

The present embodiment will be described in more detail by way of the following specific Examples and Comparative Examples, but the present embodiment is not limited to the following Examples and Comparative Examples unless it departs from the scope thereof. Various physical properties in the following Examples and Comparative Examples were measured by the methods shown below.

### (1) Example A

### (Weight Average Molecular Weight)

A chromatogram was measured using a GPC (gel permeation chromatography) measurement apparatus including a series of three columns using a polystyrene-based gel as a filler, and the weight average molecular weight (Mw) was calculated based on a calibration curve obtained using standard polystyrene. The specific measurement conditions are as follows. The following measurement solution (20 μuL) was injected into the GPC measurement apparatus and the measurement was carried out.

### (Measurement Conditions)

Apparatus: Trade name “HLC-8320 GPC”, manufactured by Tosoh Corporation
Eluent: Tetrahydrofuran (THF) containing 5 mmol/L of triethylamine
Guard column: trade name “TSKguardcolumn Super H-H”, manufactured by Tosoh Corporation
Separation column: series of three columns of trade name “TSKgel SuperH5000”, “TSKgel SuperH6000” and “TSKgel SuperH7000”, manufactured by Tosoh Corporation
Oven temperature: 40° C.
Flow rate: 0.6 mL/min
Detector: RI detector (trade name “HLC8020”, manufactured by Tosoh Corporation)
Measurement solution: A measurement solution (20 μuL) prepared by dissolving 10 mg of a measurement sample in 20 mL of THF was injected into the GPC measurement apparatus.

### (Bound Styrene Content)

A sample (100 mg) was dissolved and diluted to 100 mL of chloroform to obtain a measurement sample. An amount of absorption by a phenyl group of styrene at an ultraviolet absorption wavelength (about 254 nm) was used to measure the bound styrene content (% by mass) with respect to 100% by mass of the rubber-like polymer used as the sample. A spectrophotometer “UV-2450” manufactured by Shimadzu Corporation was used as the measurement apparatus.

### (Microstructure of Butadiene Portion: 1,2-Vinyl Bond Content)

A conjugated diene-based polymer was used as a sample, and 50 mg of the sample was dissolved in 10 mL of carbon disulfide to obtain a measurement sample. An infrared spectrum was measured within a range of 600 to 1,000 cm⁻¹ using a solution cell, and based on an absorbance at a prescribed wavelength, a microstructure of a butadiene portion, namely, a 1,2-vinyl bond content (% by mol), was determined in accordance with an equation of Hampton's method (method mentioned in R. R. Hampton, Analytical Chemistry 21, 923 (1949). Fourier transform infrared spectrophotometer “FT-IR230” manufactured by JASCO Corporation was used as a measurement apparatus.

### (Hydrogenation Rate of Conjugated Diene-Based Polymer and Ethylene Structure)

The integrated value of the unsaturated bond portion of the polymer before hydrogenation was obtained by H-NMR measurement. A large amount of methanol was then added to the reaction solution after the hydrogenation reaction to precipitate and recover a hydrogenated conjugated diene-based polymer. The hydrogenated conjugated diene-based polymer was then extracted with acetone, and the hydrogenated conjugated diene-based polymer was vacuum-dried. This was used as a sample for H-NMR measurement to measure the hydrogenation rate, ethylene structure and conjugated diene monomer unit. The H-NMR measurement conditions were as follows:

### (Measurement Conditions)

Apparatus: JNM-LA400 (manufactured by JEOL Ltd.)
Solvent: Deuterated chloroform
Measurement sample: Sampled product before and after hydrogenation of polymere
Sample concentration: 50 mg/mL
Observation frequency: 400 MHZ
Chemical shift reference: TMS (tetramethylsilane)
Pulse delay: 2.904 sec
Number of scans: 64
Pulse width: 45°
Measurement temperature: 26° C.

### (Mooney Viscosity of Conjugated Diene-Based Polymer and Hydrogenated Conjugated Diene-Based Polymer)

Using a Mooney viscometer (trade name “VR1132”, manufactured by Ueshima Seisakusho Co., Ltd.), a Mooney viscosity was measured with an L-type rotor in accordance with JIS K6300. The measurement temperature was set at 110° C. when a conjugated diene-based polymer was used as a sample, and the measurement temperature was set at 100° C. when a modified conjugated diene-based polymer was used as a sample. First, the sample was preheated at the test temperature for 1 minute and, after rotating the rotor was at 2 rpm, a torque was measured after 4 minutes, and the thus obtained measured value was defined as a Mooney viscosity (ML (1+4)).

### (Production Example 1) Conjugated Diene-Based Polymer Before Hydrogenation (SB-1)

Using a temperature-controllable 40 L capacity autoclave equipped with a stirrer and a jacket as a reactor, 2,700 g of 1,3-butadiene, 300 g of styrene, 21,000 g of cyclohexane, and 30 mmol of tetrahydrofuran (THF) and 4.9 mmol of 2,2-bis(2-oxolanyl) propane as polar substances, from which impurities had been removed, were charged in the reactor, and the internal temperature of the reactor was maintained at 42° C. As a polymerization initiator, 33.2 mmol of n-butyllithium was fed to the reactor.

After the polymerization reaction started, the temperature inside the reactor began to rise due to heat generated by the polymerization, and the temperature inside the reactor finally reached 82° C. Two minutes after the reaction temperature reached its peak, 34.0 mmol of methanol was added as a reaction terminator to obtain a rubber-like polymer solution. A part of the conjugated diene-based polymer solution was withdrawn and the solvent was removed in a dryer to obtain a conjugated diene-based polymer before hydrogenation (SB-1). The analysis results are shown in Table 1.

### (Production Example 2) Conjugated Diene-Based Polymer Before Hydrogenation (SB-2)

Using a temperature-controllable 40 L capacity autoclave equipped with a stirrer and a jacket as a reactor, 2,200 g of 1,3-butadiene, 780 g of styrene, 21,000 g of cyclohexane, and 30 mmol of tetrahydrofuran (THF) and 18.3 mmol of 2,2-bis(2-oxolanyl) propane as polar substances, from which impurities had been removed, were charged in the reactor, and the internal temperature of the reactor was maintained at 42° C. As a polymerization initiator, 26.2 mmol of n-butyllithium was fed to the reactor.

After the polymerization reaction started, the temperature inside the reactor began to rise due to heat generated by the polymerization, and the temperature inside the reactor finally reached 81° C. Two minutes after the reaction temperature reached its peak, 27.0 mmol of methanol was added as a reaction terminator to obtain a rubber polymer solution (B-1). A part of the conjugated diene-based polymer solution was withdrawn and the solvent was removed in a dryer to obtain a rubber-like polymer before hydrogenation (SB-2). The analysis results are shown in Table 1.

### (Production Example 3) Conjugated Diene-Based Polymer Before Hydrogenation (SB-3)

Using a temperature-controllable 40 L capacity autoclave equipped with a stirrer and a jacket as a reactor, 1,800 g of 1,3-butadiene, 1,200 g of styrene, 21,000 g of cyclohexane, and 30 mmol of tetrahydrofuran (THF) and 3.5 mmol of 2,2-bis(2-oxolanyl) propane as polar substances, from which impurities had been removed, were charged in the reactor, and the internal temperature of the reactor was maintained at 40° C. As a polymerization initiator, 24.2 mmol of n-butyllithium was fed to the reactor.

After the polymerization reaction started, the temperature inside the reactor began to rise due to heat generated by the polymerization, and the temperature inside the reactor finally reached 82° C. Two minutes after the reaction temperature reached its peak, 25.0 mmol of methanol was added as a reaction terminator to obtain a rubber-like polymer solution. A part of the conjugated diene-based polymer solution was withdrawn and the solvent was removed in a dryer to obtain a rubber-like polymer before hydrogenation (SB-3). The analysis results are shown in Table 1.

### (Preparation of Hydrogenated Catalyst (TC1))

1 L of dried and purified cyclohexane was charged into the nitrogen-substituted reaction solution and 100 mmol of bis(η5-cyclopentadienyl) titanium dichloride was added, and then an n-hexane solution containing 200 mmol of trimethylaluminum was added while sufficiently stirring, followed by reaction at room temperature for about 3 days to obtain a hydrogenation catalyst (TC1).

### (Production Example 4) Hydrogenated Conjugated Diene-Based Polymer (HSB-1)

To the rubber-like polymer solution before hydrogenation obtained in Production Example 1, the above hydrogenation catalyst (TC1) was added in an amount of 60 ppm based on Ti per 100 parts by mass of the conjugated diene-based polymer before hydrogenation, and a hydrogenation reaction was carried out for 50 minutes under a hydrogen pressure of 0.8 MPa at an average temperature of 85° C. To a solution of the obtained hydrogenated conjugated diene-based polymer solution, 12.6 g of n-octadecyl-3-(3,5-di-t-butyl-4-hydroxyphenyl)-propionate and 3.0 g of 4,6-bis(octylthiomethyl)-o-cresol were added as antioxidants, and the solvent was then removed by steam stripping, followed by drying in a dryer to obtain a hydrogenated conjugated diene-based polymer (HSB-1).

### (Production Example 5) Hydrogenated Conjugated Diene-Based Polymer (HSB-2)

To the conjugated diene-based polymer solution before hydrogenation obtained in Production Example 2, the above hydrogenation catalyst (TC1) was added in an amount of 90 ppm based on Ti per 100 parts by mass of the rubber-like polymer before hydrogenation, and a hydrogenation reaction was carried out for 50 minutes under a hydrogen pressure of 0.8 MPa at an average temperature of 85° C. To a solution of the obtained hydrogenated conjugated diene-based polymer, 12.6 g of n-octadecyl-3-(3,5-di-t-butyl-4-hydroxyphenyl)-propionate and 3.0 g of 4,6-bis(octylthiomethyl)-o-cresol were added as antioxidants, and the solvent was then removed by steam stripping, followed by drying in a dryer to obtain a hydrogenated conjugated diene-based polymer (HSB-2).

### (Production Example 6) Hydrogenated Conjugated Diene-Based Polymer (HSB-3)

To the conjugated diene-based polymer solution before hydrogenation obtained in Production Example 3, the above hydrogenation catalyst (TC1) was added in an amount of 35 ppm based on Ti per 100 parts by mass of the rubber-like polymer before hydrogenation, and a hydrogenation reaction was carried out for 50 minutes under a hydrogen pressure of 0.8 MPa at an average temperature of 85° C. To a solution of the obtained hydrogenated conjugated diene-based polymer, 12.6 g of n-octadecyl-3-(3,5-di-t-butyl-4-hydroxyphenyl)-propionate and 3.0 g of 4,6-bis(octylthiomethyl)-o-cresol were added as antioxidants, and the solvent was then removed by steam stripping, followed by drying in a dryer to obtain a hydrogenated conjugated diene-based polymer (HSB-3).

### (Production Example 7) Hydrogenated Conjugated Diene-Based Polymer (HSB-4)

In the same manner as in Production Example 6, except that the amount of the hydrogenation catalyst (TC1) added was changed to 60 ppm based on Ti per 100 parts by mass of the rubber-like polymer before hydrogenation, a hydrogenated conjugated diene-based polymer (HSB-4) was obtained.

TABLE 1
(Examples A and B) Conjugated diene-based copolymer and hydrogenated conjugated
diene-based polymer

| Production Example No. of | | Production | Production | Production | Production | Production | Production | Production | Production |
|---|---|---|---|---|---|---|---|---|---|
| Example A | | Example 1 | Example 2 | Example 3 | Example 4 | Example 5 | Example 6 | Example 7 | Example 8 |
| Production Example No. of | | — | Production | Production | Production | — | — | — | Production |
| Example B | | | Example 2 | Example 1 | Example 3 | | | | Example 4 |
| Name | | SB-1 | HSB-1 | SB-2 | HSB-2 | SB-3 | HSB-3 | HSB-4 | HSB-5 |
| Weight average | | 35 | 35 | 31 | 31 | 38 | 38 | 38 | 35 |
| molecular weight | | | | | | | | | |
| (×10⁴) | | | | | | | | | |
| Mooney viscosity | [ML(1 + 4)], | 45 | 67 | 47 | 52 | 60 | 67 | 85 | 43 |
| | 100° C. | | | | | | | | |
| Bound styrene content | % by mass | 9.5 | 9.5 | 25.5 | 25.5 | 40.1 | 40.1 | 40.1 | 9.5 |
| 1,2-Vinyl bond | mol % in Bd | 40.2 | 40.2 | 57.4 | 57.4 | 27.5 | 27.5 | 27.5 | 40.2 |
| amount | | | | | | | | | |
| Hydrogenation rate | mol % in Bd | 0 | 76 | 0 | 78 | 0 | 45 | 75 | 25 |
| SP value | MPa^{1/2} | 17.56 | 17.04 | 17.76 | 17.36 | 18.25 | 18.03 | 17.84 | 17.43 |

| | | | | | | | | |
|---|---|---|---|---|---|---|---|---|
| Whether or not 0.297 × St + 29.1 ≤ | unsatisfied | satisfied | unsatisfied | satisfied | unsatisfied | satisfied | satisfied | unsatisfied |
| H ≤ 0.0877 × St + 84.7 is satisfied | | | | | | | | |

### <<Preparation of Cellulose Nanofiber Composition>>

The product names used for each component in Table 2 are as follows.

### <Surfactant-1>

Product name “EMULGEN 102 KG”, manufactured by Kao Corporation (polyoxyethylene (2) monolauryl ether (number in parentheses indicates number of repetitions of oxyethylene chain)

### <Surfactant-2>

Product name “RHEODOL SP-010V”, manufactured by Kao Corporation (sorbitan monooleate)

### <Liquid Rubber-1>

Product name “Ricon 184”, manufactured by Cray Valley Corporation (liquid butadiene-styrene copolymer, Mn=8,600)

### <Cellulose Nanofibers>

### (CNF: Microfilament Cellulose)

After immersing 3 parts by mass of cotton linter pulp in 27 parts by mass of water, the mixture was dispersed with a pulper. Next, 170 parts by mass of water was added to 30 parts by mass of the pulper-processed cotton linter pulp slurry (of which 3 parts by mass was cotton linter pulp), dispersing the latter in the water (1.5% by mass solid content), and a Model SDR14 Lab Refiner (pressurized DISK type) manufactured by Aikawa Iron Works Co. was used as a disc refiner apparatus for beating treatment of the aqueous dispersion for 30 minutes with a disc clearance of 1 mm. This was followed by thorough beating under the conditions with clearance reduced to a level of near zero, to obtain a beaten aqueous dispersion (solid concentration: 1.5% by mass). The obtained beaten aqueous dispersion was directly subjected to micronization treatment 10 times using a high-pressure homogenizer (NSO15H, manufactured by Niro Soavi (Itary) at an operating pressure of 100 MPa, to obtain a microcellulose fiber slurry (solid concentration: 1.5% by mass). The mixture was then concentrated to a solid content of 10% by mass using a dehydrator, to obtain a concentrated CNF cake.

### <Preparation Procedure of Composition>

### (Production Example 1) CNF Composition (CNF-1)

Purified water was added to CNF (aqueous dispersion of cellulose fibers) to prepare an aqueous dispersion with a final cellulose nanofibers content of 5% by mass. To this there were added a liquid rubber-1 and a surfactant-1, to prepare an aqueous dispersion with a final composition of 90% by mass water, 5% by mass cellulose fibers, 2.86% by mass liquid rubber and 2.14% by mass surfactant. The aqueous dispersion was mixed for 5 minutes using an ARE-310 rotating/revolving mixer by Thinky Corp., to obtain a dispersion of a cellulose nanofiber composition. The resulting dispersion was dried at 80° C. using an SPH-201 by Espec Corp. to obtain a dried body. The obtained dried body was pulverized for 30 seconds using an MS-05 Mini Speed Mill by Labonect Co., to obtain a CNF composition powder (CNF-1).

The compacted bulk density of the obtained dry powder was measured using a powder tester PT-X manufactured by Hosokawa Micron Corporation. Specifically, a sufficient volume of resin adapter (50.46 mm inner diameter×40 mm length) was connected in a closely fitting manner with the top of a 100 mL closed-bottom cylindrical container made of stainless steel (50.46 mm inner diameter×50 mm depth), and the powder was introduced using a dispensing spoon at 10 g/min to overflowing, after which the adapter-connected closed-bottom cylindrical container was subjected to 50 Hz vibration at an amplitude of 1.5 mm for 30 seconds with a motor having an eccentric weight on the rotating shaft. The adapter was then removed, the top powder was scraped off, and the weight was measured to a precision of 0.01 g. The number-average value of three weight measurements was divided by the internal volume of the closed-bottom cylindrical container to calculate the compacted bulk density.

### (Production Example 2) CNF Composition (CNF-2)

In the same manner as in Production Example 1, except that a liquid rubber-1 and a surfactant-1 were added to prepare an aqueous dispersion having a final composition of 91.15% by mass water, 5% by mass cellulose fibers, 2.86% by mass liquid rubber and 0.99% by mass surfactant, a CNF composition powder (CNF-2) was obtained.

### (Production Example 3) CNF Composition (CNF-3)

In the same manner as in Production Example 1, except that a surfactant-1 was added to prepare an aqueous dispersion with a final composition of 92.86% by mass water, 5% by mass cellulose fibers and 2.14% by mass surfactant, a CNF composition powder (CNF-3) was obtained.

### (Production Example 4) CNF Composition (CNF-4)

In the same manner as in Production Example 1, except that a surfactant-2 was added to prepare an aqueous dispersion with a final composition of 92.86% by mass water, 5% by mass cellulose fibers and 2.14% by mass surfactant, a CNF composition powder (CNF-4) was obtained.

TABLE 2
(Example A) Cellulose nanofiber composition

| | | Production | Production | Production | Production |
|---|---|---|---|---|---|
| | | Example 1 | Example 2 | Example 3 | Example 4 |
| | | CNF-1 | CNF-2 | CNF-3 | CNF-4 |
| Cellulose | parts by | 100 | 100 | 100 | 100 |
| nanofibers | mass | | | | |
| | % by | 50 | 56.5 | 70 | 70 |
| | mass | | | | |
| Surfactant-1 | parts by | 42.8 | 19.8 | 42.8 | 0 |
| | mass | | | | |
| | % by | 21.4 | 11.2 | 30 | 0 |
| | mass | | | | |
| Surfactant-2 | parts by | 0 | 0 | 0 | 42.9 |
| | mass | | | | |
| | % by | 0 | 0 | 0 | 30 |
| | mass | | | | |
| Liquid rubber-1 | parts by | 57.2 | 57.2 | 0 | 0 |
| | mass | | | | |
| | % by | 28.6 | 32.3 | 0 | 0 |
| | mass | | | | |
| Compacted | g/cm³ | 0.213 | 0.181 | 0.145 | 0.213 |
| bulk density | | | | | |

### <<Production of Masterbatch>>

The product names used for the liquid rubbers in Table 3 are as follows.

### <Liquid Rubber>

LR-1: Ricon 131MA20, manufactured by Cray Valley Corporation (maleic anhydride modified liquid polybutadiene, Mn=5,600, number of maleic anhydride molecules per molecular chain is 11)
LR-2: Ricon 184MA6, manufactured by Cray Valley Corporation (maleic anhydride modified liquid styrene butadiene copolymer, Mn=9,100, number of maleic anhydride molecules per molecular chain is 6)
LR-3: LIR-403, manufactured by KURARAY CO., LTD (maleic anhydride modified liquid polyisoprene, Mn=34,000, number of maleic anhydride molecules per molecular chain is 3) <Silica> Trade name “ULTRASIL 7000GR”, manufactured by Evonik Degussa (nitrogen adsorption specific surface area: 170 m²/g)

### (Production Example 1) Masterbatch for Rubber Modification (MB-1)

Using an internal mixer (capacity: 0.35 L) equipped with a temperature control device, 100 parts by mass of a hydrogenated conjugated diene-based polymer (HSB-1) and 50 parts by mass of a CNF composition (CNF-1) were kneaded in the first stage under the conditions of a filling rate of 65% and a rotor rotation speed of 30 to 70 rpm. At this time, the temperature of the internal mixer was controlled to obtain a rubber composition (compound) at the discharge temperature was 155 to 160° C.

Next, in the second stage of kneading, the above obtained compound was cooled to room temperature and then kneaded again to improve the dispersion of CNF. Also in this case, the temperature of the internal mixer was controlled to adjust the discharge temperature to 155 to 160° C., thus obtaining a masterbatch for rubber modification (MB-1).

### (Production Examples 2 to 7) Masterbatches for Rubber Modification (MB-2 to MB-7)

In the same manner as in Production Example 1, except that the starting materials (hydrogenated conjugated diene-based polymer and CNF composition) and the mixing amounts used in the production of the masterbatch for rubber modification were changed as shown in Table 3, masterbatches for rubber modification (MB-2 to MB-7) were obtained.

### (Production Example 8) Masterbatch for Rubber Modification (MB-8)

Using an internal mixer (capacity: 0.35 L) equipped with a temperature control device, 100 parts by mass of a hydrogenated conjugated diene-based polymer (HSB-1) and 50 parts by mass of a CNF composition (CNF-1) were kneaded in the first stage under the conditions of a filling rate of 65% and a rotor rotation speed of 30 to 70 rpm, and then 10 parts by mass of a modified liquid isoprene (LR-3) was added, followed by kneading. The temperature of the internal mixer was controlled to obtain a rubber composition (compound) at the discharge temperature of 155 to 160° C.

Next, in the second stage of kneading, the above obtained compound was cooled to room temperature and then kneaded again to improve the dispersion of CNF. Also in this case, the temperature of the internal mixer was controlled to adjust the discharge temperature to 155 to 160° C., thus obtaining a masterbatch for rubber modification (MB-8).

### (Production Examples 9 to 11) Masterbatches for Rubber Modification (MB-9 to MB-11)

In the same manner as in Production Example 8, except that the starting materials (hydrogenated conjugated diene-based polymer and CNF composition, liquid rubber) and the mixing amounts used in the production of the masterbatch for rubber modification were changed as shown in Table 3, masterbatches for rubber modification (MB-9 to MB-11) were obtained.

### (Production Example 12) Masterbatch for Rubber Modification (MB-12)

Using an internal mixer (capacity: 0.35 L) equipped with a temperature control device, 100 parts by mass of a conjugated diene-based polymer (SB-1) and 50 parts by mass of a CNF composition (CNF-1) were kneaded in the first stage under the conditions of a filling rate of 65% and a rotor rotation speed of 30 to 70 rpm. At this time, the temperature of the internal mixer was controlled to obtain a rubber composition (compound) at the discharge temperature of 155 to 160° C.

Next, in the second stage of kneading, the above obtained compound was cooled to room temperature and then kneaded again to improve the dispersion of CNF. Also in this case, the temperature of the internal mixer was controlled to adjust the discharge temperature to 155 to 160° C., thus obtaining a masterbatch for rubber modification (MB-12).

### (Production Example 13, 14) Masterbatches for Rubber Modification (MB-13 and MB-14)

In the same manner as in Production Example 12, except that the starting materials (conjugated diene-based polymer and CNF composition) and the mixing amounts used in the production of the masterbatch for rubber modification were changed as shown in Table 3, masterbatches for rubber modification (MB-13 and MB-14) were obtained.

TABLE 3
(Example A) Masterbatch for rubber modification

| | | | Pro- | Pro- | Pro- | Pro- | Pro- | Pro- | Pro- |
|---|---|---|---|---|---|---|---|---|---|
| | | | duc- | duc- | duc- | duc- | duc- | duc- | duc- |
| | | | tion | tion | tion | tion | tion | tion | tion |
| | | | Exam- | Exam- | Exam- | Exam- | Exam- | Exam- | Exam- |
| | | | ple 1 | ple 2 | ple 3 | ple 4 | ple 5 | ple 6 | ple 7 |
| | | | MB-1 | MB-2 | MB-3 | MB-4 | MB-5 | MB-6 | MB-7 |
| Hydrogenated | HSB-1 | parts by mass | 100 | 0 | 0 | 0 | 0 | 0 | 0 |
| conjugated | HSB-2 | parts by mass | 0 | 100 | 0 | 0 | 100 | 100 | 100 |
| diene- | HSB-3 | parts by mass | 0 | 0 | 100 | 0 | 0 | 0 | 0 |
| based polymer | HSB-4 | parts by mass | 0 | 0 | 0 | 100 | 0 | 0 | 0 |
| Conjugated | SB-1 | parts by mass | 0 | 0 | 0 | 0 | 0 | 0 | 0 |
| diene- | SB-2 | parts by mass | 0 | 0 | 0 | 0 | 0 | 0 | 0 |
| based polymer | SB-3 | parts by mass | 0 | 0 | 0 | 0 | 0 | 0 | 0 |
| Modified liquid | LR-1 | parts by mass | 0 | 0 | 0 | 0 | 0 | 0 | 0 |
| rubber | LR-2 | parts by mass | 0 | 0 | 0 | 0 | 0 | 0 | 0 |
| | LR-3 | parts by mass | 0 | 0 | 0 | 0 | 0 | 0 | 0 |
| CNF | CNF-1 | parts by mass | 50 | 50 | 50 | 50 | 0 | 0 | 0 |
| composition | CNF-2 | parts by mass | 0 | 0 | 0 | 0 | 42.8 | 0 | 0 |
| | CNF-3 | parts by mass | 0 | 0 | 0 | 0 | 0 | 35.7 | 0 |
| | CNF-4 | parts by mass | 0 | 0 | 0 | 0 | 0 | 0 | 35.7 |

(Example A) Masterbatch for rubber modification

| | | | | | Pro- | Pro- | Pro- | Pro- | Pro- |
|---|---|---|---|---|---|---|---|---|---|
| | | | Pro- | Pro- | duc- | duc- | duc- | duc- | duc- |
| | | | duc- | duc- | tion | tion | tion | tion | tion |
| | | | tion | tion | Exam- | Exam- | Exam- | Exam- | Exam- |
| | | | Exam- | Exam- | ple | ple | ple | ple | ple |
| | | | ple 8 | ple 9 | 10 | 11 | 12 | 13 | 14 |
| | | | MB-8 | MB-9 | MB-10 | MB-11 | MB-12 | MB-13 | MB-14 |
| Hydrogenated | HSB-1 | parts by mass | 100 | 100 | 0 | 0 | 0 | 0 | 0 |
| conjugated | HSB-2 | parts by mass | 0 | 0 | 0 | 100 | 0 | 0 | 0 |
| diene- | HSB-3 | parts by mass | 0 | 0 | 0 | 0 | 0 | 0 | 0 |
| based polymer | HSB-4 | parts by mass | 0 | 0 | 100 | 0 | 0 | 0 | 0 |
| Conjugated | SB-1 | parts by mass | 0 | 0 | 0 | 0 | 100 | 0 | 0 |
| diene- | SB-2 | parts by mass | 0 | 0 | 0 | 0 | 0 | 100 | 0 |
| based polymer | SB-3 | parts by mass | 0 | 0 | 0 | 0 | 0 | 0 | 100 |
| Modified liquid | LR-1 | parts by mass | 0 | 0 | 0 | 50 | 0 | 0 | 0 |
| rubber | LR-2 | parts by mass | 0 | 0 | 50 | 0 | 0 | 0 | 0 |
| | LR-3 | parts by mass | 50 | 50 | 0 | 0 | 0 | 0 | 0 |
| CNF | CNF-1 | parts by mass | 50 | 0 | 50 | 50 | 50 | 50 | 50 |
| composition | CNF-2 | parts by mass | 0 | 0 | 0 | 0 | 0 | 0 | 0 |
| | CNF-3 | parts by mass | 0 | 35.7 | 0 | 0 | 0 | 0 | 0 |
| | CNF-4 | parts by mass | 0 | 0 | 0 | 0 | 0 | 0 | 0 |

### <<Preparation Hydrogenated Conjugated Diene-Based Polymer Composition>>

The product names used for the liquid rubbers in Tables 4 to 7 are as follows.

### <Liquid Rubber>

LR-1: Trade name “Ricon 131MA20”, manufactured by Cray Valley Corporation (maleic anhydride modified liquid polybutadiene, Mn=5,600, number of maleic anhydride molecules per molecular chain is 11)
LR-2: Trade name “Ricon 184MA6”, manufactured by Cray Valley Corporation (maleic anhydride modified liquid styrene butadiene copolymer, Mn=9,100, number of maleic anhydride molecules per molecular chain is 6)
LR-3: Trade name “LIR-403”, manufactured by KURARAY CO., LTD (maleic anhydride modified liquid polyisoprene, Mn=34,000, number of maleic anhydride molecules per molecular chain is 3)

### <Silica>

Trade name “Ultrasil 7000GR”, manufactured by Evonik Degussa (nitrogen adsorption specific surface area: 170 m²/g)

### <Carbon Black>

Trade name “Seest KH (N339)”, manufacture by Tokai Carbon Co., Ltd.

### <S-RAE Oil>

Trade name “Process NC140”, manufactured by JX Nippon Oil&Gas Exploration Corporation

### <Silane Coupling Agent>

Trade name “Si75” (bis(triethoxysilylpropyl) disulfide), manufactured by Evonik Degussa

### <Zinc Oxide>

Trade name “Zinc Oxide”, manufactured by Sakai Chemical Industry Co., Ltd.

### <Stearic Acid>

Trade name “LUNAC S-90V”, manufactured by Kao Corporation

### <Antioxidant>

Trade name “NOCRAC 6C” (N-(1,3-dimethylbutyl)-N′-phenyl-p-phenylenediamine), manufactured by OUCHI SHINKO CHEMICAL INDUSTRIAL CO., LTD.

### <Wax>

Trade name “Sunnock”, manufactured by OUCHI SHINKO CHEMICAL INDUSTRIAL CO., LTD.

### <Sulfur>

Trade name “SULFAX 200S” (powdered sulfur), manufactured by Tsurumi Chemical Industry Co., Ltd.

### <Vulcanization Accelerator −1>

Trade name “Nocceler CZ” (N-cyclohexyl-2-benzothiazolylsulfenamide), manufactured by OUCHI SHINKO CHEMICAL INDUSTRIAL CO., LTD.

### <Vulcanization Accelerator −2>

Trade name “Nocceler D” (1,3-diphenylguanidine), manufactured by OUCHI SHINKO CHEMICAL INDUSTRIAL CO., LTD.

The properties of the conjugated diene-based polymer composition before vulcanization (rubber composition) and the conjugated diene-based polymer composition after vulcanization (cured product) were evaluated by the following methods.

### (Dispersibility of Cellulose Nanofibers)

The cured product of the conjugated diene-based polymer composition was placed in a mold for vulcanization press, and the dispersion state of the cellulose nanofibers was visually observed in a 5 cm square area on the surface and evaluated according to the following criteria.
A: No agglomerates are visually observed.
B: A small number of agglomerates (1 to 10 particles) are observed.
C: Many agglutinations (11 or more) are observed.

### (Workability: Compound Mooney Viscosity)

The above compound obtained after kneading in the second stage and before kneading in the third stage mentioned below was used as a sample, and the viscosity was measured using a Mooney viscometer in accordance with JIS K6300-1 after preheating at 130° C. for 1 minute and then rotating with a rotor at 2 revolutions per minute for 4 minutes.

Each result was shown as an index obtained assuming that the result of Comparative Example 7 was 100. A larger index indicates more satisfactory workability.

### (Tensile Strength, Tensile Modulus and Tensile Elongation)

The tensile strength, tensile modulus (100% modulus and 200% modulus) and tensile elongation were measured in accordance with a tensile test method of JIS K6251. Each result was shown as an index obtained assuming that the result of Comparative Example 7 was 100. A larger index indicates more satisfactory tensile strength, tensile modulus and tensile elongation.

### (Hardness)

The hardness of the vulcanized rubber was measured by a type A durometer in accordance with JIS K6253 “Hardness Test Method for Vulcanized and Thermoplastic Rubbers”. The measurement was carried out at 25° C. Each result was shown as an index obtained assuming that the result of Comparative Example 7 was 100. A larger index indicates more satisfactory hardness.

### (Storage Elastic Modulus)

The storage elastic modulus was evaluated at 25° C., a frequency of 10 Hz and strain of 1% by a torsion method using a viscoelasticity tester ARES-G2, manufactured by TA Instruments. Each result was shown as an index obtained assuming that the result of Comparative Example 7 was 100. A larger index indicates higher storage elastic modulus.

### (Ozone Resistance)

Using each of the resulting cured products, the ozone resistance was determined by the following test method.

Each vulcanized rubber composition was subjected to vulcanization pressing using a prescribed mold (15 cm long×15 cm wide×2.0 mm thick) under the conditions of 160° C. for 15 to 30 minutes to obtain a vulcanized rubber sheet, and a strip sample (6 cm long×1 cm wide×2.0 mm thick) was punched out from the vulcanized rubber sheet and, after placing in an ozone tank (50° C., 100 pphm), the strip sample was left to stand for 48 hours in the state of 20% elongation. Thereafter, the strip sample (vulcanized rubber sheet) was observed, and the number of cracks having a length of 1 mm or more on the surface was counted and evaluated according to the following criteria.

### [Determination Criteria]

Poor: The vulcanized rubber sheet was broken.
Fair: The number of cracks having a length of 1 mm or more was 21 or more.
Good: The number of cracks having a length of 1 mm or more was 10 or more and 20 or less.
Excellent: The number of cracks having a length of 1 mm or more was 1 or more and less than 10.

### Examples 1 to 14, and Comparative Examples 1 to 3

The masterbatches, hydrogenated conjugated diene-based polymers and conjugated diene-based polymers shown in Tables 4 and 5 were used as starting rubber components, and then kneaded according to the formulation shown in Table 4 by the following method to obtain conjugated diene-based polymer compositions.

In the first stage of kneading, using an internal mixer (capacity: 0.35 L) equipped with a temperature control device, a masterbatch, starting rubbers (hydrogenated conjugated diene-based polymer, conjugated diene-based polymer), fillers (silica, carbon black), a silane coupling agent, process oil, wax, zinc oxide and stearic acid were kneaded under the conditions of a filling rate of 65% and a rotor rotation speed of 30 to 70 rpm. At this time, the temperature of the internal mixer was controlled to obtain each conjugated diene-based polymer composition (compound) at the discharge temperature of 155 to 160° C.

Next, in the second stage of kneading, the compound obtained above was cooled to room temperature, and then an antioxidant was added, followed by kneading again to improve the dispersion of CNF or fillers (silica, carbon black). Also in this case, the temperature of the internal mixer was controlled to adjust the discharge temperature to 155 to 160° C. After cooling, in the third stage of kneading, sulfur, a vulcanization accelerator −1 and a vulcanization accelerator −2 were added, followed by kneading in an open roll set at 70° C. Thereafter, the mixture was molded and vulcanized in a vulcanization press at 160° C. for 15 minutes. The properties of the conjugated diene-based polymer composition before vulcanization and the conjugated diene-based polymer composition after vulcanization were evaluated. The results are shown in Tables 4 and 5.

### Comparative Example 4

Using the hydrogenated conjugated diene-based polymers shown in Tables 4 and 5 as starting rubber components, conjugated diene-based polymer compositions were obtained by kneading according to the formulations shown in Tables 4 and 5 using the following method.

In the first stage of kneading, a hydrogenated conjugated diene-based polymer (HSB-2), silica, a silane coupling agent, process oil, wax, zinc oxide and stearic acid were kneaded using an internal mixer (capacity: 0.35 L) equipped with a temperature control device under the conditions of a filling rate of 65% and a rotor rotation speed of 30 to 70 rpm. At this time, the temperature of the internal mixer was controlled to obtain each conjugated diene-based polymer composition (compound) at the discharge temperature of 155 to 160° C.

Next, in the second stage of kneading, the compound obtained above was cooled to room temperature, and then an antioxidant was added, followed by kneading again to improve the dispersion of silica. Also in this case, the temperature of the internal mixer was controlled to adjust the discharge temperature to 155 to 160° C. After cooling, in the third stage of kneading, sulfur, a vulcanization accelerator −1 and a vulcanization accelerator −2 were added, followed by kneading in an open roll set at 70° C. Thereafter, the mixture was molded and vulcanized in a vulcanization press at 160° C. for 15 minutes. The properties of the conjugated diene-based polymer composition before vulcanization and the conjugated diene-based polymer composition after vulcanization were evaluated. The results are shown in Tables 4 and 5.

TABLE 4
(Example A) Rubber composition and cured product (using masterbatch)

| | | | | Exam- | Exam- | Exam- | Exam- | Exam- | Exam- | Exam- | Exam- | Exam- |
|---|---|---|---|---|---|---|---|---|---|---|---|---|
| | | | | ple | ple | ple | ple | ple | ple | ple | ple | ple |
| | | | | 1 | 2 | 3 | 4 | 5 | 6 | 7 | 8 | 9 |
| Formulation | Masterbatch | | Type | MB-1 | MB-2 | MB-3 | MB-4 | MB-5 | MB-6 | MB-7 | MB-2 | MB-2 |
| | | | parts by | 30 | 30 | 30 | 30 | 28.6 | 27.14 | 27.14 | 30 | 30 |
| | | | mass | | | | | | | | | |
| | Hydrogenated | HSB-1 | parts by | 80 | 0 | 0 | 0 | 0 | 0 | 0 | 0 | 0 |
| | conjugated | | mass | | | | | | | | | |
| | diene-based | HSB-2 | parts by | 0 | 80 | 0 | 0 | 80 | 80 | 80 | 80 | 80 |
| | polymer | | mass | | | | | | | | | |
| | | HSB-3 | parts by | 0 | 0 | 80 | 0 | 0 | 0 | 0 | 0 | 0 |
| | | | mass | | | | | | | | | |
| | | HSB-4 | parts by | 0 | 0 | 0 | 80 | 0 | 0 | 0 | 0 | 0 |
| | | | mass | | | | | | | | | |
| | Conjugated | SB-1 | parts by | 0 | 0 | 0 | 0 | 0 | 0 | 0 | 0 | 0 |
| | diene-based | | mass | | | | | | | | | |
| | polymer | SB-2 | parts by | 0 | 0 | 0 | 0 | 0 | 0 | 0 | 0 | 0 |
| | | | mass | | | | | | | | | |
| | | SB-3 | parts by | 0 | 0 | 0 | 0 | 0 | 0 | 0 | 0 | 0 |
| | | | mass | | | | | | | | | |
| | Reinforcing | Silica | parts by | 0 | 0 | 0 | 0 | 0 | 0 | 0 | 20 | 0 |
| | filler | | mass | | | | | | | | | |
| | | Carbon | parts by | 0 | 0 | 0 | 0 | 0 | 0 | 0 | 0 | 20 |
| | | black | mass | | | | | | | | | |

| | S-RAE oil | parts by | 10 | 10 | 10 | 10 | 10 | 10 | 10 | 10 | 10 |
|---|---|---|---|---|---|---|---|---|---|---|---|
| | | mass | | | | | | | | | |
| | Silane coupling agent | parts by | 0 | 0 | 0 | 0 | 0 | 0 | 0 | 1.6 | 0 |
| | | mass | | | | | | | | | |
| | Zinc oxide | parts by | 2.5 | 2.5 | 2.5 | 2.5 | 2.5 | 2.5 | 2.5 | 2.5 | 2.5 |
| | | mass | | | | | | | | | |
| | Stearic acid | parts by | 2.0 | 2.0 | 2.0 | 2.0 | 2.0 | 2.0 | 2.0 | 2.0 | 2.0 |
| | | mass | | | | | | | | | |
| | Wax | parts by | 1.5 | 1.5 | 1.5 | 1.5 | 1.5 | 1.5 | 1.5 | 1.5 | 1.5 |
| | | mass | | | | | | | | | |
| | Antioxidant | parts by | 2.0 | 2.0 | 2.0 | 2.0 | 2.0 | 2.0 | 2.0 | 2.0 | 2.0 |
| | | mass | | | | | | | | | |
| | Sulfur | parts by | 1.7 | 1.7 | 1.7 | 1.7 | 1.7 | 1.7 | 1.7 | 1.7 | 1.7 |
| | | mass | | | | | | | | | |
| | Vulcanization | parts by | 1.7 | 1.7 | 1.7 | 1.7 | 1.7 | 1.7 | 1.7 | 1.7 | 1.7 |
| | accelerator-1 | mass | | | | | | | | | |
| | Vulcanization | parts by | 2.0 | 2.0 | 2.0 | 2.0 | 2.0 | 2.0 | 2.0 | 2.0 | 2.0 |
| | accelerator-2 | mass | | | | | | | | | |
| Dispersibility (visual inspection) | | | A | A | A | A | A | A | A | A | A |
| physical | Workability | index | 48 | 46 | 55 | 80 | 48 | 46 | 48 | 59 | 61 |
| properties | Hardness | index | 104 | 108 | 111 | 119 | 104 | 100 | 100 | 113 | 115 |
| | Storage elastic modulus | index | 147 | 157 | 194 | 228 | 152 | 142 | 145 | 240 | 244 |
| | at 25° C. | | | | | | | | | | |
| | 100% Modulus | index | 200 | 265 | 294 | 324 | 247 | 241 | 247 | 341 | 329 |
| | 200% Modulus | index | 114 | 142 | 153 | 172 | 139 | 136 | 139 | 200 | 217 |
| | Tensile strength | index | 51 | 53 | 65 | 80 | 51 | 54 | 55 | 99 | 101 |
| | Tensile elongation | index | 94 | 97 | 117 | 151 | 91 | 94 | 97 | 111 | 114 |
| | Ozone resistance | | Good | Good | Fair | Excel- | Good | Good | Good | Good | Good |
| | | | | | | lent | | | | | |

TABLE 5
(Example A) Rubber composition and cured product (using masterbatch)

| | | | | | | | | | Com- | Com- | Com- |
|---|---|---|---|---|---|---|---|---|---|---|---|
| | | | | Example | Example | Example | Example | Example | parative | parative | parative |
| | | | | 10 | 11 | 12 | 13 | 14 | Example 1 | Example 2 | Example 3 |
| For- | Masterbatch | Type | | MB-8 | MB-9 | MB-10 | MB-11 | MB-11 | MB-12 | MB-13 | MB-14 |
| mulation | | | parts by | 40 | 37.14 | 40 | 40 | 40 | 30 | 30 | 30 |
| | | | mass | | | | | | | | |
| | Hydrogenated | HSB-1 | parts by | 80 | 80 | 0 | 0 | 0 | 0 | 0 | 0 |
| | conjugated | | mass | | | | | | | | |
| | diene-based | HSB-2 | parts by | 0 | 0 | 0 | 80 | 80 | 0 | 0 | 0 |
| | polymer | | mass | | | | | | | | |
| | | HSB-3 | parts by | 0 | 0 | 0 | 0 | 0 | 0 | 0 | 0 |
| | | | mass | | | | | | | | |
| | | HSB-4 | parts by | 0 | 0 | 80 | 0 | 0 | 0 | 0 | 0 |
| | | | mass | | | | | | | | |
| | Conjugated | Sb-1 | parts by | 0 | 0 | 0 | 0 | 0 | 80 | 0 | 0 |
| | diene-based | | mass | | | | | | | | |
| | polymer | SB-2 | parts by | 0 | 0 | 0 | 0 | 0 | 0 | 80 | 0 |
| | | | mass | | | | | | | | |
| | | SB-3 | parts by | 0 | 0 | 0 | 0 | 0 | 0 | 0 | 80 |
| | | | mass | | | | | | | | |
| | Reinforcing | Silica | parts by | 0 | 0 | 0 | 0 | 20 | 0 | 0 | 0 |
| | filler | | mass | | | | | | | | |
| | | Carbon | parts by | 0 | 0 | 0 | 0 | 0 | 0 | 0 | 0 |
| | | black | mass | | | | | | | | |

| | S-RAE oil | parts by | 0 | 0 | 0 | 0 | 0 | 10 | 10 | 10 |
|---|---|---|---|---|---|---|---|---|---|---|
| | | mass | | | | | | | | |
| | silane coupling agent | parts by | 0 | 0 | 0 | 0 | 1.6 | 0 | 0 | 0 |
| | | mass | | | | | | | | |
| | Zinc oxide | parts by | 2.5 | 2.5 | 2.5 | 2.5 | 2.5 | 2.5 | 2.5 | 2.5 |
| | | mass | | | | | | | | |
| | Stearic acid | parts by | 2.0 | 2.0 | 2.0 | 2.0 | 2.0 | 2.0 | 2.0 | 2.0 |
| | | mass | | | | | | | | |
| | Antioxidant | parts by | 2.0 | 2.0 | 2.0 | 2.0 | 2.0 | 2.0 | 2.0 | 2.0 |
| | | mass | | | | | | | | |
| | Sulfur | parts by | 1.7 | 1.7 | 1.7 | 1.7 | 1.7 | 1.7 | 1.7 | 1.7 |
| | | mass | | | | | | | | |
| | Vulcanization | parts by | 1.7 | 1.7 | 1.7 | 1.7 | 1.7 | 1.7 | 1.7 | 1.7 |
| | accelerator-1 | mass | | | | | | | | |
| | Vulcanization | parts by | 2.0 | 2.0 | 2.0 | 2.0 | 2.0 | 2.0 | 2.0 | 2.0 |
| | accelerator-2 | mass | | | | | | | | |
| Dispersibility (visual | | | A | A | A | A | A | B | B | B |
| inspection) | | | | | | | | | | |
| physical | Workability | index | 51 | 52 | 83 | 51 | 62 | 45 | 43 | 52 |
| properties | Hardness | index | 123 | 117 | 132 | 113 | 102 | 96 | 104 | 108 |
| | Storage elastic modulus | index | 207 | 200 | 317 | 196 | 233 | 132 | 147 | 184 |
| | at 25° C. | | | | | | | | | |
| | 100% Modulus | index | 212 | 206 | 435 | 271 | 312 | 177 | 247 | 276 |
| | 200% Modulus | index | 142 | 136 | 228 | 144 | 169 | 103 | 136 | 144 |
| | Tensile strength | index | 90 | 81 | 109 | 72 | 93 | 47 | 51 | 63 |
| | Tensile elongation | index | 94 | 91 | 120 | 91 | 103 | 89 | 86 | 106 |
| | Ozone resistance | | Good | Good | Excellent | Good | Good | Poor | Poor | Poor |

### Examples 15 to 21

Using the hydrogenated conjugated diene-based polymers shown in Tables 6 and 7 as the starting rubber components, conjugated diene-based polymer compositions were obtained by kneading according to the formulations shown in Tables 6 and 7 by the following method.

In the first stage of kneading, using an internal mixer (capacity: 0.35 L) equipped with a temperature control device, a hydrogenated conjugated diene-based polymer (HSB-1), a cellulose nanofiber composition, process oil, wax, zinc oxide and stearic acid were kneaded under the conditions of a filling rate of 65% and a rotor rotation speed of 30 to 70 rpm. At this time, the temperature of the internal mixer was controlled to obtain a hydrogenated conjugated diene-based polymer composition (compound) at the discharge temperature of 155 to 160° C.

Next, in the second stage of kneading, the compound obtained above was cooled to room temperature, and then an antioxidant was added, followed by kneading again to improve the dispersion of cellulose nanofibers. Also in this case, the temperature of the internal mixer was controlled to adjust the discharge temperature to 155 to 160° C. After cooling, in the third stage of kneading, sulfur, a vulcanization accelerator −1 and a vulcanization accelerator −2 were added, followed by kneading in an open roll set at 70° C. Thereafter, the mixture was molded and vulcanized in a vulcanization press at 160° C. for 15 minutes. The properties of the conjugated diene-based polymer composition before vulcanization and the conjugated diene-based polymer composition after vulcanization were evaluated. The results are shown in Tables 6 and 7.

### Examples 22 to 23

Using the hydrogenated conjugated diene-based polymers shown in Tables 6 and 7 as starting rubber components, conjugated diene-based polymer compositions were obtained by kneading according to the formulations shown in Tables 6 and 7 using the following method.

In the first stage of kneading, using an internal mixer (capacity: 0.35 L) equipped with a temperature control device, a starting material rubber (hydrogenated conjugated diene-based polymer), a cellulose nanofiber composition, reinforcing fillers (silica, carbon black), process oil, wax, zinc oxide and stearic acid were kneaded under the conditions of a filling rate of 65% and a rotor rotation speed of 30 to 70 rpm. At this time, the temperature of the internal mixer was controlled to obtain each conjugated diene-based polymer composition (compound) at the discharge temperature of 155 to 160° C.

Next, in the second stage of kneading, the compound obtained above was cooled to room temperature, and then an antioxidant was added, followed by kneading again to improve the dispersion of reinforcing fillers (silica, carbon black). Also in this case, the temperature of the internal mixer was controlled to adjust the discharge temperature to 155 to 160° C. After cooling, in the third stage of kneading, sulfur, a vulcanization accelerator −1 and a vulcanization accelerator −2 were added, followed by kneading in an open roll set at 70° C. Thereafter, the mixture was molded and vulcanized in a vulcanization press at 160° C. for 15 minutes. The properties of the conjugated diene-based polymer composition before vulcanization and the conjugated diene-based polymer composition after vulcanization were evaluated. The results are shown in Tables 6 and 7.

### Examples 24 to 28

Using the hydrogenated conjugated diene-based polymers shown in Tables 6 and 7 as starting rubber components, conjugated diene-based polymer compositions were obtained by kneading according to the formulations shown in Tables 6 and 7 using the following method.

In the first stage of kneading, using an internal mixer (capacity: 0.35 L) equipped with a temperature control device, a starting rubber (hydrogenated conjugated diene-based polymer), a cellulose nanofiber composition, a modified liquid rubber, process oil, wax, zinc oxide and stearic acid were kneaded under the conditions of a filling rate of 65% and a rotor rotation speed of 30 to 70 rpm. At this time, the temperature of the internal mixer was controlled to obtain each conjugated diene-based polymer composition (compound) at the discharge temperature of 155 to 160° C.

Next, in the second stage of kneading, the compound obtained above was cooled to room temperature, and then an antioxidant was added, followed by kneading again to improve the dispersion of CNF or reinforcing fillers (silica, carbon black). Also in this case, the temperature of the internal mixer was controlled to adjust the discharge temperature to 155 to 160° C. After cooling, in the third stage of kneading, sulfur, a vulcanization accelerator −1 and a vulcanization accelerator −2 were added, followed by kneading in an open roll set at 70° C. Thereafter, the mixture was molded and vulcanized in a vulcanization press at 160° C. for 15 minutes. The properties of the conjugated diene-based polymer composition before vulcanization and the conjugated diene-based polymer composition after vulcanization were evaluated. The results are shown in Tables 6 and 7.

### Comparative Examples 5 to 7

Using the hydrogenated conjugated diene-based polymers shown in Tables 6 and 7 as starting rubber components, conjugated diene-based polymer compositions were obtained by kneading according to the formulations shown in Tables 6 and 7 using the following method.

In the first stage of kneading, using an internal mixer (capacity: 0.35 L) equipped with a temperature control device, a starting rubber (hydrogenated conjugated diene-based polymer), a conjugated diene-based polymer, a cellulose nanofiber composition, process oil, wax, zinc oxide and stearic acid were kneaded under the conditions of a filling rate of 65% and a rotor rotation speed of 30 to 70 rpm. At this time, the temperature of the internal mixer was controlled to obtain each conjugated diene-based polymer composition (compound) at the discharge temperature of 155 to 160° C.

Next, in the second stage of kneading, the compound obtained above was cooled to room temperature, and then an antioxidant was added, followed by kneading again to improve the dispersion of cellulose nanofibers. Also in this case, the temperature of the internal mixer was controlled to adjust the discharge temperature to 155 to 160° C. After cooling, in the third stage of kneading, sulfur, a vulcanization accelerator −1 and a vulcanization accelerator −2 were added, followed by kneading in an open roll set at 70° C. Thereafter, the mixture was molded and vulcanized in a vulcanization press at 160° C. for 15 minutes. The properties of the conjugated diene-based polymer composition before vulcanization and the conjugated diene-based polymer composition after vulcanization were evaluated. The results are shown in Tables 6 and 7.

TABLE 6
(Example A) Rubber composition and cured product (without using masterbatch)

| | | | | Example | Example | Example | Example | Example | Example | Example | Example | Example |
|---|---|---|---|---|---|---|---|---|---|---|---|---|
| | | | | 15 | 16 | 17 | 18 | 19 | 20 | 21 | 22 | 23 |
| For- | Hydrogenated | HSB-1 | parts by | 100 | 0 | 0 | 0 | 0 | 0 | 0 | 0 | 0 |
| mulation | conjugated | | mass | | | | | | | | | |
| | diene-based | HSB-2 | parts by | 0 | 100 | 0 | 0 | 100 | 100 | 100 | 100 | 100 |
| | polymer | | mass | | | | | | | | | |
| | | HSB-3 | parts by | 0 | 0 | 100 | 0 | 0 | 0 | 0 | 0 | 0 |
| | | | mass | | | | | | | | | |
| | | HSB-4 | parts by | 0 | 0 | 0 | 100 | 0 | 0 | 0 | 0 | 0 |
| | | | mass | | | | | | | | | |
| | Conjugated | SB-1 | parts by | 0 | 0 | 0 | 0 | 0 | 0 | 0 | 0 | 0 |
| | diene-based | | mass | | | | | | | | | |
| | polymer | SB-2 | parts by | 0 | 0 | 0 | 0 | 0 | 0 | 0 | 0 | 0 |
| | | | mass | | | | | | | | | |
| | | SB-3 | parts by | 0 | 0 | 0 | 0 | 0 | 0 | 0 | 0 | 0 |
| | | | mass | | | | | | | | | |
| | Modified liquid | LR-1 | parts by | 0 | 0 | 0 | 0 | 0 | 0 | 0 | 0 | 0 |
| | rubber | | mass | | | | | | | | | |
| | | LR-2 | parts by | 0 | 0 | 0 | 0 | 0 | 0 | 0 | 0 | 0 |
| | | | mass | | | | | | | | | |
| | | LR-3 | parts by | 0 | 0 | 0 | 0 | 0 | 0 | 0 | 0 | 0 |
| | | | mass | | | | | | | | | |
| | CNF | CNF-1 | parts by | 10 | 10 | 10 | 10 | 0 | 0 | 0 | 10 | 10 |
| | composition | | mass | | | | | | | | | |
| | | CNF-2 | parts by | 0 | 0 | 0 | 0 | 8.56 | 0 | 0 | 0 | 0 |
| | | | mass | | | | | | | | | |
| | | CNF-3 | parts by | 0 | 0 | 0 | 0 | 0 | 7.14 | 0 | 0 | 0 |
| | | | mass | | | | | | | | | |
| | | CNF-4 | parts by | 0 | 0 | 0 | 0 | 0 | 0 | 7.14 | 0 | 0 |
| | | | mass | | | | | | | | | |
| | Reinforcing | Silica | parts by | 0 | 0 | 0 | 0 | 0 | 0 | 0 | 20 | 0 |
| | filler | | mass | | | | | | | | | |
| | | Carbon | parts by | 0 | 0 | 0 | 0 | 0 | 0 | 0 | 0 | 20 |
| | | black | mass | | | | | | | | | |

| | S-RAE oil | parts by | 10 | 10 | 10 | 10 | 10 | 10 | 10 | 10 | 10 |
|---|---|---|---|---|---|---|---|---|---|---|---|
| | | mass | | | | | | | | | |
| | Silane coupling agent | parts by | 0 | 0 | 0 | 0 | 0 | 0 | 0 | 1.6 | 0 |
| | | mass | | | | | | | | | |
| | Zinc oxide | parts by | 2.5 | 2.5 | 2.5 | 2.5 | 2.5 | 2.5 | 2.5 | 2.5 | 2.5 |
| | | mass | | | | | | | | | |
| | Stearic acid | parts by | 2.0 | 2.0 | 2.0 | 2.0 | 2.0 | 2.0 | 2.0 | 2.0 | 2.0 |
| | | mass | | | | | | | | | |
| | Wax | parts by | 1.5 | 1.5 | 1.5 | 1.5 | 1.5 | 1.5 | 1.5 | 1.5 | 1.5 |
| | | mass | | | | | | | | | |
| | Antioxidant | parts by | 2.0 | 2.0 | 2.0 | 2.0 | 2.0 | 2.0 | 2.0 | 2.0 | 2.0 |
| | | mass | | | | | | | | | |
| | Sulfur | parts by | 1.7 | 1.7 | 1.7 | 1.7 | 1.7 | 1.7 | 1.7 | 1.7 | 1.7 |
| | | mass | | | | | | | | | |
| | Vulcanization | parts by | 1.7 | 1.7 | 1.7 | 1.7 | 1.7 | 1.7 | 1.7 | 1.7 | 1.7 |
| | accelerator-1 | mass | | | | | | | | | |
| | vulcanization | parts by | 2.0 | 2.0 | 2.0 | 2.0 | 2.0 | 2.0 | 2.0 | 2.0 | 2.0 |
| | accelerator-2 | mass | | | | | | | | | |
| Dispersibility (visual inspection) | | | A | A | A | A | A | A | A | A | A |
| Physical | Workability | index | 51 | 49 | 58 | 83 | 51 | 49 | 51 | 62 | 64 |
| properties | Hardness | index | 100 | 104 | 108 | 115 | 100 | 96 | 96 | 109 | 111 |
| | Storage elastic modulus | index | 137 | 147 | 184 | 218 | 142 | 132 | 136 | 230 | 235 |
| | at 25° C. | | | | | | | | | | |
| | 100% Modulus | index | 182 | 247 | 276 | 306 | 229 | 224 | 229 | 324 | 312 |
| | 200% Modulus | index | 100 | 128 | 139 | 158 | 125 | 122 | 125 | 186 | 203 |
| | Tensile strength | index | 44 | 45 | 57 | 73 | 44 | 46 | 47 | 92 | 94 |
| | Tensile elongation | index | 89 | 91 | 111 | 146 | 86 | 89 | 91 | 106 | 109 |
| | Ozone resistance | | Good | Good | Fair | Excellent | Good | Good | Good | Good | Good |

TABLE 7
(Example A) Rubber composition and cured product (without using masterbatch)

| | | | | | | | | | Com- | Com- | Com- | Com- |
|---|---|---|---|---|---|---|---|---|---|---|---|---|
| | | | | Ex- | Ex- | Ex- | Ex- | Ex- | parative | parative | parative | parative |
| | | | | am- | am- | am- | am- | am- | Exam- | Exam- | Exam- | Exam- |
| | | | | ple 24 | ple 25 | ple 26 | ple 27 | ple 28 | ple 4 | ple 5 | ple 6 | ple 7 |
| For- | Hydrogenated | HSB-1 | parts by mass | 100 | 100 | 0 | 0 | 100 | 0 | 0 | 0 | 0 |
| mulation | conjugated | HSB-2 | parts by mass | 0 | 0 | 0 | 100 | 0 | 0 | 0 | 0 | 0 |
| | diene-based | HSB-3 | parts by mass | 0 | 0 | 0 | 0 | 0 | 0 | 0 | 0 | 0 |
| | polymer | HSB-4 | parts by mass | 0 | 0 | 100 | 0 | 0 | 0 | 0 | 0 | 0 |
| | Conjugated | SB-1 | parts by mass | 0 | 0 | 0 | 0 | 0 | 100 | 0 | 0 | 0 |
| | diene-based | SB-2 | parts by mass | 0 | 0 | 0 | 0 | 0 | 0 | 100 | 0 | 0 |
| | polymer | SB-3 | parts by mass | 0 | 0 | 0 | 0 | 0 | 0 | 0 | 100 | 100 |
| | Modified liquid | LR-1 | parts by mass | 0 | 0 | 0 | 10 | 10 | 0 | 0 | 0 | 0 |
| | rubber | LR-2 | parts by mass | 0 | 0 | 10 | 10 | 0 | 0 | 0 | 0 | 0 |
| | | LR-3 | parts by mass | 10 | 10 | 0 | 0 | 0 | 0 | 0 | 0 | 0 |
| | CNF composition | CNF-1 | parts by mass | 10 | 0 | 10 | 10 | 10 | 10 | 10 | 0 | 0 |
| | | CNF-2 | parts by mass | 0 | 0 | 0 | 0 | 0 | 0 | 0 | 0 | 0 |
| | | CNF-3 | parts by mass | 0 | 7.14 | 0 | 0 | 0 | 0 | 0 | 7.14 | 0 |
| | | CNF-4 | parts by mass | 0 | 0 | 0 | | 0 | 0 | 0 | 0 | 0 |
| | Reinforcing filler | Silica | parts by mass | 0 | 0 | 0 | 0 | 20 | 0 | 0 | 0 | 45 |
| | | Carbon black | parts by mass | 0 | 0 | 0 | 0 | 0 | 0 | 0 | 0 | 0 |

| | S-RAE oil | parts by mass | 0 | 0 | 0 | 0 | 0 | 10 | 10 | 10 | 10 |
|---|---|---|---|---|---|---|---|---|---|---|---|
| | Silane coupling agent | parts by mass | 0 | 0 | 0 | 0 | 1.6 | 0 | 0 | 0 | 0 |
| | Zinc oxide | parts by mass | 2.5 | 2.5 | 2.5 | 2.5 | 2.5 | 2.5 | 2.5 | 2.5 | 2.5 |
| | Stearic acid | parts by mass | 2.0 | 2.0 | 2.0 | 2.0 | 2.0 | 2.0 | 2.0 | 2.0 | 2.0 |
| | Wax | parts by mass | 1.5 | 1.5 | 1.5 | 1.5 | 1.5 | 1.5 | 1.5 | 1.5 | 1.5 |
| | Antioxidant | parts by mass | 2.0 | 2.0 | 2.0 | 2.0 | 2.0 | 2.0 | 2.0 | 2.0 | 2.0 |
| | Sulfur | parts by mass | 1.7 | 1.7 | 1.7 | 1.7 | 1.7 | 1.7 | 1.7 | 1.7 | 1.7 |
| | Vulcanization accelerator-1 | parts by mass | 1.7 | 1.7 | 1.7 | 1.7 | 1.7 | 1.7 | 1.7 | 1.7 | 1.7 |
| | Vulcanization accelerator-2 | parts by mass | 2.0 | 2.0 | 2.0 | 2.0 | 2.0 | 2.0 | 2.0 | 2.0 | 2.0 |
| Dispersibility (visual inspection) | | | A | A | A | A | A | B | B | C | C |
| Physical | Workability | index | 54 | 55 | 86 | 54 | 65 | 48 | 46 | 55 | 100 |
| properties | Hardness | index | 119 | 113 | 128 | 109 | 98 | 92 | 100 | 104 | 100 |
| | Storage elastic modulus | index | 197 | 190 | 307 | 186 | 223 | 122 | 137 | 175 | 100 |
| | at 25° C. | | | | | | | | | | |
| | 100% Modulus | index | 194 | 188 | 418 | 253 | 294 | 159 | 229 | 259 | 100 |
| | 200% Modulus | index | 128 | 122 | 214 | 131 | 156 | 89 | 122 | 131 | 100 |
| | Tensile strength | index | 83 | 74 | 102 | 65 | 85 | 39 | 44 | 55 | 100 |
| | Tensile elongation | index | 89 | 86 | 114 | 86 | 97 | 83 | 80 | 100 | 100 |
| | Ozone resistance | | Good | Good | Excellent | Good | Good | Poor | Poor | Poor | Poor |

### Examples 29 to 33, Comparative Examples 8 to 10

Using the hydrogenated conjugated diene-based polymers, hydrogenated conjugated diene-based polymers, natural rubbers and polybutadiene shown in Table 8 as starting rubber components, conjugated diene-based polymer compositions were obtained by kneading according to the formulations shown in Table 8 using the following method.

In the first stage of kneading, using an internal mixer (capacity: 0.35 L) equipped with a temperature control device, a starting rubber (hydrogenated conjugated diene-based polymer), starting rubbers (hydrogenated conjugated diene-based polymer, natural rubber, polybutadiene), a cellulose nanofiber composition, a modified liquid rubber, process oil, wax, zinc oxide and stearic acid were kneaded under the conditions of a filling rate of 65% and a rotor rotation speed of 30 to 70 rpm. At this time, the temperature of the internal mixer was controlled to obtain each conjugated diene-based polymer composition (compound) at the discharge temperature of 155 to 160° C.

Next, in the second stage of kneading, the compound obtained above was cooled to room temperature, and then an antioxidant was added, followed by kneading again to improve the dispersion of cellulose nanofibers. Also in this case, the temperature of the internal mixer was controlled to adjust the discharge temperature to 155 to 160° C. After cooling, in the third stage of kneading, sulfur, a vulcanization accelerator −1 and a vulcanization accelerator −2 were added, followed by kneading in an open roll set at 70° C. Thereafter, the mixture was molded and vulcanized in a vulcanization press at 160° C. for 15 minutes. The properties of the conjugated diene-based polymer composition before vulcanization and the conjugated diene-based polymer composition after vulcanization were evaluated. The results are shown in Table 8.

TABLE 8
(Example A) Rubber composition and cured product (using rubber other than SBR)

| | | | | Example | Example | Example | Example | Example | Comparative | Comparative | Comparative |
|---|---|---|---|---|---|---|---|---|---|---|---|
| | | | | 29 | 30 | 31 | 32 | 33 | Example 8 | Example 9 | Example 10 |
| For- | Masterbatch | | type | MB-1 | MB-1 | MB-2 | — | — | MB-12 | MB-12 | — |
| mulation | | | parts by | 30 | 30 | 30 | — | — | 30 | 30 | — |
| | | | mass | | | | | | | | |
| | Hydrogenated | HSB-1 | parts by | 50 | 50 | 0 | 70 | 0 | 0 | 0 | 70 |
| | conjugated | | mass | | | | | | | | |
| | diene-based | HSB-2 | parts by | 0 | 0 | 50 | 0 | 70 | 0 | 0 | 0 |
| | polymer | | mass | | | | | | | | |
| | Conjugated | SB-1 | parts by | 0 | 0 | 0 | 0 | 0 | 70 | 0 | 0 |
| | diene-based | | mass | | | | | | | | |
| | polymer | SB-2 | parts by | 0 | 0 | 0 | 0 | 0 | 0 | 70 | 0 |
| | | | mass | | | | | | | | |
| | Natural rubber | | parts by | 30 | 30 | 0 | 30 | 0 | 30 | 0 | 30 |
| | | | mass | | | | | | | | |
| | Polybutadiene | | parts by | 0 | 0 | 30 | 0 | 30 | 0 | 30 | 0 |
| | | | mass | | | | | | | | |
| | Modified | LR-3 | parts by | 0 | 10 | 0 | 10 | 0 | 0 | 0 | 0 |
| | liquid rubber | | mass | | | | | | | | |
| | CNF | CNF-1 | parts by | 0 | 0 | 0 | 10 | 10 | 10 | 10 | 0 |
| | composition | | mass | | | | | | | | |
| | Reinforcing | Silica | parts by | 0 | 0 | 0 | 0 | 0 | 0 | 0 | 45 |
| | filler | | mass | | | | | | | | |

| | S-RAE oil | parts by | 10 | 0 | 10 | 0 | 10 | 10 | 10 | 10 |
|---|---|---|---|---|---|---|---|---|---|---|
| | | mass | | | | | | | | |
| | Silane coupling agent | parts by | 0 | 0 | 0 | 0 | 0 | 0 | 0 | 3.6 |
| | | mass | | | | | | | | |
| | Zinc oxide | parts by | 2.5 | 2.5 | 2.5 | 2.5 | 2.5 | 2.5 | 2.5 | 2.5 |
| | | mass | | | | | | | | |
| | Stearic acid | parts by | 2.0 | 2.0 | 2.0 | 2.0 | 2.0 | 2.0 | 2.0 | 2.0 |
| | | mass | | | | | | | | |
| | Wax | parts by | 1.5 | 1.5 | 1.5 | 1.5 | 1.5 | 1.5 | 1.5 | 1.5 |
| | | mass | | | | | | | | |
| | Antioxidant | parts by | 2.0 | 2.0 | 2.0 | 2.0 | 2.0 | 2.0 | 2.0 | 2.0 |
| | | mass | | | | | | | | |
| | Sulfur | parts by | 1.7 | 1.7 | 1.7 | 1.7 | 1.7 | 1.7 | 1.7 | 1.7 |
| | | mass | | | | | | | | |
| | Vulcanization | parts by | 1.7 | 1.7 | 1.7 | 1.7 | 1.7 | 1.7 | 1.7 | 1.7 |
| | accelerator-1 | mass | | | | | | | | |
| | Vulcanization | parts by | 2.0 | 2.0 | 2.0 | 2.0 | 2.0 | 2.0 | 2.0 | 2.0 |
| | accelerator-2 | mass | | | | | | | | |
| Dispersibility (visual | | | A | A | A | A | A | B | B | B |
| inspection) | | | | | | | | | | |
| physical | Workability | index | 50 | 58 | 63 | 55 | 65 | 52 | 50 | 100 |
| properties | Hardness | index | 108 | 116 | 108 | 114 | 107 | 104 | 103 | 100 |
| | Storage elastic | index | 105 | 197 | 102 | 188 | 100 | 95 | 86 | 100 |
| | modulus at 25° C. | | | | | | | | | |
| | 100% Modulus | index | 106 | 282 | 103 | 265 | 100 | 94 | 82 | 100 |
| | 200% Modulus | index | 102 | 172 | 101 | 165 | 100 | 98 | 93 | 100 |
| | Tensile strength | index | 92 | 108 | 92 | 105 | 92 | 91 | 89 | 100 |
| | Tensile elongation | index | 95 | 98 | 94 | 96 | 93 | 93 | 90 | 100 |
| | Ozone resistance | | Good | Good | Good | Good | Good | Poor | Poor | Poor |

As shown in Tables 4 to 8, it was confirmed that the hydrogenated conjugated diene-based polymer compositions obtained in Examples 1 to 28 have lower compound Mooney viscosity and are excellent in processability of the rubber composition, as compared with the conjugated diene-based polymer compositions obtained in Comparative Examples 1 to 7.

It was also confirmed that the hydrogenated conjugated diene-based polymer compositions obtained in Examples 1 to 28 have excellent ozone resistance, high tensile strength, high tensile modulus and high elastic modulus, as compared with the conjugated diene-based polymer compositions obtained in Comparative Examples 1 to 7.

It was also confirmed that the conjugated diene-based polymer compositions using the masterbatches obtained in Examples 1 to 14 have improved physical properties due to the use of the masterbatches, as compared with the conjugated diene-based polymer compositions obtained in Examples 15 to 28.

It was also confirmed that the hydrogenated conjugated diene-based polymer compositions obtained in Examples 10 to 14 and Examples 24 to 28 have high tensile strength, high tensile modulus and high elastic modulus, as compared with the conjugated diene-based polymer compositions obtained in Examples 1 to 9 and Examples 15 to 23, and an improvement in physical properties by mixing the modified liquid rubber was confirmed.

It was also confirmed that the hydrogenated conjugated diene-based polymer compositions obtained in Examples 29 to 33 have higher tensile strength, high tensile modulus and high elastic modulus, as compared with the conjugated diene-based polymer compositions obtained in Comparative Examples 8 to 10, and improved physical properties were also confirmed in the compounds containing a natural rubber and polybutadiene.

### (2) Example B

The evaluation procedures for (weight average molecular weight), (bound styrene content), (microstructure of butadiene portion: 1,2-vinyl bond content), (hydrogenation rate of conjugated diene-based polymer, and ethylene structure), (Mooney viscosity of conjugated diene-based polymer and conjugated diene-based polymer composition) are the same as those of Example A.

### (Production Example 1) Conjugated Diene Polymer Before Hydrogenation (SB-2)

The same as SB-2 of Example A.

### (Preparation of Hydrogenated Catalyst (TC1))

The same as in Example A.

### (Production Example 2) Hydrogenated Conjugated Diene-Based Polymer (HSB-1)

A rubber-like polymer solution before hydrogenation was obtained in the same manner as in Production Example 1 of Example A, and then a hydrogenated conjugated diene-based polymer (HSB-1) was obtained in the same manner as in Production Example 4 of Example A.

### (Production Example 3) Hydrogenated Conjugated Diene-Based Polymer (HSB-2)

From the conjugated diene-based polymer solution before hydrogenation obtained in Production Example 1, a hydrogenated conjugated diene-based polymer (HSB-2) was obtained in the same manner as in Production Example 5 of Example A.

### (Production Example 4) Hydrogenated Conjugated Diene-Based Polymer (HSB-5)

In the same manner as in Production Example 2, except that the amount of the hydrogenation catalyst (TC1) added was changed to 30 ppm based on Ti per 100 parts by mass of the rubber-like polymer before hydrogenation, a hydrogenated conjugated diene-based polymer (HSB-5) was obtained.

### <<Preparation of Cellulose Nanofiber Composition>>

Regarding each component in Table 9, <surfactant-1>, <surfactant-2>, <liquid rubber-1>, and <cellulose nanofiber> are the same as in Example A.

### <Preparation Procedure of Composition>

### (Production Example 1) CNF Composition (CNF-1)

The same as in Example A.

### (Production Example 2) CNF Composition (CNF-2)

In the same manner as in Production Example 1, except that a liquid rubber-1 and a surfactant-1 were added to prepare an aqueous dispersion having a final composition of 91.43% by mass water, 5% by mass cellulose fiber, 2.86% by mass liquid rubber and 0.71% by mass surfactant, a CNF composition powder (CNF-2) was obtained

### (Production Example 3) CNF Composition (CNF-3)

The same as CNF-3 in Example A.

### (Production Example 4) CNF Composition (CNF-4)

The same as CNF-4 in Example A.

### [Table 9]

TABLE 9
(Example B) Cellulose nanofiber composition

| | | CNF-1 | CNF-2 | CNF-3 | CNF-4 |
|---|---|---|---|---|---|
| Cellulose nanofibers | % by mass | 50 | 58.4 | 70 | 70 |
| Surfactant-1 | % by mass | 21.4 | 8.3 | 30 | 0 |
| Surfactant-2 | % by mass | 0 | 0 | 0 | 30 |
| Liquid rubber-1 | % by mass | 28.6 | 33.3 | 0 | 0 |
| Compacted | g/cm³ | 0.213 | 0.181 | 0.145 | 0.213 |
| bulk density | | | | | |

### <<Production of Masterbatch>>

The liquid rubber in Table 10 is the same as that in Example A.

### (Production Example 1) Natural Masterbatch for Rubber Modification (MB-1)

Using an internal mixer (capacity: 0.35 L) equipped with a temperature control device, 100 parts by mass of a hydrogenated conjugated diene-based polymer (HSB-2) and 50 parts by mass of a CNF composition (CNF-1) were kneaded in the first stage under the conditions of a filling rate of 65% and a rotor rotation speed of 30 to 50 rpm. At this time, the temperature of the internal mixer was controlled so that the discharge temperature was 155 to 160° C. to obtain a rubber composition (compound).

Next, in the second stage of kneading, the above obtained compound was cooled to room temperature and then kneaded again to improve the dispersion of CNF. Also in this case, the temperature of the internal mixer was controlled to adjust the discharge temperature to 155 to 160° C., thus obtaining a masterbatch for natural rubber modification (MB-1).

### (Production Examples 2 to 5) Masterbatches for Natural Rubber Modification (MB-2 to MB-5)

In the same manner as in Production Example 1, except that the starting materials (hydrogenated conjugated diene-based polymer and CNF composition) and the mixing amounts used in the production of the masterbatch for natural rubber modification were changed as shown in Table 10, masterbatches for natural rubber modification (MB-2 to MB-5) were obtained.

### (Production Example 6) Masterbatch for Natural Rubber Modification (MB-6)

Using an internal mixer (capacity: 0.35 L) equipped with a temperature control device, in the first stage of kneading, 100 parts by mass of a hydrogenated conjugated diene-based polymer (HSB-1) and 50 parts by mass of CNF composition (CNF-1) were kneaded for 1 minute under the conditions of a filling rate of 65% and a rotor rotation speed of 30 to 50 rpm, and then 50 parts by mass of a modified liquid polyisoprene (LR-3) was added, followed by kneading. The temperature of the internal mixer was controlled so that the discharge temperature was 155 to 160° C. to obtain a rubber composition (compound).

Next, in the second stage of kneading, the above obtained compound was cooled to room temperature and then kneaded again to improve the dispersion of CNF. Also in this case, the temperature of the internal mixer was controlled to adjust the discharge temperature to 155 to 160° C., thus obtaining a masterbatch for natural rubber modification (MB-6).

### (Production Examples 7 to 8) Masterbatches for Natural Rubber Modification (MB-7 to MB-8)

In the same manner as in Production Example 6, except that the starting materials (hydrogenated conjugated diene-based polymer and CNF composition, liquid rubber) and the mixing amounts used in the production of the masterbatch for natural rubber modification were changed as shown in Table 10, masterbatch for natural rubber modification (MB-7 to MB-8) were obtained.

### (Production Example 9) Masterbatch for Natural Rubber Modification (MB-9)

Using an internal mixer (capacity: 0.35 L) equipped with a temperature control device, 100 parts by mass of a conjugated diene-based polymer (SB-2) and 50 parts by mass of the CNF composition (CNF-1) were mixed in the first stage under the conditions of a filling rate of 65% and a rotor rotation speed of 30 to 50 rpm. At this time, the temperature of the internal mixer was controlled so that the discharge temperature was 155 to 160° C. to obtain a rubber composition (compound).

Next, in the second stage of kneading, the above obtained compound was cooled to room temperature and then kneaded again to improve the dispersion of CNF. Also in this case, the temperature of the internal mixer was controlled to adjust the discharge temperature to 155 to 160° C., thus obtaining a masterbatch for natural rubber modification (MB-9).

### (Production Example 10) Masterbatch for Natural Rubber Modification (MB-10)

In the same manner as in Production Example 9, except that the hydrogenated conjugated diene-based polymer used in the production of the masterbatch for natural rubber modification was changed as shown in Table 10, a masterbatch for natural rubber modification (MB-10) was obtained.

TABLE 10
(Example B) Masterbatch for rubber modification

| | | | MB-1 | MB-2 | MB-3 | MB-4 | MB-5 | MB-6 | MB-7 | MB-8 | MB-9 | MB-10 |
|---|---|---|---|---|---|---|---|---|---|---|---|---|
| Hydrogenated | HSB-1 | phr | 0 | 100 | 100 | 100 | 100 | 100 | 0 | 100 | 0 | 0 |
| conjugated diene-based | HSB-2 | phr | 100 | 0 | 0 | 0 | 0 | 0 | 100 | 0 | 0 | 0 |
| polymer | HSB-5 | phr | 0 | 0 | 0 | 0 | 0 | 0 | 0 | 0 | 0 | 100 |
| Conjugated diene- | SB-2 | phr | 0 | 0 | 0 | 0 | 0 | 0 | 0 | 0 | 100 | 0 |
| based polymer | | | | | | | | | | | | |
| Modified liquid rubber | LR-1 | phr | 0 | 0 | 0 | 0 | 0 | 0 | 0 | 50 | 0 | 0 |
| | LR-2 | phr | 0 | 0 | 0 | 0 | 0 | 0 | 50 | 0 | 0 | 0 |
| | LR-3 | phr | 0 | 0 | 0 | 0 | 0 | 50 | 0 | 0 | 0 | 0 |
| CNF composition | CNF-1 | phr | 50 | 50 | 0 | 0 | 0 | 50 | 0 | 50 | 50 | 50 |
| | CNF-2 | phr | 0 | 0 | 42.8 | 0 | 0 | 0 | 0 | 0 | 0 | 0 |
| | CNF-3 | phr | 0 | 0 | 0 | 35.7 | 0 | 0 | 35.7 | 0 | 0 | 0 |
| | CNF-4 | phr | 0 | 0 | 0 | 0 | 35.7 | 0 | 0 | 0 | 0 | 0 |

### <<Preparation of Hydrogenated Conjugated Diene-Based Polymer Composition>>

The product names used for each component in Tables 11 and 12 are as follows.

### <Natural Rubber>

RSS No. 3 (Manufacturer: UNIMAC RUBBER CO., LTD. (Thailand), Supplier: Marubeni Techno Rubber)

The product names of <liquid rubber>, <silica>, <carbon black>, <silane coupling agent>, <zinc oxide>, <stearic acid>, <antioxidant>, <wax>, <sulfur>, <vulcanization accelerator −1> and <vulcanization accelerator −2> are the same as those in Example A.

The properties of the conjugated diene-based polymer composition before vulcanization (rubber composition) and the conjugated diene-based polymer composition after vulcanization (cured product) were evaluated by the following methods.

### (Dispersibility of Cellulose Nanofibers)

Evaluation was carried out in the same manner as in Example A.

### (Tensile Strength, Tensile Modulus and Tensile Elongation)

The measurement was made by in the same manner as in Example A, and each result was shown as an index obtained assuming that the result of Comparative Example 1 was 100.

### (Hardness)

The measurement was made by in the same manner as in Example A, and each result was shown as an index obtained assuming that the result of Comparative Example 1 was 100.

### (Storage Elastic Modulus)

The measurement was made by in the same manner as in Example A, and each result was shown as an index obtained assuming that the result of Comparative Example 1 was 100.

### (Ozone Resistance)

Using each of the resulting cured products, the ozone resistance was determined by the following test method.

Each vulcanized rubber composition was subjected to vulcanization pressing using a prescribed mold (15 cm long×15 cm wide×2.0 mm thickness) under the conditions of 160° C. for 10 to 20 minutes to obtain a vulcanized rubber sheet, and a strip sample (6 cm long×1 cm wide×2.0 mm thickness) was punched out from the vulcanized rubber sheet and, after placing in an ozone tank (50° C., 100 pphm), the strip sample was left to stand for 48 hours in the state of 15% elongation. Thereafter, the strip sample (vulcanized rubber sheet) was observed, and the number of cracks having a length of 1 mm or more on the surface was counted and evaluated according to the following criteria.

### [Determination Criteria]

Poor: The vulcanized rubber sheet was broken.
Fair: The number of cracks having a length of 1 mm or more was 21 or more.
Good: The number of cracks having a length of 1 mm or more was 10 or more and 20 or less.
Excellent: The number of cracks having a length of 1 mm or more was 1 or more and less than 10.

### (Morphology)

The cross-sectional morphology of the cured product was observed using a high-resolution scanning electron microscope (SU8220, manufactured by Hitachi High-Tech Corporation). Using Cryomicrotome (UC7, manufactured by Leica), the cured product was cut with a diamond knife at −120° C. to fabricate a smooth cross section, which was then subjected to electronic staining with osmium tetroxide to obtain a specimen for observation. The observation sample was mounted on a sample station using carbon paste, and then osmium coating was carried out as a conductive treatment. As the observation conditions using a high-resolution scanning electron microscope, an acceleration voltage of 2 kV, a working distance of about 4 mm and an Upper detector (LA100) were selected to obtain a backscattered electron image with enhanced compositional contrast. The obtained cross-sectional images were subjected to image processing using ImageJ, and the size of the island portion was measured by binarization processing. The size of the island was converted into a circle and its diameter was taken as the size of the island, and the median diameter (D50) of the island was calculated. Then, it was evaluated according to the following criteria.

### [Determination Criteria]

Poor: No island portion is present, or the island portion is present but contains cellulose nanofibers.
Fair: Cellulose nanofibers are dispersed in the continuous phase (sea portion), and the D50 of the island portions is less than 50 nm or more than 1,000 nm.
Good: Cellulose nanofibers are dispersed in the continuous phase (sea portion), and D50 of the island portions is 50 nm or more and 1,000 nm or less.

### Examples 1 to 5

Using the masterbatches and natural rubber shown in Table 11 as starting rubber components, hydrogenated conjugated diene-based polymer compositions were obtained by kneading according to the formulations shown in Table 11 using the following method.

Using an internal mixer (contents: 0.35 L) equipped with a temperature control device, a masterbatch, a starting rubber (natural rubber), zinc oxide, stearic acid, antioxidant and wax were mixed in the first stage of mixing under the conditions of a filling rate of 65% and a rotor rotation speed of 30 to 70 rpm. At this time, the temperature of the internal mixer was controlled so that the discharge temperature was 155 to 160° C., thus obtaining a hydrogenated conjugated diene-based polymer composition (compound).

Next, in the second stage of kneading, the mixture obtained above was cooled to room temperature and then kneaded again to improve the dispersion of the cellulose nanofibers. Also in this case, the temperature of the mixer was controlled to adjust the discharge temperature to 155 to 160° C. After cooling, in the third stage of kneading, sulfur and a vulcanization accelerator −1 were added, followed by kneading in an open roll set at 70° C. Thereafter, the mixture was molded and vulcanized in a vulcanization press at 160° C. for 15 minutes. The properties of the vulcanized hydrogenated conjugated diene-based polymer composition were evaluated. The results are shown in Table 11.

### Example 6

Using the masterbatch and natural rubber shown in Table 11 as starting rubber components, the mixture was kneaded according to the formulation shown in Table 11 by the following method to obtain a hydrogenated conjugated diene-based polymer composition.

Using an internal mixer (contents: 0.35 L) equipped with a temperature control device, a masterbatch, a starting rubber (natural rubber), a reinforcing filler (silica), a silane coupling agent, zinc oxide, stearic acid, antioxidant and wax were kneaded in the first stage of mixing under the conditions of a filling rate of 65% and a rotor rotation speed of 30 to 70 rpm. At this time, the temperature of the internal mixer was controlled to obtain a hydrogenated conjugated diene-based polymer composition (compound) at the discharge temperature was 155 to 160° C.

Next, in the second stage of kneading, the mixture obtained above was cooled to room temperature and then kneaded again to improve the dispersion of the cellulose nanofibers and the reinforcing filler (silica). Also in this case, the temperature of the mixer was controlled to adjust the discharge temperature to 155 to 160° C. After cooling, in the third stage of kneading, sulfur, a vulcanization accelerator −1 and a vulcanization accelerator −2 were added, followed by kneading using an open roll set at 70° C. Thereafter, the product was molded and vulcanized in a vulcanization press at 160° C. for 15 minutes. The properties of the vulcanized hydrogenated conjugated diene-based polymer composition were evaluated. The results are shown in Table 11.

### Example 7

Using the masterbatches and natural rubber shown in Table 11 as starting rubber components, the mixtures were kneaded in accordance with the formulation shown in Table 11 by the following method to obtain hydrogenated conjugated diene-based polymer compositions.

Using an internal mixer (contents: 0.35 L) equipped with a temperature control device, a masterbatch, a starting rubber (natural rubber), a reinforcing filler (carbon black), zinc oxide, stearic acid, antioxidant and wax were kneaded in the first stage of mixing under the conditions of a filling rate of 65% and a rotor rotation speed of 30 to 70 rpm. At this time, the temperature of the internal mixer was controlled to obtain a hydrogenated conjugated diene-based polymer composition (compound) at the discharge temperature was 155 to 160° C.

Next, in the second stage of kneading, the mixture obtained above was cooled to room temperature and then kneaded again to improve the dispersion of the cellulose nanofibers and the reinforcing filler (carbon black). Also in this case, the temperature of the mixer was controlled to adjust the discharge temperature of the compound to 155 to 160° C. After cooling, in the third stage of kneading, sulfur and a vulcanization accelerator −1 were added, followed by kneading in an open roll set at 70° C. Thereafter, the mixture was molded and vulcanized in a vulcanization press at 160° C. for 15 minutes. The properties of the vulcanized hydrogenated conjugated diene-based polymer composition were evaluated. The results are shown in Table 11.

### Examples 8 to 10

Using the masterbatches and natural rubber shown in Table 11 as starting rubber components, hydrogenated conjugated diene-based polymer compositions were obtained by kneading according to the formulations shown in Table 11 by the following method.

Using an internal mixer (contents: 0.35 L) equipped with a temperature control device, a masterbatch, a starting rubber (natural rubber), zinc oxide, stearic acid, antioxidant and wax were mixed in the first stage of mixing under the conditions of a filling rate of 65% and a rotor rotation speed of 30 to 70 rpm. At this time, the temperature of the internal mixer was controlled to obtain a hydrogenated conjugated diene-based polymer composition (compound) at the discharge temperature was 155 to 160° C.

Next, in the second stage of kneading, the compound obtained above was cooled to room temperature and then kneaded again to improve the dispersion of the cellulose nanofibers. Also in this case, the temperature of the mixer was controlled to adjust the discharge temperature of the compound to 155 to 160° C. After cooling, in the third stage of kneading, sulfur and a vulcanization accelerator −1 were added, followed by kneading in an open roll set at 70° C. Thereafter, the mixture was molded and vulcanized in a vulcanization press at 160° C. for 15 minutes. The properties of the vulcanized hydrogenated conjugated diene-based polymer composition were evaluated. The results are shown in Table 11.

### Example 11

Using the masterbatch and natural rubber shown in Table 11 as starting rubber components, the mixture was kneaded according to the formulation shown in Table 11 by the following method to obtain a hydrogenated conjugated diene-based polymer composition.

Using an internal mixer (contents: 0.35 L) equipped with a temperature control device, a masterbatch, a starting rubber (natural rubber), a reinforcing filler (silica), a silane coupling agent, zinc oxide, stearic acid, antioxidant and wax were kneaded in the first stage of mixing under the conditions of a filling rate of 65% and a rotor rotation speed of 30 to 70 rpm. At this time, the temperature of the internal mixer was controlled to obtain a hydrogenated conjugated diene-based polymer composition (compound) at the discharge temperature was 155 to 160° C.

Next, in the second stage of kneading, the mixture obtained above was cooled to room temperature and then kneaded again to improve the dispersion of the cellulose nanofibers and the reinforcing filler (silica). Also in this case, the temperature of the mixer was controlled to adjust the discharge temperature of the compound to 155 to 160° C. After cooling, in the third stage of kneading, sulfur, a vulcanization accelerator −1 and a vulcanization accelerator −2 were added, followed by kneading using an open roll set at 70° C. Thereafter, the product was molded and vulcanized in a vulcanization press at 160° C. for 15 minutes. The properties of the vulcanized hydrogenated conjugated diene-based polymer composition were evaluated. The results are shown in Table 11.

### Example 12

Using the masterbatch and natural rubber shown in Table 11 as starting rubber components, the mixture was kneaded according to the formulation shown in Table 11 by the following method to obtain a hydrogenated conjugated diene-based polymer composition.

Using an internal mixer (contents: 0.35 L) equipped with a temperature control device, a masterbatch, a starting rubber (natural rubber), zinc oxide, stearic acid, antioxidant and wax were mixed in the first stage of mixing under the conditions of a filling rate of 65% and a rotor rotation speed of 30 to 70 rpm. At this time, the temperature of the internal mixer was controlled to obtain a hydrogenated conjugated diene-based polymer composition (compound) at the discharge temperature was 155 to 160° C.

Next, in the second stage of kneading, the mixture obtained above was cooled to room temperature and then kneaded again to improve the dispersion of the cellulose nanofibers. Also in this case, the temperature of the mixer was controlled to adjust the discharge temperature of the compound to 155 to 160° C. After cooling, in the third stage of kneading, sulfur and a vulcanization accelerator −1 were added, followed by kneading in an open roll set at 70° C. Thereafter, the mixture was molded and vulcanized in a vulcanization press at 160° C. for 15 minutes. The properties of the vulcanized hydrogenated conjugated diene-based polymer composition were evaluated. The results are shown in Table 11.

### Comparative Example 1

Using the masterbatch and natural rubber shown in Table 11 as starting rubber components, conjugated diene-based polymer compositions were obtained by kneading according to the formulation shown in Table 11 by the following method.

Using an internal mixer (contents: 0.35 L) equipped with a temperature control device, a masterbatch, a starting rubber (natural rubber), zinc oxide, stearic acid, antioxidant and wax were mixed in the first stage of mixing under the conditions of a filling rate of 65% and a rotor rotation speed of 30 to 70 rpm. At this time, the temperature of the internal mixer was controlled to obtain a hydrogenated conjugated diene-based polymer composition (compound) at the discharge temperature was 155 to 160° C.

Next, in the second stage of kneading, the mixture obtained above was cooled to room temperature and then kneaded again to improve the dispersion of the cellulose nanofibers. Also in this case, the temperature of the mixer was controlled to adjust the discharge temperature of the compound to 155 to 160° C. After cooling, in the third stage of kneading, sulfur and a vulcanization accelerator −1 were added, followed by kneading in an open roll set at 70° C. Thereafter, the mixture was molded and vulcanized in a vulcanization press at 160° C. for 15 minutes. The properties of the vulcanized conjugated diene-based polymer composition were evaluated. The results are shown in Table 11.

TABLE 11
(Example B) Rubber composition and cured product (using masterbatch)

| | | | | | | | | | | | | | Ex- | Ex- | Com- | Ex- |
|---|---|---|---|---|---|---|---|---|---|---|---|---|---|---|---|---|
| | | | | Ex- | Ex- | Ex- | Ex- | Ex- | Ex- | Ex- | Ex- | Ex- | am- | am- | parative | am- |
| | | | | am- | am- | am- | am- | am- | am- | am- | am- | am- | ple | ple | Exam- | ple |
| | | | | ple 1 | ple 2 | ple 3 | ple 4 | ple 5 | ple 6 | ple 7 | ple 8 | ple 9 | 10 | 11 | ple 1 | 12 |
| For- | Master- | Type | | MB- | MB- | MB- | MB- | MB- | MB- | MB- | MB- | MB- | MB- | MB- | MB-9 | MB- |
| mulation | batch | | | 1 | 2 | 3 | 4 | 5 | 2 | 2 | 6 | 7 | 8 | 8 | | 10 |
| | | | parts by mass | 30 | 30 | 28.56 | 27.14 | 27.14 | 60 | 60 | 40 | 37.14 | 40 | 60 | 30 | 30 |
| | Natural | NR | parts by mass | 80 | 80 | 80 | 80 | 80 | 60 | 60 | 80 | 80 | 80 | 70 | 80 | 80 |
| | rubber | | | | | | | | | | | | | | | |
| | Reinforcing | Silica | parts by mass | 0 | 0 | 0 | 0 | 0 | 20 | 0 | 0 | 0 | 0 | 15 | 0 | 0 |
| | filler | Carbon | parts by mass | 0 | 0 | 0 | 0 | 0 | 0 | 20 | 0 | 0 | 0 | 0 | 0 | 0 |
| | | black | | | | | | | | | | | | | | |

| | Silane coupling | parts by mass | 0 | 0 | 0 | 0 | 0 | 1.6 | 0 | 0 | 0 | 0 | 1.2 | 0 | 0 |
|---|---|---|---|---|---|---|---|---|---|---|---|---|---|---|---|
| | agent | | | | | | | | | | | | | | |
| | Zinc oxide | parts by mass | 2.6 | 2.6 | 2.6 | 2.6 | 2.6 | 2.6 | 2.6 | 2.6 | 2.6 | 2.6 | 2.6 | 2.6 | 2.6 |
| | Stearic acid | parts by mass | 2.0 | 2.0 | 2.0 | 2.0 | 2.0 | 2.0 | 2.0 | 2.0 | 2.0 | 2.0 | 2.0 | 2.0 | 2.0 |
| | Antioxidant | parts by mass | 3.0 | 3.0 | 3.0 | 3.0 | 3.0 | 3.0 | 3.0 | 3.0 | 3.0 | 3.0 | 3.0 | 3.0 | 3.0 |
| | Wax | parts by mass | 1.5 | 1.5 | 1.5 | 1.5 | 1.5 | 1.5 | 1.5 | 1.5 | 1.5 | 1.5 | 1.5 | 1.5 | 1.5 |
| | Sulfur | parts by mass | 1.5 | 1.5 | 1.5 | 1.5 | 1.5 | 1.5 | 1.5 | 1.5 | 1.5 | 1.5 | 1.5 | 1.5 | 1.5 |
| | Vulcanization | parts by mass | 0.9 | 0.9 | 0.9 | 0.9 | 0.9 | 0.9 | 0.9 | 0.9 | 0.9 | 0.9 | 0.9 | 0.9 | 0.9 |
| | accelerator-1 | | | | | | | | | | | | | | |
| | Vulcanization | parts by mass | — | — | — | — | — | 0.4 | — | — | — | — | 0.3 | — | — |
| | accelerator-2 | | | | | | | | | | | | | | |
| Dispersibility | | | A | A | A | A | A | A | A | A | A | A | A | B | A |
| (visual inspection) | | | | | | | | | | | | | | | |
| Physical | Hardness | index | 106 | 113 | 107 | 105 | 108 | 130 | 132 | 111 | 110 | 118 | 116 | 100 | 104 |
| pro- | Storage elastic | index | 110 | 123 | 120 | 115 | 121 | 181 | 186 | 137 | 135 | 148 | 191 | 100 | 106 |
| perties | modulus at 25° C. | | | | | | | | | | | | | | |
| | 100% modulus | index | 113 | 127 | 122 | 117 | 118 | 263 | 252 | 141 | 134 | 148 | 237 | 100 | 109 |
| | 200% modulus | index | 110 | 120 | 117 | 115 | 116 | 202 | 223 | 156 | 146 | 165 | 178 | 100 | 108 |
| | Tensile strength | index | 107 | 117 | 111 | 113 | 117 | 189 | 185 | 148 | 141 | 152 | 161 | 100 | 105 |
| | Tensile elongation | index | 107 | 113 | 112 | 111 | 114 | 133 | 131 | 120 | 117 | 121 | 126 | 100 | 105 |
| | Ozone resistance | | Fair | Good | Good | Good | Good | Excel- | Excel- | Good | Good | Good | Excel- | Poor | Fair |
| | | | | | | | | lent | lent | | | | lent | | |
| | Morphology | | Good | Good | Good | Good | Good | Good | Good | Good | Good | Good | Good | Poor | Fair |

### Examples 13 to 17

Using the hydrogenated conjugated diene-based polymers shown in Table 12 as starting rubber components, the mixture was kneaded according to the formulations shown in Table 12 by the following method to obtain hydrogenated conjugated diene-based polymer compositions.

Using an internal mixer (contents: 0.35 L) equipped with a temperature control device, a hydrogenated conjugated diene-based polymer (HSB-1 or HSB-2), a starting rubber (natural rubber), a cellulose nanofiber composition, zinc oxide, stearic acid, antioxidant and wax were mixed in the first stage of mixing under the conditions of a filling rate of 65% and a rotor rotation speed of 30 to 70 rpm. At this time, the temperature of the internal mixer was controlled to obtain a hydrogenated conjugated diene-based polymer composition (compound) at the discharge temperature was 155 to 160° C.

Next, in the second stage of kneading, the compound obtained above was cooled to room temperature and then kneaded again to improve the dispersion of the cellulose nanofibers. Also in this case, the temperature of the mixer was controlled to adjust the discharge temperature of the compound to 155 to 160° C. After cooling, in the third stage of kneading, sulfur and a vulcanization accelerator −1 were added, followed by kneading using an open roll set at 70° C. Thereafter, the mixture was molded and vulcanized in a vulcanization press at 160° C. for 15 minutes. The properties of the vulcanized hydrogenated conjugated diene-based polymer composition were evaluated. The results are shown in Table 12.

### Example 18

Using the hydrogenated conjugated diene-based polymers shown in Table 12 as starting rubber components, the mixture was kneaded according to the formulations shown in Table 12 by the following method to obtain a hydrogenated conjugated diene-based polymer composition.

In the first stage of kneading, using an internal mixer (contents: 0.35 L) equipped with a temperature control device, a masterbatch, a hydrogenated conjugated diene-based polymer (HSB-1), a starting rubber (natural rubber), a cellulose nanofiber composition, a reinforcing filler (silica), a silane coupling agent, zinc oxide, stearic acid, an antioxidant and wax were kneaded under the conditions of a filling rate of 65% and a rotor rotation speed of 30 to 70 rpm. At this time, the temperature of the internal mixer was controlled to obtain a hydrogenated conjugated diene-based polymer composition (compound) at the discharge temperature was 155 to 160° C.

Next, in the second stage of kneading, the mixture obtained above was cooled to room temperature and then kneaded again to improve the dispersion of the cellulose nanofibers and the reinforcing filler (silica). Also in this case, the temperature of the mixer was controlled to adjust the discharge temperature of the compound to 155 to 160° C. After cooling, in the third stage of kneading, sulfur, a vulcanization accelerator −1 and a vulcanization accelerator −2 were added, followed by kneading using an open roll set at 70° C. Thereafter, the mixture was molded and vulcanized in a vulcanization press at 160° C. for 15 minutes. The properties of the vulcanized hydrogenated conjugated diene-based polymer composition were evaluated. The results are shown in Table 12.

### Example 19

Using the hydrogenated conjugated diene-based polymers shown in Table 12 as starting rubber components, the compound was kneaded in the manner described below according to the formulations shown in Table 12 to obtain hydrogenated conjugated diene-based polymer compositions.

In the first stage of kneading, using an internal mixer (contents: 0.35 L) equipped with a temperature control device, a hydrogenated conjugated diene-based polymer (HSB-1), a starting rubber (natural rubber), a cellulose nanofiber composition, a reinforcing filler (carbon black), zinc oxide, stearic acid, an antioxidant and wax were kneaded were kneaded under the conditions of a filling rate of 65% and a rotor rotation speed of 30 to 70 rpm. At this time, the temperature of the internal mixer was controlled to obtain a hydrogenated conjugated diene-based polymer composition (compound) at the discharge temperature of 155 to 160° C.

Next, in the second stage of kneading, the mixture obtained above was cooled to room temperature and then kneaded again to improve the dispersion of the cellulose nanofibers and the reinforcing filler (carbon black). Also in this case, the temperature of the mixer was controlled to adjust the discharge temperature of the compound to 155 to 160° C. After cooling, in the third stage of kneading, sulfur and a vulcanization accelerator −1 were added, followed by kneading using an open roll set at 70° C. Thereafter, the mixture was molded and vulcanized in a vulcanization press at 160° C. for 15 minutes. The properties of the vulcanized hydrogenated conjugated diene-based polymer composition were evaluated. The results are shown in Table 12.

### Examples 20 to 22

Using the hydrogenated conjugated diene-based polymers shown in Table 12 as starting rubber components, the compositions were kneaded in the following manner according to the formulations shown in Table 12 to obtain hydrogenated conjugated diene-based polymer compositions.

In the first stage of kneading, using an internal mixer (capacity: 0.35 L) equipped with a temperature control device, a hydrogenated conjugated diene-based polymer (HSB-1 or HSB-2), a starting rubber (natural rubber), a modified liquid rubber, a cellulose nanofiber composition, zinc oxide, stearic acid, antioxidant and wax were kneaded under the conditions of a filling rate of 65% and a rotor rotation speed of 30 to 70 rpm. At this time, the temperature of the internal mixer was controlled to obtain a hydrogenated conjugated diene-based polymer composition (compound) at the discharge temperature was 155 to 160° C.

Next, in the second stage of kneading, the mixture obtained above was cooled to room temperature and then kneaded again to improve the dispersion of the cellulose nanofibers. Also in this case, the temperature of the mixer was controlled to adjust the discharge temperature of the compound to 155 to 160° C. After cooling, in the third stage of kneading, sulfur and a vulcanization accelerator −1 were added, followed by kneading using an open roll set at 70° C. Thereafter, the mixture was molded and vulcanized in a vulcanization press at 160° C. for 15 minutes. The properties of the vulcanized hydrogenated conjugated diene-based polymer composition were evaluated. The results are shown in Table 12.

### Example 23

Using the hydrogenated conjugated diene-based polymers shown in Table 12 as starting rubber components, the compositions were kneaded in accordance with the formulations shown in Table 12 by the following method to obtain hydrogenated conjugated diene-based polymer compositions.

In the first stage of kneading, using an internal mixer (capacity: 0.35 L) equipped with a temperature control device, a hydrogenated conjugated diene-based polymer (HSB-1), a starting rubber (natural rubber), a modified liquid rubber, a cellulose nanofiber composition, a reinforcing filler (silica), a silane coupling agent, zinc oxide, stearic acid, antioxidant and wax were kneaded under the conditions of a filling rate of 65% and a rotor rotation speed of 30 to 70 rpm. At this time, the temperature of the internal mixer was controlled to obtain a hydrogenated conjugated diene-based polymer composition (compound) at the discharge temperature was 155 to 160° C.

Next, in the second stage of kneading, the mixture obtained above was cooled to room temperature and then kneaded again to improve the dispersion of the cellulose nanofibers and the reinforcing filler (silica). Also in this case, the temperature of the mixer was controlled to adjust the discharge temperature of the compound to 155 to 160° C. After cooling, in the third stage of kneading, sulfur, a vulcanization accelerator −1 and a vulcanization accelerator −2 were added, followed by kneading using an open roll set at 70° C. Thereafter, the mixture was molded and vulcanized in a vulcanization press at 160° C. for 15 minutes. The properties of the vulcanized hydrogenated conjugated diene-based polymer composition were evaluated. The results are shown in Table 12.

### Example 24

Using the hydrogenated conjugated diene-based polymers shown in Table 12 as starting rubber components, the compositions were kneaded in accordance with the formulations shown in Table 12 by the following method to obtain a hydrogenated conjugated diene-based polymer composition.

In the first stage of kneading, using an internal mixer (capacity: 0.35 L) equipped with a temperature control device, a hydrogenated conjugated diene-based polymer (HSB-5), a starting rubber (natural rubber), a modified liquid rubber, a cellulose nanofiber composition, zinc oxide, stearic acid, antioxidant and wax were kneaded under the conditions of a filling rate of 65% and a rotor rotation speed of 30 to 70 rpm. At this time, the temperature of the internal mixer was controlled to obtain a hydrogenated conjugated diene-based polymer composition (compound) at the discharge temperature was 155 to 160° C.

Next, in the second stage of kneading, the mixture obtained above was cooled to room temperature and then kneaded again to improve the dispersion of the cellulose nanofibers. Also in this case, the temperature of the mixer was controlled to adjust the discharge temperature of the compound to 155 to 160° C. After cooling, in the third stage of kneading, sulfur and a vulcanization accelerator −1 were added, followed by kneading using an open roll set at 70° C. Thereafter, the mixture was molded and vulcanized in a vulcanization press at 160° C. for 15 minutes. The properties of the vulcanized hydrogenated conjugated diene-based polymer composition were evaluated. The results are shown in Table 12.

### Comparative Example 2

Using the conjugated diene-based polymers shown in Table 12 as starting rubber components, a conjugated diene-based polymer compositions was obtained by kneading according to the formulation shown in Table 12 by the following method.

In the first stage of kneading, using an internal mixer (capacity: 0.35 L) equipped with a temperature control device, a conjugated diene-based polymer (SB-2), a starting rubber (natural rubber), a cellulose nanofiber composition, zinc oxide, stearic acid, antioxidant and wax were kneaded under the conditions of a filling rate of 65% and a rotor rotation speed of 30 to 70 rpm.

At this time, the temperature of the internal mixer was controlled to obtain a hydrogenated conjugated diene-based polymer composition (compound) at the discharge temperature was 155 to 160° C.

Next, in the second stage of kneading, the compound obtained above was cooled to room temperature and then kneaded again to improve the dispersion of the cellulose nanofibers. Also in this case, the temperature of the mixer was controlled to adjust the discharge temperature of the compound to 155 to 160° C. After cooling, in the third stage of kneading, sulfur and a vulcanization accelerator −1 were added, followed by kneading using an open roll set at 70° C. Thereafter, the mixture was molded and vulcanized in a vulcanization press at 160° C. for 15 minutes. The properties of the vulcanized conjugated diene-based polymer composition were evaluated. The results are shown in Table 12.

TABLE 12
(Example B) Rubber composition and cured product (without using masterbatch)

| | | | | | | | | | | | | | | | Com- | |
|---|---|---|---|---|---|---|---|---|---|---|---|---|---|---|---|---|
| | | | | | | | | | | | | | | | par- | |
| | | | | Ex- | Ex- | Ex- | Ex- | Ex- | Ex- | Ex- | Ex- | Ex- | Ex- | Ex- | ative | Ex- |
| | | | | am- | am- | am- | am- | am- | am- | am- | am- | am- | am- | am- | Ex- | am- |
| | | | | ple | ple | ple | ple | ple | ple | ple | ple | ple | ple | ple | am- | ple |
| | | | | 13 | 14 | 15 | 16 | 17 | 18 | 19 | 20 | 21 | 22 | 23 | ple 2 | 24 |
| For- | Hydro- | HSB-1 | parts by | 0 | 20 | 20 | 20 | 20 | 40 | 40 | 20 | 0 | 20 | 30 | 0 | 0 |
| mula- | genated | | mass | | | | | | | | | | | | | |
| tion | conjugated | HSB-2 | parts by | 20 | 0 | 0 | 0 | 0 | 0 | 0 | 0 | 20 | 0 | 0 | 0 | 0 |
| | diene- | | mass | | | | | | | | | | | | | |
| | based | HSB-5 | parts by | 0 | 0 | 0 | 0 | 0 | 0 | 0 | 0 | 0 | 0 | 0 | 0 | 20 |
| | polymer | | mass | | | | | | | | | | | | | |
| | Conjugated | SB-2 | parts by | 0 | 0 | 0 | 0 | 0 | 0 | 0 | 0 | 0 | 0 | 0 | 20 | 0 |
| | diene- | | mass | | | | | | | | | | | | | |
| | based | | | | | | | | | | | | | | | |
| | polymer | | | | | | | | | | | | | | | |
| | Natural | NR | parts by | 80 | 80 | 80 | 80 | 80 | 60 | 60 | 80 | 80 | 80 | 70 | 80 | 80 |
| | rubber | | mass | | | | | | | | | | | | | |
| | Modified | LR-1 | parts by | 0 | 0 | 0 | 0 | 0 | 0 | 0 | 0 | 0 | 10 | 15 | 0 | 0 |
| | liquid | | mass | | | | | | | | | | | | | |
| | rubber | LR-2 | parts by | 0 | 0 | 0 | 0 | 0 | 0 | 0 | 0 | 10 | 0 | 0 | 0 | 0 |
| | | | mass | | | | | | | | | | | | | |
| | | LR-3 | parts by | 0 | 0 | 0 | 0 | 0 | 0 | 0 | 10 | 0 | 0 | 0 | 0 | 0 |
| | | | mass | | | | | | | | | | | | | |
| | CNF | CNF-1 | parts by | 10 | 10 | 0 | 0 | 0 | 20 | 20 | 10 | 0 | 10 | 15 | 10 | 10 |
| | com- | | mass | | | | | | | | | | | | | |
| | position | CNF-2 | parts by | 0 | 0 | 8.56 | 0 | 0 | 0 | 0 | 0 | 0 | 0 | 0 | 0 | 0 |
| | | | mass | | | | | | | | | | | | | |
| | | CNF-3 | parts by | 0 | 0 | 0 | 7.14 | 0 | 0 | 0 | 0 | 7.14 | 0 | 0 | 0 | 0 |
| | | | mass | | | | | | | | | | | | | |
| | | CNF-4 | parts by | 0 | 0 | 0 | 0 | 7.14 | 0 | 0 | 0 | 0 | 0 | 0 | 0 | 0 |
| | | | mass | | | | | | | | | | | | | |
| | Rein- | Silica | parts by | 0 | 0 | 0 | 0 | 0 | 20 | 0 | 0 | 0 | 0 | 15 | 0 | 0 |
| | forcing | | mass | | | | | | | | | | | | | |
| | filler | Carbon | parts by | 0 | 0 | 0 | 0 | 0 | 0 | 20 | 0 | 0 | 0 | 0 | 0 | 0 |
| | | black | mass | | | | | | | | | | | | | |

| | Silane coupling | parts by | 0 | 0 | 0 | 0 | 0 | 1.6 | 0 | 0 | 0 | 0 | 1.2 | 0 | 0 |
|---|---|---|---|---|---|---|---|---|---|---|---|---|---|---|---|
| | agent | mass | | | | | | | | | | | | | |
| | Zinc oxide | parts by | 2.6 | 2.6 | 2.6 | 2.6 | 2.6 | 2.6 | 2.6 | 2.6 | 2.6 | 2.6 | 2.6 | 2.6 | 2.6 |
| | | mass | | | | | | | | | | | | | |
| | Stearic acid | parts by | 2.0 | 2.0 | 2.0 | 2.0 | 2.0 | 2.0 | 2.0 | 2.0 | 2.0 | 2.0 | 2.0 | 2.0 | 2.0 |
| | | mass | | | | | | | | | | | | | |
| | Antioxidant | parts by | 3.0 | 3.0 | 3.0 | 3.0 | 3.0 | 3.0 | 3.0 | 3.0 | 3.0 | 3.0 | 3.0 | 3.0 | 3.0 |
| | | mass | | | | | | | | | | | | | |
| | Wax | parts by | 1.5 | 1.5 | 1.5 | 1.5 | 1.5 | 1.5 | 1.5 | 1.5 | 1.5 | 1.5 | 1.5 | 1.5 | 1.5 |
| | | mass | | | | | | | | | | | | | |
| | Sulfur | parts by | 1.5 | 1.5 | 1.5 | 1.5 | 1.5 | 1.5 | 1.5 | 1.5 | 1.5 | 1.5 | 1.5 | 1.5 | 1.5 |
| | | mass | | | | | | | | | | | | | |
| | Vulcanization | parts by | 0.9 | 0.9 | 0.9 | 0.9 | 0.9 | 0.9 | 0.9 | 0.9 | 0.9 | 0.9 | 0.9 | 0.9 | 0.9 |
| | accelerator-1 | mass | | | | | | | | | | | | | |
| | Vulcanization | parts by | — | — | — | — | — | 0.4 | — | — | — | — | 0.3 | — | — |
| | accelerator-2 | mass | | | | | | | | | | | | | |
| Dispersibility | | | A | A | A | A | A | A | A | A | A | A | A | B | A |
| (visual inspection) | | | | | | | | | | | | | | | |
| Phys- | Hardness | index | 101 | 108 | 103 | 100 | 104 | 124 | 127 | 107 | 106 | 113 | 111 | 94 | 101 |
| ical | Storage elastic | index | 104 | 116 | 114 | 109 | 115 | 172 | 177 | 130 | 129 | 141 | 182 | 96 | 103 |
| pro- | modulus at 25° C. | | | | | | | | | | | | | | |
| perties | 100% Modulus | index | 108 | 122 | 117 | 112 | 113 | 252 | 242 | 135 | 129 | 142 | 228 | 95 | 106 |
| | 200% Modulus | index | 104 | 114 | 111 | 109 | 110 | 192 | 212 | 148 | 139 | 156 | 169 | 94 | 104 |
| | Tensile strength | index | 102 | 113 | 106 | 109 | 113 | 182 | 177 | 142 | 136 | 146 | 154 | 96 | 102 |
| | Tensile elongation | index | 102 | 107 | 106 | 105 | 109 | 127 | 124 | 114 | 111 | 115 | 120 | 97 | 101 |
| | Ozone resistance | | Fair | Good | Good | Good | Good | Excel- | Excel- | Good | Good | Good | Excel- | Poor | Fair |
| | | | | | | | | lent | lent | | | | lent | | |
| | Morphology | | Good | Good | Good | Good | Good | Good | Good | Good | Good | Good | Good | Poor | Fair |

As shown in Tables 11 and 12, it was confirmed that the hydrogenated conjugated diene-based polymer compositions obtained in Examples 1 to 24 have excellent dispersibility of cellulose nanofibers, high tensile modulus and high elastic modulus and excellent ozone resistance when vulcanized, as compared to the conjugated diene-based polymer compositions obtained in Comparative Examples 1 and 2.

### INDUSTRIAL APPLICABILITY

The hydrogenated conjugated diene-based polymer composition of the present invention is suitably used for applications such as interior and exterior parts of automobiles, anti-vibration rubbers, belts, footwear, foams and various industrial products. The hydrogenated conjugated diene-based polymer composition can be applied particularly to members in which rubber or soft plastics are used, and is preferably applied to tires. Tire applications include, for example, treads and sidewalls of passenger cars, trucks, buses, heavy vehicles and the like.

1.-59. (canceled)

60: A hydrogenated conjugated diene-based polymer composition comprising:
50% by mass or more of a hydrogenated conjugated diene-based polymer including an aromatic vinyl monomer unit; and
0.5% to 30% by mass of cellulose nanofibers.

61: A hydrogenated conjugated diene-based polymer composition which is a rubber composition comprising a hydrogenated conjugated diene-based polymer including an aromatic vinyl monomer unit and cellulose nanofibers.

62: A hydrogenated conjugated diene-based polymer composition comprising:
100 parts by mass of a rubber component containing 50% by mass or more of a hydrogenated conjugated diene-based polymer including an aromatic vinyl monomer unit; and
1 part by mass or more and 15 parts by mass or less of cellulose nanofibers.

63: A hydrogenated conjugated diene-based polymer composition comprising:
100 parts by mass of a rubber component containing 5% by mass or more of a hydrogenated conjugated diene-based polymer including an aromatic vinyl monomer unit and a natural rubber; and
1 part by mass or more and 15 parts by mass or less of cellulose nanofibers.

64: The hydrogenated conjugated diene-based polymer composition according to claim 62, wherein the hydrogenated conjugated diene-based polymer includes a styrene unit, and a styrene unit content St and a hydrogenation rate H of the hydrogenated conjugated diene-based polymer satisfy the relationship of the following formula:
0.297×St+29.1≤H≤0.0877×St+84.7.

65: The hydrogenated conjugated diene-based polymer composition according to claim 62, wherein the cellulose nanofibers have no ionic groups.

66: The hydrogenated conjugated diene-based polymer composition according to claim 62, wherein the hydrogenated conjugated diene-based polymer composition further comprises a surfactant.

67: The hydrogenated conjugated diene-based polymer composition according to claim 62, wherein the surfactant is a nonionic surfactant.

68: The hydrogenated conjugated diene-based polymer composition according to claim 62, wherein the hydrogenated conjugated diene-based polymer composition further comprises a liquid rubber.

69: The hydrogenated conjugated diene-based polymer composition according to claim 68, wherein the liquid rubber comprises a modified liquid rubber modified with an unsaturated carboxylic acid and/or a derivative thereof.

70: The hydrogenated conjugated diene-based polymer composition according to claim 62, comprising 10 parts by mass or more and 80 parts by mass or less of a reinforcing filler with respect to 100 parts by mass of the rubber component.

71: A hydrogenated conjugated diene-based polymer cured product, which is a cured product of the hydrogenated conjugated diene-based polymer composition according to claim 62.

72: A method for producing the hydrogenated conjugated diene-based polymer composition according to claim 68, the method comprising:
a step of preparing a cellulose nanofiber composition comprising cellulose nanofibers, a liquid rubber and a surfactant,
a step of mixing the cellulose nanofiber composition with a first rubber component containing a hydrogenated conjugated diene-based polymer to prepare a masterbatch for rubber modification, and
a step of mixing the masterbatch for rubber modification with a second rubber component to prepare a hydrogenated conjugated diene-based polymer composition.

73: The method according to claim 72, wherein the cellulose nanofiber composition is a powder.

74: A masterbatch for rubber modification comprising 100 parts by mass of a first rubber component containing 50% by mass or more of a hydrogenated conjugated diene-based polymer including an aromatic vinyl monomer unit, and
15 parts by mass or more and 100 parts by mass or less of cellulose nanofibers.

75: The masterbatch for rubber modification according to claim 74, wherein the masterbatch for rubber modification further comprises a surfactant.

76: A method for producing the masterbatch for rubber modification according to claim 75, the method comprising:
a step of preparing a cellulose nanofiber composition comprising cellulose nanofibers and a surfactant, and
a step of mixing the cellulose nanofiber composition with a first rubber component containing a hydrogenated conjugated diene-based polymer.

77: The method according to claim 76, wherein the cellulose nanofiber composition is a powder.

78: The masterbatch for rubber modification according to claim 75, wherein the masterbatch for rubber modification further comprises a liquid rubber.

79: A method for producing the masterbatch for rubber modification according to claim 78, the method comprising:
a step of preparing a cellulose nanofiber composition comprising cellulose nanofibers, a liquid rubber and a surfactant, and
a step of mixing the cellulose nanofiber composition with a first rubber component containing a hydrogenated conjugated diene-based polymer.

80: The method according to claim 79, wherein the cellulose nanofiber composition is a powder.
